(19) United States
(12) Patent Application Publication
(10) Pub. No.: US 2018/0352211 A1
(43) Pub. Date: Dec. 6, 2018

(54) GARMENT DIGITISATION APPARATUS, METHOD AND COMPUTER PROGRAM PRODUCT

(71) Applicant: METAIL LIMITED, London (GB)

(72) Inventors: Tom DALZIEL, London (GB); Craig THOMAS, London (GB); Joe TOWNSEND, London (GB); Tom BARNES, London (GB); Yu CHEN, London (GB); Anoop UNADKAT, London (GB); Jim DOWNING, London (GB); Tom ADEYOOLA, London (GB)

(21) Appl. No.: 15/761,651

(22) PCT Filed: Sep. 21, 2016
(86) PCT No.: PCT/GB2016/052933

§ 371 Date: Mar. 20, 2018

(30) Foreign Application Priority Data
Sep. 21, 2015 (GB) 1516700.0

(51) Int. Cl. H04N 13/246; G03B 15/02; G06T 17/20; G06T 15/50; G06T 15/04; G06Q 30/06

(52) U.S. Cl. CPC H04N 13/246; G03B 15/02; G06T 17/20; G06T 2200/08; G06T 15/04; G06Q 30/0643; G06T 2200/04; G06T 15/50

(57) ABSTRACT

There is disclosed a garment digitization apparatus, including a mannequin loading system, a mannequin rotation system, a computer system and a camera system, wherein the apparatus is configured to load a mannequin wearing a garment using the mannequin loading system, to rotate the mannequin wearing the garment through at least 360° using the mannequin rotation system, and to capture images of the garment using the camera system during the mannequin rotation, wherein the mannequin loading, the mannequin rotation and the image capturing occur under control of the computer system. Related methods and computer program products are also disclosed.

### BACKGROUND OF THE INVENTION

### 1. Field of the Invention

The field of the invention relates to automated garment digitization apparatus, and to related methods and computer program products.

### 2. Technical Background

Metail is the leading provider of body shape and garment visualisation technology for online retailers. Our system, in use by some major retailers in the UK, Brazil and India, allows online shoppers to generate images of their own body and dress the model to provide a visualisation of a garment/outfit—giving a virtual fitting experience and addressing issues that hinder more online clothes shopping.

The current system, whilst valuable to shoppers, and reducing returns and increasing conversion for retailers has limitations in two areas: (1) there is a need for increased garment throughput in the photography stage to support the largest retailers, with lower capital costs per garment and simpler operations, and (2) a high level of manual activities are needed to produce a digital garment before visualisation.

To address these issues, Metail has previously productionised 3 technologies: (1) automatic separation of garment images from the photo background (see, e.g. U.S. Pat. No. 8,605,148B2), (2) automated creation of 3D models of a garment from the captured images, and (3) real-time 3D visualisation of the garment. These advances have reduced manual processes and improved realism, but require additional photography and thus reduce garment throughput.

This patent specification describes not only various ideas and functions, but also their creative expression. A portion of the disclosure of this patent document therefore contains material to which a claim for copyright is made and notice is hereby given:

© Metail Limited (e.g. pursuant to 17 U.S.C. 401). A claim to copyright protection is made to all protectable expression associated with the examples of the invention illustrated and described in this patent specification.

The copyright owner has no objection to the facsimile reproduction by anyone of the patent document or the patent disclosure, as it appears in the Patent and Trademark Office patent file or records, but reserves all other copyright rights whatsoever. No express or implied license under any copyright whatsoever is therefore granted.

### 3. Discussion of Related Art

U.S. Pat. No. 8,605,148B2 discloses a system and method for image processing and generating a body model. U.S. Pat. No. 8,605,148B2 is incorporated by reference.

WO2012110828 (A1) discloses that a virtual body model of a person is created with a small number of measurements and a single photograph and combined with one or more images of garments. The virtual body model represents a realistic representation of the user's body and is used for visualizing photo-realistic fit visualizations of garments, hairstyles, make-up, and/or other accessories. The virtual garments are created from layers based on photographs of real garments from multiple angles. Furthermore the virtual body model is used in multiple embodiments of manual and automatic garment, make-up, and, hairstyle recommendations, such as, from channels, friends, and fashion entities. The virtual body model is sharable for, as example, visualization and comments on looks. Furthermore it is also used for enabling users to buy garments that fit other users, suitable for gifts or similar. The implementation can also be used in peer-to-peer online sales where garments can be bought with the knowledge that the seller has a similar body shape and size as the user as well as being used in manufacturing the garment chosen. WO2012110828 (A1) is incorporated by reference. WO2012110828 (A1) discloses methods of digitising a garment in 3D.

There is a need for increased garment throughput in the imaging stage, to support the larger retailers.

### SUMMARY OF THE INVENTION

According to a first aspect of the invention, there is provided a garment digitization apparatus, including a mannequin loading system, a mannequin rotation system, a computer system and a camera system, wherein the apparatus is configured to load a mannequin wearing a garment using the mannequin loading system, to rotate the mannequin wearing the garment through at least 360° using the mannequin rotation system, and to capture images of the garment using the camera system during the mannequin rotation, wherein the mannequin loading, the mannequin rotation and the image capturing occur under control of the computer system.

An advantage is that image capture is standardized by the apparatus, which improves the reliability of the captured images. A further advantage is that garment arrangement on the mannequin is not disturbed during the mannequin loading, because the automated mannequin loading provides negligible garment disturbance. A further advantage is that mannequin lifetime is extended because the improved handling of the mannequin leads to reduced manual handling damage to the mannequin.

The garment digitization apparatus may be one wherein the captured images of the garment are stored on the computer system.

The garment digitization apparatus may be one wherein the captured images are suitable for 3D garment digitization of the garment.

The garment digitization apparatus may be one wherein the apparatus is arranged to support a loaded mannequin from above. An advantage is that lower parts of garments may be imaged more readily, because there is no need to support the mannequin from below.

The garment digitization apparatus may be one wherein the loaded mannequin includes a neck spigot, and is supported from the neck spigot by the apparatus. An advantage is secure supporting of the mannequin.

The garment digitization apparatus may be one wherein the apparatus includes a motion controller which controls rotation of the mannequin, wherein a signal from the motion controller is used to synchronise mannequin rotation and image capture. An advantage is a precise relation between mannequin rotation and captured images is established.

The garment digitization apparatus may be one wherein the loading system includes a gantry system to engage and to load the mannequin.

The garment digitization apparatus may be one wherein the gantry system includes 3 linear axes and 1 rotational axis. An advantage is very flexible control over mannequin loading and mannequin movement after loading.

The garment digitization apparatus may be one wherein the loading system includes a gantry system to engage and to load the mannequin, and wherein the gantry system includes 3 linear axes and 1 rotational axis and wherein the 3 linear axes and 1 rotational axis are controlled by the motion controller.

The garment digitization apparatus may be one wherein the gantry system includes a collet fixture which is movable downwards to receive, to engage and to secure mannequin tooling on an upper part of the mannequin to the collet fixture.

The garment digitization apparatus may be one wherein the loading system includes linear actuators. An advantage is reduced disturbance to the mannequin.

The garment digitization apparatus may be one wherein the loading system includes electromagnets.

The garment digitization apparatus may be one wherein the apparatus is arranged to support a loaded mannequin from below.

The garment digitization apparatus may be one wherein the loaded mannequin is supported using two spigots of the loading system onto which each of the legs is slotted.

The garment digitization apparatus may be one wherein the camera system includes an industrial camera. An advantage is suitability for large scale garment digitization.

The garment digitization apparatus may be one wherein the camera system has a calibrated position.

The garment digitization apparatus may be one wherein the camera system includes a shutterless camera. An advantage is prolonged camera life in the apparatus.

The garment digitization apparatus may be one wherein the camera system includes a GigE Vision camera.

The garment digitization apparatus may be one wherein the camera system includes a monoscopic camera.

The garment digitization apparatus may be one wherein the camera system includes a stereo camera.

The garment digitization apparatus may be one wherein the apparatus includes a lighting system.

The garment digitization apparatus may be one wherein the lighting system is under control of the computer system.

The garment digitization apparatus may be one wherein the lighting system comprises high-color rendering index (CRI) lighting.

The garment digitization apparatus may be one wherein the lighting system includes a backpanel and a ringlight.

The garment digitization apparatus may be one wherein the lighting system includes light emitting diode (LED) panels.

The garment digitization apparatus may be one wherein the lighting system includes texture lighting, alpha lighting and albedo lighting.

The garment digitization apparatus may be one wherein the apparatus includes a rig, wherein the rig supports or includes the camera system, the mannequin loading system, the mannequin rotation system, and the lighting system.

The garment digitization apparatus may be one wherein the rig includes columns and a roof, wherein the columns support the roof.

The garment digitization apparatus may be one wherein the rig roof is a rigid roof.

The garment digitization apparatus may be one wherein the rig roof is opaque.

The garment digitization apparatus may be one wherein the rig includes a back-panel, a lighting column, and a camera column which provide stability while housing their respective components.

The garment digitization apparatus may be one wherein the rig includes a frame which includes an extruded aluminium profile system.

The garment digitization apparatus may be one wherein the frame has adjustable feet.

The garment digitization apparatus may be one wherein the rig is readily movable within a room without disassembly of the rig.

The garment digitization apparatus may be one wherein the rig ensures that the location and orientation of all apparatus components is constrained so that consistency between garment images is maintained.

The garment digitization apparatus may be one wherein the apparatus is configured to receive a trolley and to receive the mannequin from the trolley.

The garment digitization apparatus may be one wherein the apparatus ensures the trolley does not tip over when the mannequin is being loaded to the apparatus.

The garment digitization apparatus may be one wherein the computer system is mounted in the rig.

The garment digitization apparatus may be one wherein the computer system is mounted in a roof of the rig.

The garment digitization apparatus may be one wherein the computer system includes a server.

The garment digitization apparatus may be one wherein the computer system includes a graphics processing unit for processing the captured images.

The garment digitization apparatus may be one wherein the apparatus is configured to load the mannequin from one side of the apparatus, and to unload the mannequin to the same side of the apparatus.

The garment digitization apparatus may be one wherein the apparatus is configured to load the mannequin from a position on one side of the apparatus, and to unload the mannequin to the same position on same side of the apparatus.

The garment digitization apparatus may be one wherein the apparatus is configured to load the mannequin from a first position on one side of the apparatus, and to unload the mannequin to a second position on the same side of the apparatus, wherein the first position and the second positions are different positions.

The garment digitization apparatus may be one wherein the apparatus is configured to load and to unload the mannequin from a first position on one side of the apparatus, and to load and to unload the mannequin to a second position on the same side of the apparatus, wherein the first position and the second positions are different positions.

The garment digitization apparatus may be one wherein the apparatus is configured to load the mannequin from one side of the apparatus, and to unload the mannequin to an opposite side of the apparatus.

The garment digitization apparatus may be one wherein the apparatus is configured to load the mannequin from a first position, or from a second position, on one side of the apparatus, and to unload the mannequin to an opposite side of the apparatus.

The garment digitization apparatus may be one wherein the apparatus is configured to load and to unload the mannequin from one side of the apparatus, and to load and to unload the mannequin from an opposite side of the apparatus.

The garment digitization apparatus may be one wherein the apparatus includes Radio-frequency identification (RFID) tracking for mannequin RFID tracking.

The garment digitization apparatus may be one wherein the apparatus includes the mannequin.

The garment digitization apparatus may be one wherein the mannequin includes a retroreflective surface.

The garment digitization apparatus may be one wherein the retroreflective surface is a retroreflective suit.

The garment digitization apparatus may be one wherein the image capture includes automatic texture cutout using the mannequin which includes a retroreflective surface.

The garment digitization apparatus may be one wherein the apparatus provides automatic texture cutout and transparency capture for improved layering of non-opaque garments.

The garment digitization apparatus may be one wherein the apparatus includes a portable device which is connectable to the computer system, in which the portable device is programmed to receive user input to control mannequin loading and/or garment image capture.

The garment digitization apparatus may be one wherein the portable device is a tablet.

The garment digitization apparatus may be one wherein a touch-based, device independent user interface (UI) is provided on the portable device, served as a web application for easy updates.

The garment digitization apparatus may be one wherein the user interface routes the user appropriately to optimize the workflow.

The garment digitization apparatus may be one wherein the portable device provides high quality image previews, to reduce a likelihood of storing unsuitable images.

The garment digitization apparatus may be one wherein the image capture includes raw image capture.

The garment digitization apparatus may be one wherein the image capture includes colour calibration.

The garment digitization apparatus may be one wherein the image capture includes fixed focusing.

The garment digitization apparatus may be one wherein the image capture includes a lossless imaging pipeline and local image processing.

The garment digitization apparatus may be one wherein the apparatus provides for standardizing relative mannequin position/orientation & apparent size to reduce digitization errors and allow for simpler staff training.

The garment digitization apparatus may be one wherein the apparatus provides for automatic mannequin loading & unloading for one-time dressing & reduced mannequin wear.

The garment digitization apparatus may be one wherein the mannequin loading system is operable to unload and to release the mannequin.

The garment digitization apparatus may be one wherein the apparatus supports digitisation of high-translucency garments, complex netting garments, and dipped hem garments.

The garment digitization apparatus may be one wherein the apparatus includes a single power switch.

The garment digitization apparatus may be one wherein the apparatus includes hidden cabling and cladding.

The garment digitization apparatus may be one wherein the apparatus is operable to rotate the mannequin wearing the garment using the mannequin rotation system through a plurality of 360° rotations.

According to a second aspect of the invention, there is provided a computer-implemented method of digitising a garment in 3D, using a garment digitization apparatus, the apparatus including a mannequin loading system, a mannequin rotation system, a computer system and a camera system, the method including the steps of:

(i) loading a mannequin wearing a garment using the mannequin loading system;

(ii) rotating the mannequin wearing the garment through at least 360° using the mannequin rotation system, and

(iii) capturing at least three images of the garment using the camera system during the mannequin rotation.

The method may include the step of digitising the garment in 3D, using the at least three captured images of the garment.

The method may include the step of storing the captured images of the garment on the computer system.

The method may be one wherein the mannequin is loaded from above.

The method may be one wherein the mannequin rotation and the image capture are synchronised.

The method may be one wherein the apparatus includes a lighting system, wherein the lighting system is controlled by the computer.

The method may be one wherein, to obtain automatic texture cutout results, the mannequin, which is a retroreflective mannequin, is rotated 360° 3 times under 3 different lighting conditions: texture lighting, alpha lighting, and albedo lighting.

The method may be one including using an apparatus of any aspect of the first aspect of the invention.

According to a third aspect of the invention, there is provided a computer program product executable on a computer system to digitise a garment in 3D, the computer system controlling a garment digitization apparatus, the apparatus including a mannequin loading system, a mannequin rotation system, the computer system and a camera system, the computer program product executable to:

(i) load a mannequin wearing a garment using the mannequin loading system;

(ii) rotate the mannequin wearing the garment through at least 360° using the mannequin rotation system, and

(iii) capture at least three images of the garment using the camera system during the mannequin rotation.

The computer program product may be further executable to digitise the garment in 3D, using the at least three captured images of the garment.

The computer program product may be further executable to perform a method of any aspect of the second aspect of the invention.

According to a fourth aspect of the invention, there is provided a mannequin including a stretchable retroreflective material covering.

The mannequin may include an upwardly projecting spigot.

According to a fifth aspect of the invention, there is provided a method of manufacturing a mannequin including a stretchable retroreflective material covering, comprising the steps of removing a top layer of a mannequin and replacing the top layer with stretchable retroreflective material to form a stretchable retroreflective material covering.

The method may include the step of clamping the retroreflective material in place on the mannequin.

According to a sixth aspect of the invention, there is provided a trolley including a support arranged to receive a mannequin and to support the mannequin from above.

The trolley may be one in which the support is arranged to secure the mannequin to the trolley.

According to a seventh aspect of the invention, there is provided a trolley including a support arranged to receive a mannequin and to support the mannequin from below.

According to an eighth aspect of the invention, there is provided a system including an apparatus of any aspect of the first aspect of the invention, and a trolley of any aspect of the sixth or sevenths aspects of the invention.

According to a ninth aspect of the invention, there is provided a mannequin loading apparatus comprising a gantry system and a mannequin, the gantry system including a vertically displaceable collet fixture, the mannequin including an upwardly projecting spigot, wherein the collet fixture is lowerable to engage and to secure the spigot, and wherein the collet fixture is raiseable by the gantry system to lift the mannequin.

The mannequin loading apparatus may be one wherein the collet fixture includes a tapered socket.

The mannequin loading apparatus may be one wherein the tapered socket includes a plurality of ball bearings that are lockable into a groove on tooling fixed to the top of the mannequin.

The mannequin loading apparatus may be one wherein when the collet fixture is lowered onto the mannequin tooling, a flange on the tooling activates an engage position pin on the collet fixture that triggers an engaging mechanism.

The mannequin loading apparatus may be one wherein when a fixture pin is depressed, the fixture lever springs into an engage position and touches a docking station lever pin.

The mannequin loading apparatus may be one wherein when a lever on the collet fixture springs, the plurality of ball bearings are locked into the groove of the mannequin tooling to engage and secure the mannequin to the collet fixture.

The mannequin loading apparatus may be one wherein the collet fixture is releasable from the spigot so as to release the mannequin.

The mannequin loading apparatus may be one wherein the collet fixture is releasable from the spigot so as to release the mannequin to a docking station.

The mannequin loading apparatus may be one wherein the gantry system rotates the collet fixture, so that a lever is pushed against a lever pin mounted at the docking station.

The mannequin loading apparatus may be one wherein when the lever is effectively pushed to an end of its travel, the locating bearings are unlocked and therefore released from grooves on the mannequin tooling.

The mannequin loading apparatus may further comprise an electronic circuit to detect a position of a release pin with regard to a docking station pin, and to verify a configuration of the collet fixture pre-mannequin loading and post-mannequin unloading.

### BRIEF DESCRIPTION OF THE FIGURES

Aspects of the invention will now be described, by way of example(s), with reference to the following Figures, in which:

FIG. 1 shows an isometric projection of an example of six light panels with a frame or structure omitted, with driving angles shown as dashed lines.

FIG. 2 shows a plan view of an example of six light panels with a frame or structure omitted, with driving angles shown as dashed lines. The angle and the dimensions, in mm, are an example.

FIG. 3 shows a plan view of an example of six light panels with a frame or structure omitted, with driving angles shown as dashed lines, with extra detail on lighting locations. The angles and the dimensions, in mm, are an example.

FIG. 4 shows a side view of an example of six light panels with a frame or structure omitted, with driving angles shown as dashed lines. The angles and the dimensions, in mm, are an example.

FIG. 5 shows a side view of an example of six light panels with a frame or structure omitted, with driving angles shown as dashed lines, with mannequin height (in mm) specified by way of example.

FIG. 6 shows an isometric projection of an example in which the mannequin is supported from above.

FIG. 7 shows an isometric projection of an example in which the mannequin is supported from below.

FIG. 8 shows an example of a photorig frame where the field of view is physically demarcated by structural elements and the camera is supported by these structural elements.

FIG. 9 shows further detail for the concept in FIG. 8.

FIG. 10 shows an example of a photorig frame, with components supported in columns which hold up the roof structure.

FIG. 11 shows a computer aided design (CAD) & sketch which relates to the example in FIG. 8.

FIG. 12 shows a CAD & sketch which relates to the example in FIG. 8.

FIG. 13 shows a CAD & sketch which relates to the example in FIG. 10.

FIG. 14 shows a CAD & sketch which relates to the example in FIG. 10.

FIG. 15 shows a CAD & sketch which relates to the example in FIG. 10.

FIG. 16 shows a CAD & sketch which relates to the example in FIG. 10.

FIG. 17 shows views of a CAD model of a preferred example photorig design, without cladding.

FIG. 18 shows views of a CAD model of a preferred example photorig design, with cladding.

FIG. 19 shows a larger, more detailed, view of the isometric projection of FIG. 18a.

FIG. 20 shows an isometric projection of a preferred example photorig design, without cladding.

FIG. 21 shows an isometric projection of a preferred example photorig design, with cladding.

FIG. 22 shows an isometric projection of a preferred example photorig design without cladding and with various important dimensions (in mm), by way of example.

FIG. 23 shows two projections of a preferred example photorig design without cladding and with various important dimensions (in mm), by way of example.

FIG. 24 shows views of an example lighting column in a preferred example photorig design, and with various important dimensions (in mm), by way of example.

FIG. 25 shows an example camera column in a preferred example photorig design and with various important dimensions (in mm), by way of example.

FIG. 26 shows a preferred example photorig design with mannequin trolleys in docking locations and a rackmount computer in the roof structure, by way of example.

FIG. 27 shows a sketch of part of an example mannequin loading and unloading system, with only one docking point, with a camera position also indicated.

FIG. 28 shows a sketch of part of an example mannequin loading and unloading system with one docking point on each side with specific loading and unloading functionality, with a camera position also indicated.

FIG. 29 shows a sketch of part of an example mannequin loading and unloading system with one docking point on each side with both loading and unloading functionality, with a camera position also indicated.

FIG. 30 shows a sketch of part of an example mannequin loading and unloading system with two docking points on one side with specific loading or unloading functionality, with a camera position also indicated.

FIG. 31 shows a sketch of part of an example mannequin loading and unloading system with two docking points on one side with both loading and unloading functionality, with a camera position also indicated.

FIG. 32 shows a sketch of part of an example mannequin loading and unloading system with two loading points on one side and one unloading point on the other side, with a camera position also indicated.

FIG. 33 shows a CAD view of an example mannequin working (moving) area with various pick up/drop off points illustrated. The dimensions, in mm, are an example.

FIG. 34 shows a sketch design of the linear axes in example motion control mechanics.

FIG. 35 shows a close CAD view of the linear axes in a preferred example of motion control mechanics.

FIG. 36 shows an example of a retroreflective mannequin suit construction.

FIG. 37 shows various CAD views of an example tool-changer mechanism. The tool changer is adapted for opening by use of added push bar. A button sub assembly may be removed to allow free rotation. Adding an extended arm allows a mechanical method of releasing the taper arrangement.

FIG. 38 shows an example of a mechanism for holding the male tool changer part on the mannequin trolley.

FIG. 39 shows an example of specific detail of the mechanism in FIG. 38, namely the sprung bearings required to keep the part in place.

FIG. 40 shows an example including an upper part of a mannequin and an upper part of a trolley in the context of the mechanism shown in FIG. 38.

FIG. 41 shows an example of a mechanism by which the trolley docks the mannequin into the photorig and an example design for release using a solenoid.

FIG. 42 shows an example mechanism for ensuring a trolley does not tip over during docking, by supporting the trolley base appropriately.

FIG. 43 shows an example tool changer mechanism and the use of contact switches to detect location of the parts during loading or unloading.

FIG. 44 shows an example process of loading and unloading using the tool changer and an example in which a solenoid is used for release.

FIGS. 45-47 show CAD models of an example process of loading the mannequin, at three successive points in time. FIG. 45 shows the mannequin being brought for loading; FIG. 46 shows the mannequin being engaged for loading, and FIG. 47 shows tool removal after tool disengagement from the mannequin.

FIGS. 48-49 show two different perspectives of a CAD model of an example adaptor piece which allows the trolley to hold the mannequin in.

FIG. 50 shows a process diagram of an example of how components may interact in a photorig example.

FIGS. 51-59 show examples of UI design for a tablet interface example.

FIG. 60 shows part 1 of 4 of an operational analysis of an example imaging process, which proceeds on the right to FIG. 80.

FIGS. 61-63 show CAD models of an example gearhead mechanism, for mannequin rotation. FIG. 61 shows an example rotation gearhead assembly; FIG. 62 shows an example gearhead block, and FIG. 63 shows an example gearhead block. Dimensions are given in mm, as an example.

FIG. 64 shows CAD models of example mannequin-attachment components, including a rotary shaft, a push rod and a mannequin coupling. Dimensions are given in mm, as an example.

FIGS. 65-67 show CAD models of an example stop block mechanism for mannequin insertion. FIG. 65 shows a stop block assembly example; FIG. 66 shows a stop block example, and FIG. 67 shows a stop block insert example. Dimensions are given in mm, as an example.

FIGS. 68-69 show CAD models of example mannequin trolley locators on a side of a rig. FIG. 68 shows a trolley top locator assembly example; FIG. 69 shows a top locator example. Dimensions are given in mm, as an example.

FIG. 70 shows a CAD model of an example locator plate. Dimensions are given in mm, as an example.

FIG. 71 shows a CAD model of an example release contactor and pin (to detect mannequin release). Dimensions are given in mm, as an example.

FIGS. 72-75 show CAD models of an example mannequin support adaptor for the trolleys. FIG. 72 shows a mannequin top support assembly example; FIG. 73 shows a location pad support example; FIG. 74 shows a mannequin top support rod example;

FIG. 75 shows a mannequin top location pad example. Dimensions are given in mm, as an example.

FIG. 76 illustrates an example mechanical design for a gantry to engage and load a mannequin from a docking station.

FIG. 77 illustrates an example mechanical design for a gantry to unload a mannequin to a docking station.

FIG. 78 illustrates an example mechanical design for a gantry to safely release a mannequin after an unloading is completed.

FIG. 79 shows an example electronic circuit to control a mannequin loading and unloading process.

FIG. 80 shows part 2 of 4 of an operational analysis of an example imaging process, which proceeds on the right to FIG. 81.

FIG. 81 shows part 3 of 4 of an operational analysis of an example imaging process, which proceeds on the right to FIG. 82.

FIG. 82 shows part 4 of 4 of an operational analysis of an example imaging process, which follows, from the left, from FIG. 81.

### DETAILED DESCRIPTION

There is provided a unified and automated imaging solution suitable for 3D Garment Digitisation.

1.1 Features and Innovations

There is provided a new garment imaging solution to address the challenges described in the Background to the Invention section. The solution includes overall improvements to Metail's existing garment photography hardware and software. These improvements advance the quality of the final image, ease the image capturing operation and reduce costs in digitization. In summary, the new garment imaging system may include the following hardware and procedural improvements:
Advance the quality of the final image by:
Introducing RAW capture, colour calibration, fixed focus and improved lighting;
Implementing retro-reflective hardware (see, e.g. U.S. Pat. No. 8,605,148B2) for automatic texture cutout;
Standardizing relative mannequin position/orientation & apparent size to reduce digitization errors and allow for simpler staff training.
Ease the image capturing operation by:
Tablet-based user interface;
Automatic mannequin loading & unloading for one-time dressing & reduced mannequin wear;
Built-in-tests & calibration to eliminate user maintenance and flatten learning curve;
High-quality and fixed components to increase the apparatus minimum breaking force (MBF) and reduce support overheads.
Reduce costs in digitization by:
Retro-reflective mannequin & backpanel, ringlight and other components which enable the automatic texture cutout solution;
Standardizing relative mannequin position/orientation & apparent size to ease digitization development.

Several software improvements may be provided. Examples are as follows:
Advance the quality of the final image by:
Introducing lossless imaging pipeline and local image processing before upload
Easier image review in the studio with improved user interface (UI);
Implementing automatic texture cutout and transparency capture for vastly improved layering of non-opaque garments;
Improved tracking and monitoring for better quality feedback.
Ease the image capture operation by:
Touch-based, device independent UI served as a web application for easy updates;
High resolution images for quick quality checks;
Radio-frequency identification (RFID) mannequin tracking for simple operation.
Reduce costs in digitization by:
Local computation of auto-cutout, so downloads are quicker for digitization;
Higher quality previews, which reduce likelihood of uploading unsuitable images.

Furthermore, operational process analysis has ensured both hardware and software are designed with the most efficient and rewarding user experience in mind.

The following novel elements may allow us to realise the above improvements:
Rotating the mannequin from above to allow for clean cutout around the ankles
Capturing images during rotation, using a signal from the motion controller for synchronisation, and proximity sensors for calibration, to speed capture
Combining these elements with light emitting diode (LED) panels and an industrial camera to achieve well synchronised images and a durable setup
Automatic mannequin loading using linear actuators to avoid disturbing garments during loading and the resultant time-consuming redressing
Automatic mannequin unloading using sensors and counter-rotation against the arm of the tool-changer device
A unique bracket on each mannequin stand to allow for easy and durable loading/unloading
Specially positioned seams and flaps on the mannequin's retro-reflective suit to provide the most even retro-reflective return.

1.2 Benefits

An example of the new garment image capturing system may provide the following three major benefits:

Improving the Quality of Garment Photography

Improved overall garment appearance, image quality and garment range can all contribute to improvements in our key performance metrics of virtual fitting products. The new garment imaging system improves the overall quality of garment photography. This may be achieved by:

1) Improving overall garment appearance, with the features of calibrated camera position, automatic texture cutout (see, e.g. U.S. Pat. No. 8,605,148B2), translucency capture, and automated loading (no need for rushed redressing).

2) Improving image quality, by using RAW capture, lossless compression, colour calibration, high-colour rendering index (CRI) lighting, and improved optics.

3) Supporting a wider range of garments, e.g. supporting digitisation of high-translucency and complex netting captured, dipped hems, and other complex legwear.

Improving Studio Staffs Experience.

The ease of integration and operational process is a key factor in acquiring the customers to the digitisation solution. The new garment photography system may implement the following four example features that improve the user experience, as shown in Table 1.1:

TABLE 1.1
Four example features of an example system that improve the user's
experience.

| | |
|---|---|
| Simpler hardware | Tablet-based interface, single power switch, fixed |
| implemented | components |
| Simpler software | Touch-based UI, UX/UI design by products team, |
| implemented | software designed for multiple-mannequin |
| | environment |
| Maintenance, repair & | LED lights, industrial camera, custom-made |
| manual recalibration | automated motion system, industrial PC/server, |
| eliminated | power distribution. Automatic tests & calibration |
| Rig aesthetics | Custom design, hidden cabling, cladding, |
| improved | attractive materials |

Decrease the Digitisation Cost

The cost for photography can be broken broadly into two categories: operational expenditure and capital expenditure. The capital expenditure would increase with the new photography system because expenditure on each rig in hubs will increase. However, this is more than balanced by operational expenditure savings. The new garment imaging system decreases our operational expenditure by:

1) Increasing garment throughput per rig: Speed reduction caused by the automatic texture cutout solution (see, e.g. U.S. Pat. No. 8,605,148B2) is now compensated with loading & capture speed increases & system downtime strongly reduced with operational process improvements.

2) Reducing the overall digitization time: Hardware and software for automatic texture cutout & auto-alpha channel capture (see, e.g. U.S. Pat. No. 8,605,148B2) are implemented. The system also provides small-file size for fast transfer to the off-site operation teams for post-processing.

The new garment photography system also reduces the operation cost of clients. This is achieved by:

1) Increasing garment throughput per stylist, with user experience (UX) improvements, automated garment, stylist and mannequin ID, redressing eliminated, operational model changed, and system sped up to reduce downtime.

2) Reducing supervision overhead: with more intuitive & informative UI, improved monitoring & feedback, and strong reduction of maintenance & repair.

1.3 Components

The new imaging system example has been split into 7 key components:

1. Frame and structure components, i.e. the part of the rig by which the location and orientation of all components is constrained so that consistency between garment images is maintained.

2. Camera components, including the imaging device, lens, connectors and image processing software.

3. Motion Control components, including the motion controller, drivers, power supplies, motors, actuators and all other componentry involved in moving and loading the mannequins.

4. Lighting components, including texture lighting, alpha lighting and albedo lighting necessary to capture as much accurate detail as possible, for instant cutout and aesthetically appealing results.

5. Mannequin components, including all elements of mannequin modification, including the retroreflective suit, spigot, and the stand to support the mannequin.

6. Back-end software and computer hardware components, including all software and computer hardware involved in controlling components, collating images and uploading them to the cloud for further processing.

7. Front end software components, including all software and UX/UIs involved in providing the studio staff with a user interface by which to control the system.

The design details, requirements, and options of each component are addressed in the following Sections 2-8.

2. Frame and Structure Components

In an example, the photo-rig structure fixes components to ensure consistency between all garment images. This allows us to optimise our image pipeline and pinpoint areas for improvement more easily. This also reduces the possibility of tampering or accidental displacement of components, thereby eliminating user-maintenance, allowing users to focus on great styling. The frame implements cable routing and thermal management for all components, providing a tidy and safe workspace for users and a long life for components.

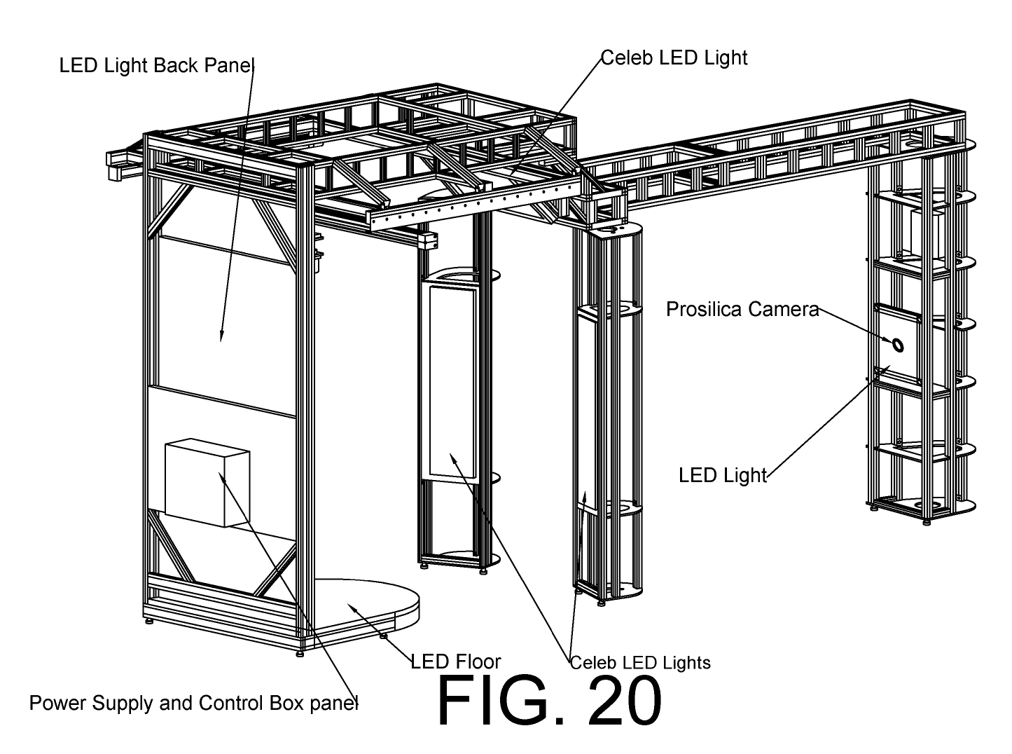

Development work on the frame/structure started by noting spatial constraints for components. These constraints allowed for two overarching design concepts: 1) supporting the mannequin from below or 2) supporting the mannequin from above. The former concept is more traditional: it allows for easier redressing in-situ and shooting accessories and shoes without significant design engineering thought. The latter concept is more unconventional, but provides far superior automatic texture cutout (for cutout, see, e.g. U.S. Pat. No. 8,605,148B2). Supporting the mannequin from above was chosen as a core concept. We supplied various conceptual designs to incorporate this. In a preferred example design, the design uses a large rigid roof to fix the separation of components, with the back-panel, lighting column, and camera column providing stability while housing their respective components (see e.g. FIG. 20).

A preferred example structure is primarily built using an extruded aluminium profile system (e.g. a Paletti System, Paletti USA, 145 Keystone Drive, Montgomeryville, Pa. 18936, USA). This allows for easy alterations and additions, is lightweight, strong and simple to disassemble and reassemble. The camera and light columns are further supported with steel plates, the backdrop incorporates acrylic sheets for diffusion and protection of the LEDs and the entire frame has adjustable feet to ensure stability in any environment.

Much of the work in this component involved integration of other components (see Sections 3-8). The profile system allowed for simple and strong housing of the three LED texture-lighting panels as well as the ring light. Brackets were produced to aid in the installation of the actuators and cable carriers in the roof section of the frame. Furthermore, brackets for the industrial PC, industrial camera and motion-control electronics cabinet enabled seamless and secure integration. Finally, in a preferred example, the mannequin loading bays used an aluminium frame and nylon contact points for smooth interaction with the mannequins.

2.1 Requirement Definition

The initial high-level requirements for an example frame and structure, ranked in preferred order of importance and ease of implementation, are given in Table 2.1:

TABLE 2.1
Example requirement definitions for the frame & structure.

| Requirement | Quantifier/Detail |
|---|---|
| Fits In Standard Studio | 6 m(L) × 3 m(W) × 3 m(H) |
| Incorporates components outlined in | Camera, motion control, |
| other Work Packages | lighting, mannequin, PC hardware |
| Able to Photograph Shoes | — |
| Able to Take Large Wide Garments | Maximum diameter 1144 mm |
| Durable | Minimum lifespan 5 years |
| Roof on structure | For reduction of ambient light |
| Platform is Sturdy & Stable | Support maximum weight of |
| | stylist with mannequin (100 kg) |
| Locally Moveable | Moveable by 1 person across |
| | a room when assembled |
| Incorporates Seamless Photo Platform | — |
| Modular | — |
| Safe To Operate | CE & UL certification |
| Hidden Cabling | Excluding power & ethernet |
| Able to Photograph Accessories | Bags, jewellery, scarves, |
| | hats, gloves |
| Camera/Server Integrated & Hidden | User cannot change settings |
| Sections Hand Portable | ≤32 kg per section & mobility |

A preferred example platform is not designed to be routinely stood on. Its sturdiness & stability is to ensure it is safe to stand on accidentally or for maintenance.

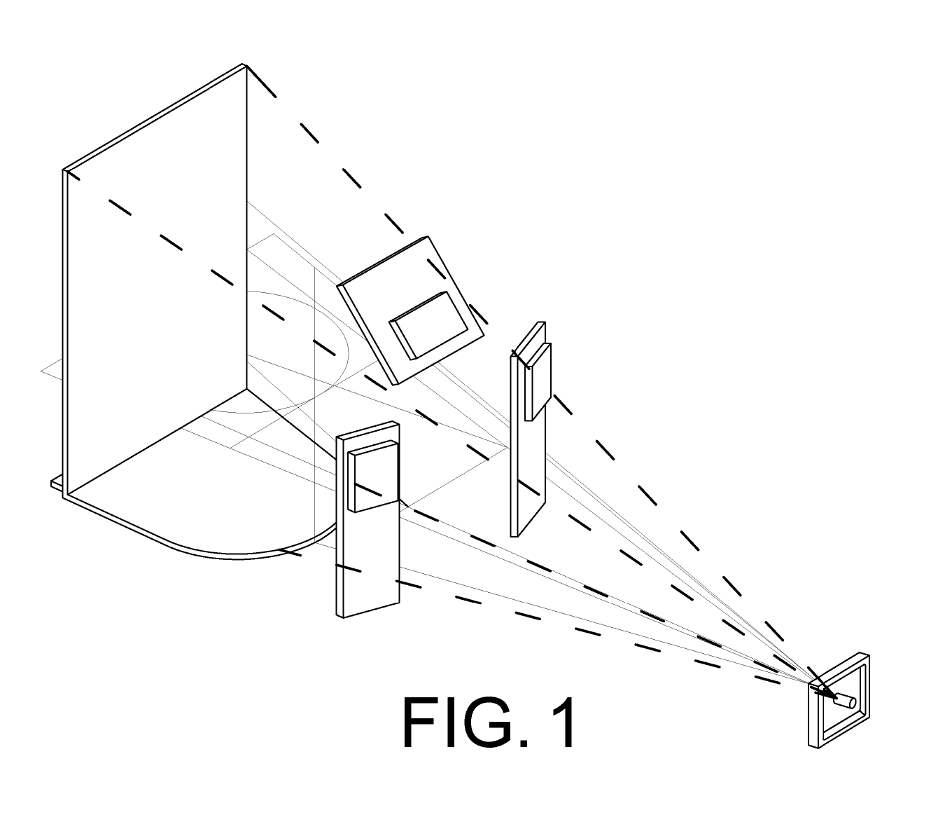

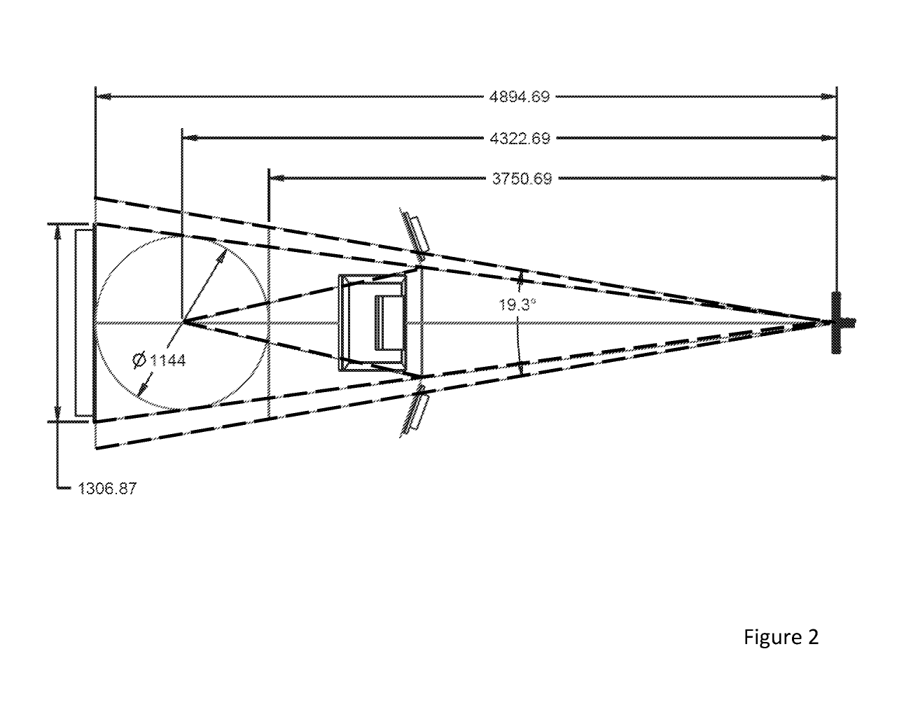

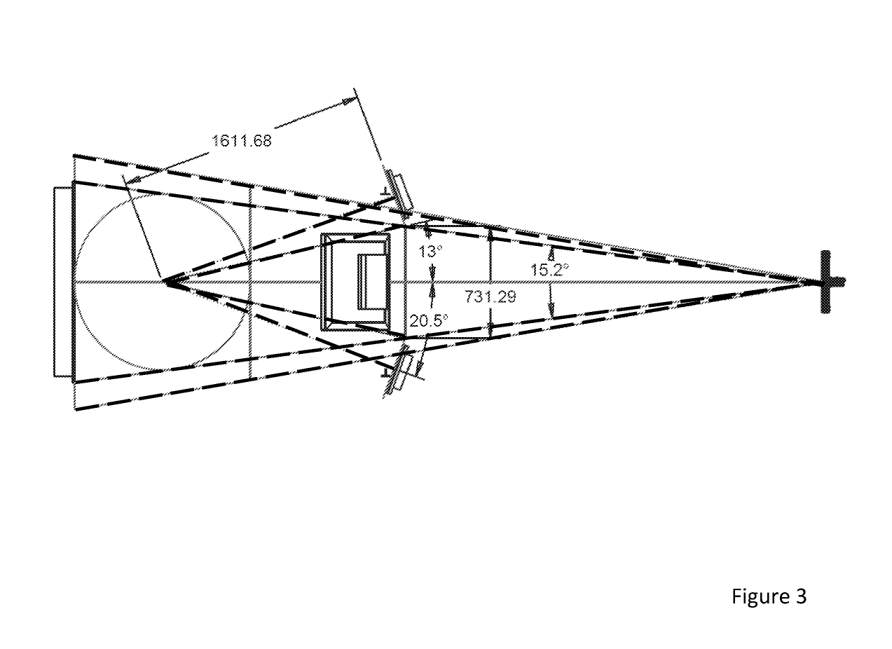

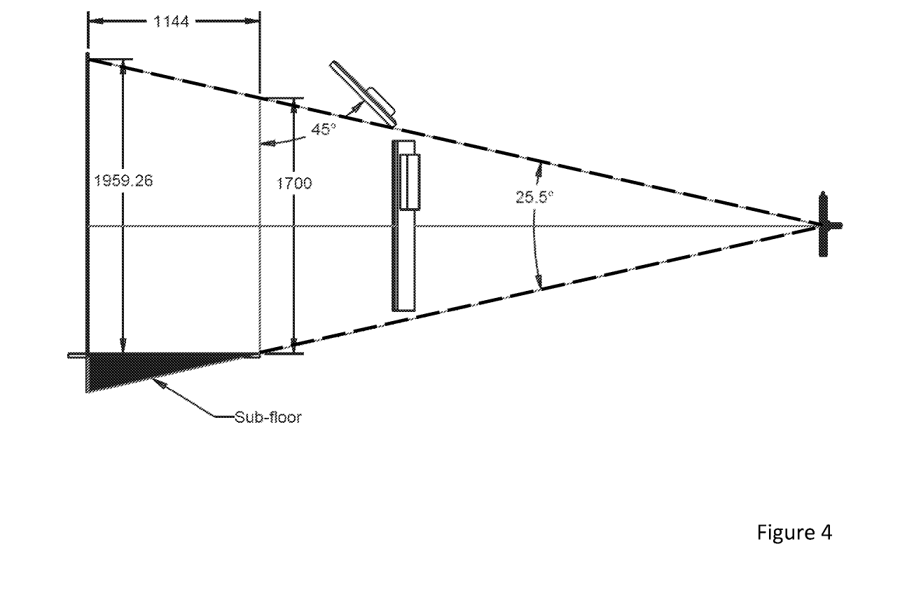

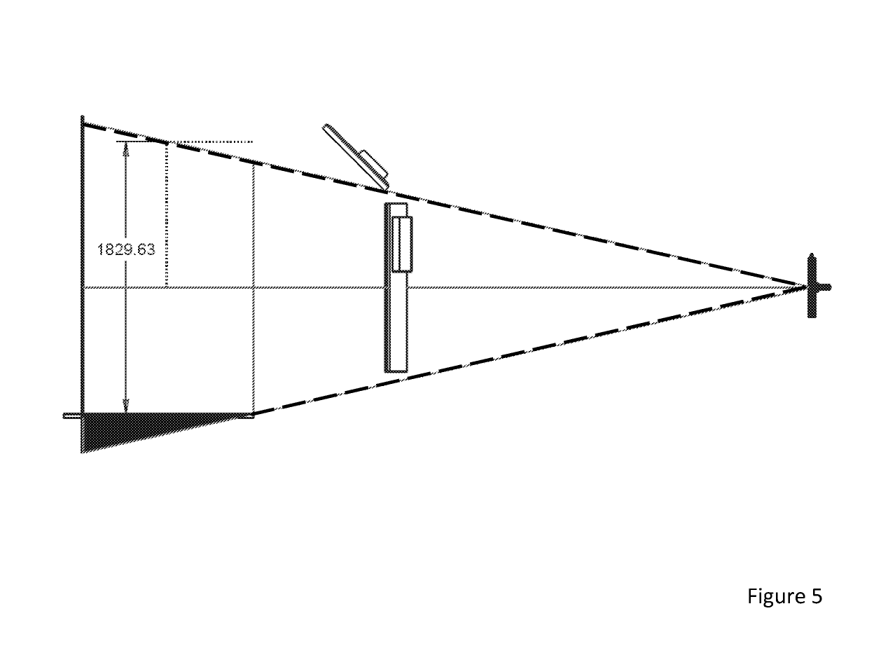

Furthermore basic requirements for a preferred example are illustrated diagrammatically (see e.g. FIGS. 1-5). The diagrams assume a field of view of 19.3° horizontal (FIG. 2) & 25.5° vertical (FIG. 4) (40 mm lens on 4/3″ sensor). The example functional diameter of the dressed mannequin (1144 mm) was also assumed (FIG. 2). A retro-reflective angle of 13° (FIG. 3) combined with these dimensions constrained lighting positions and backdrop positions relative to the camera.

2.2 Concept Options and Decisions

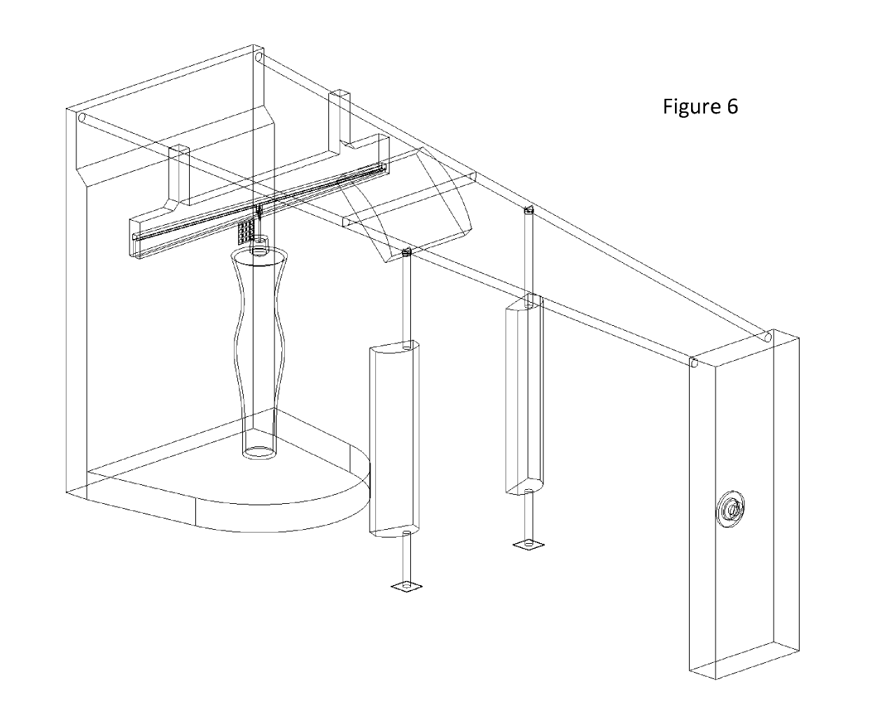

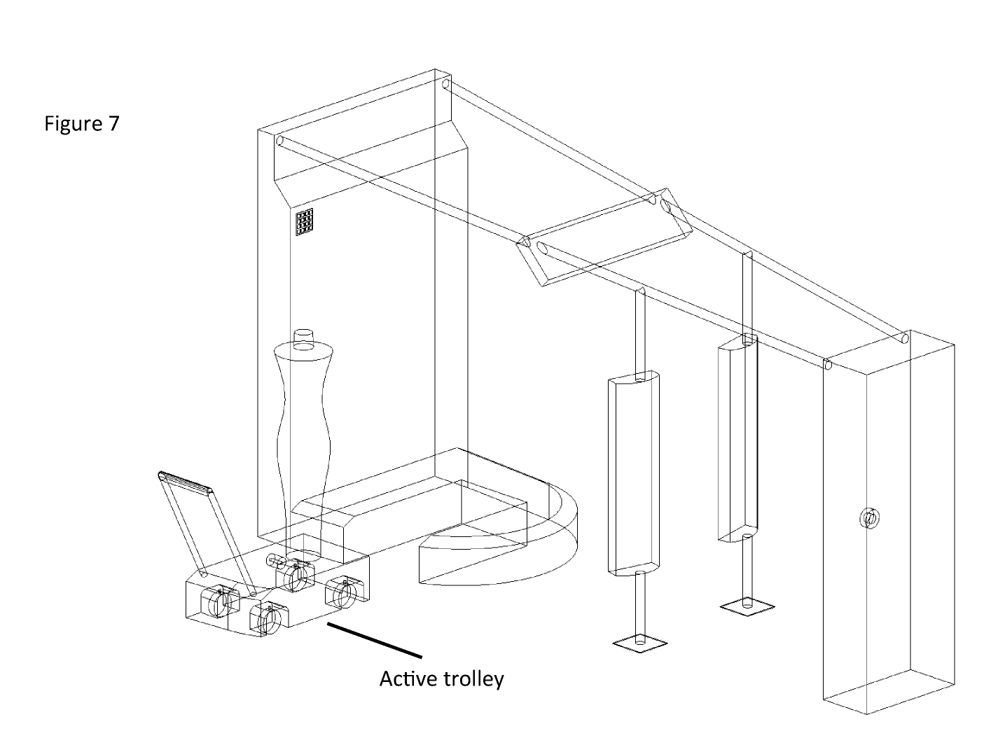

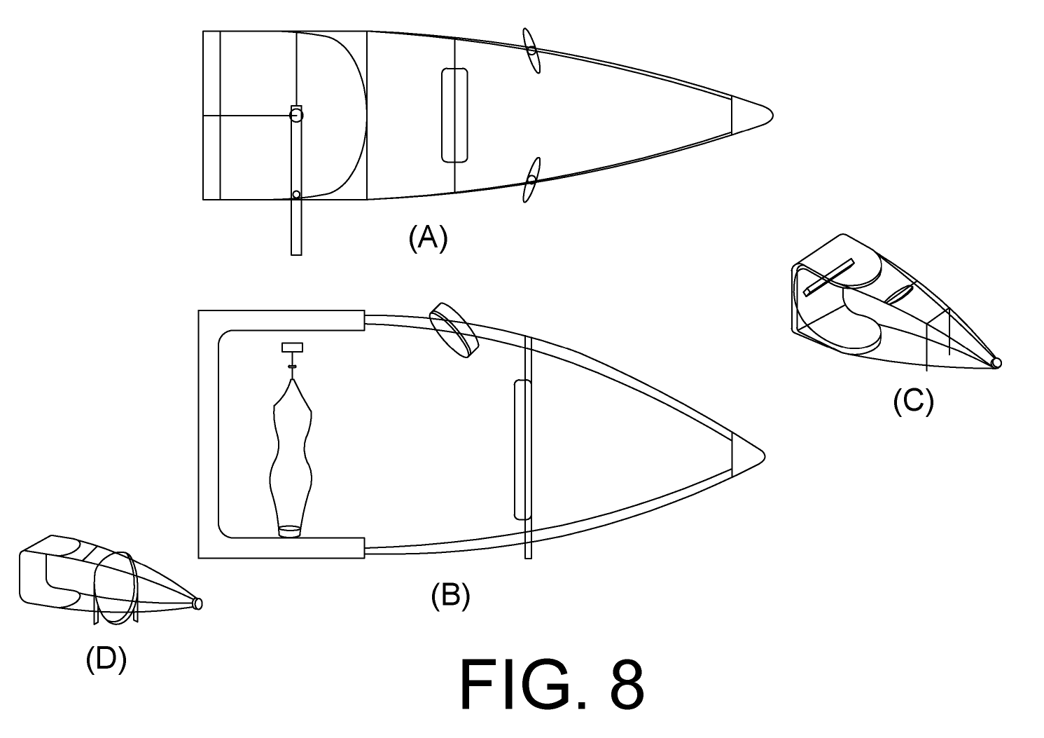

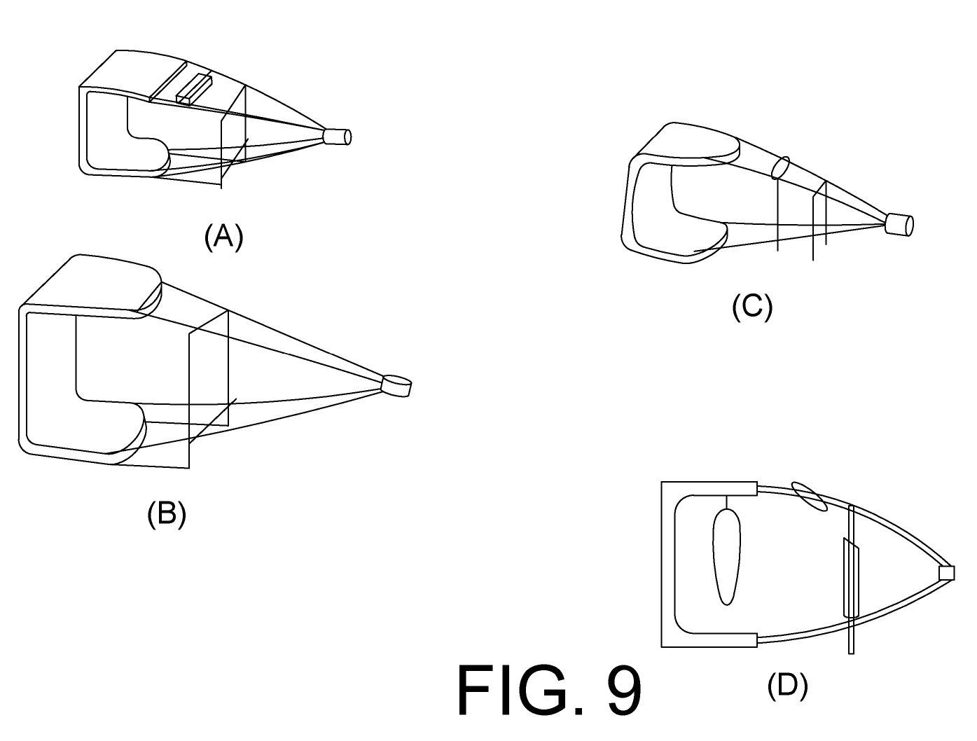

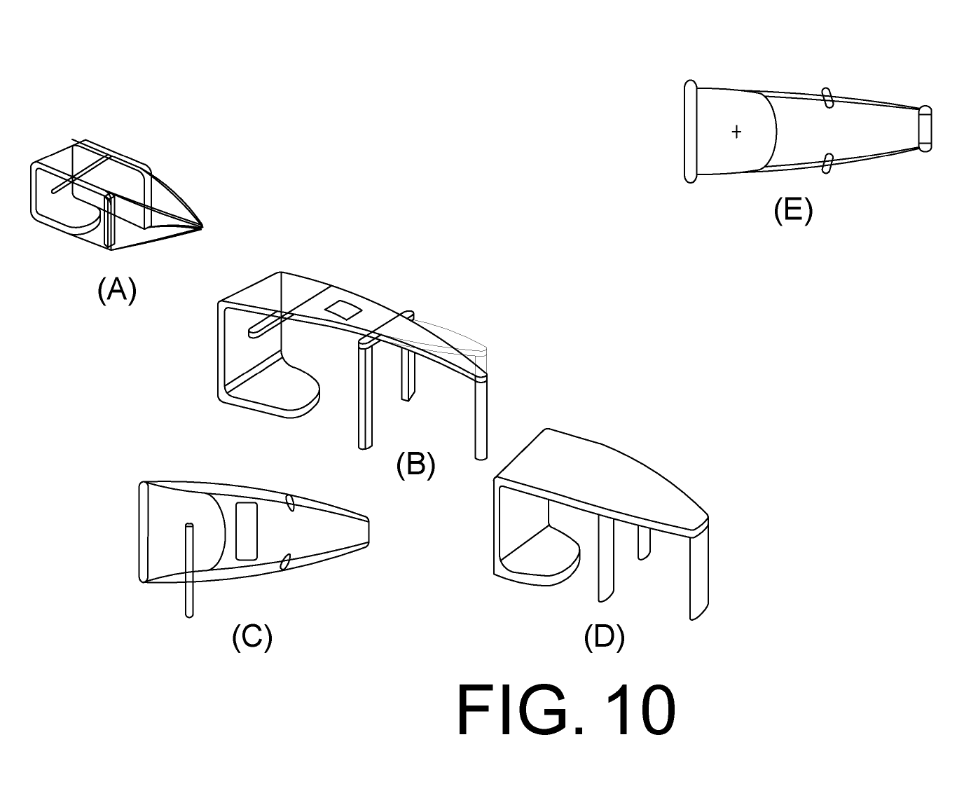

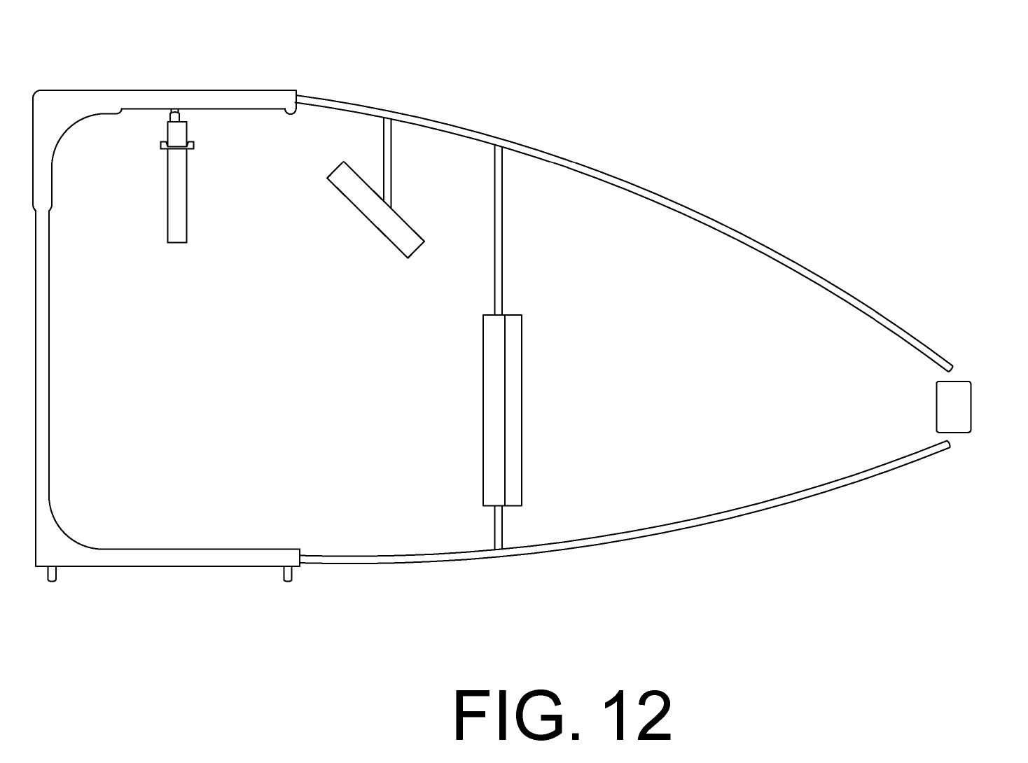

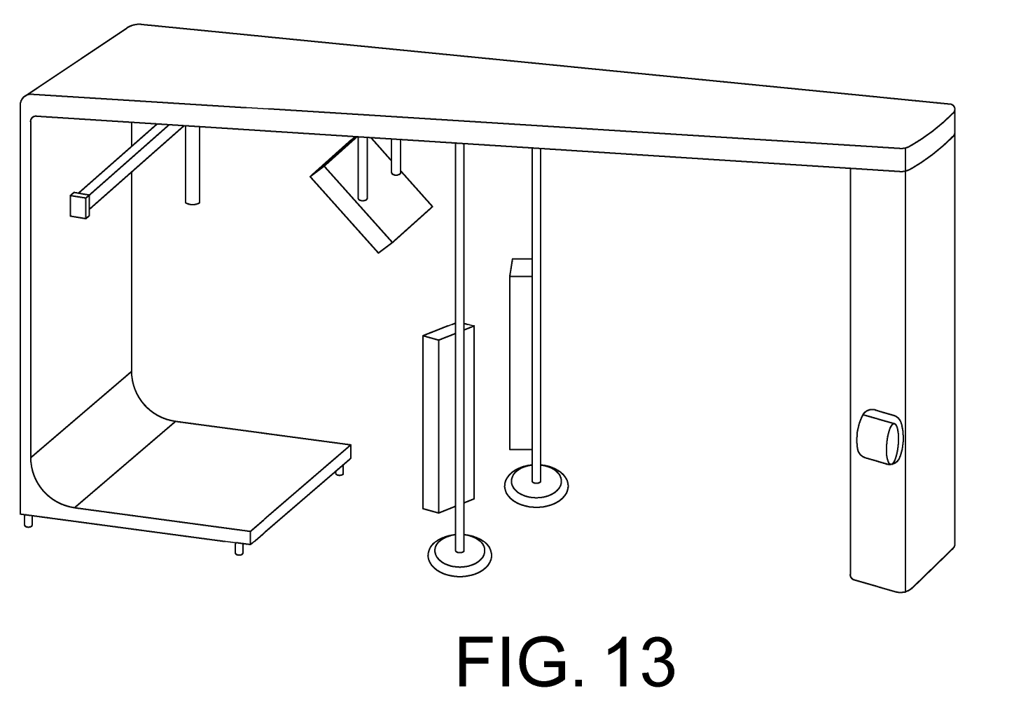

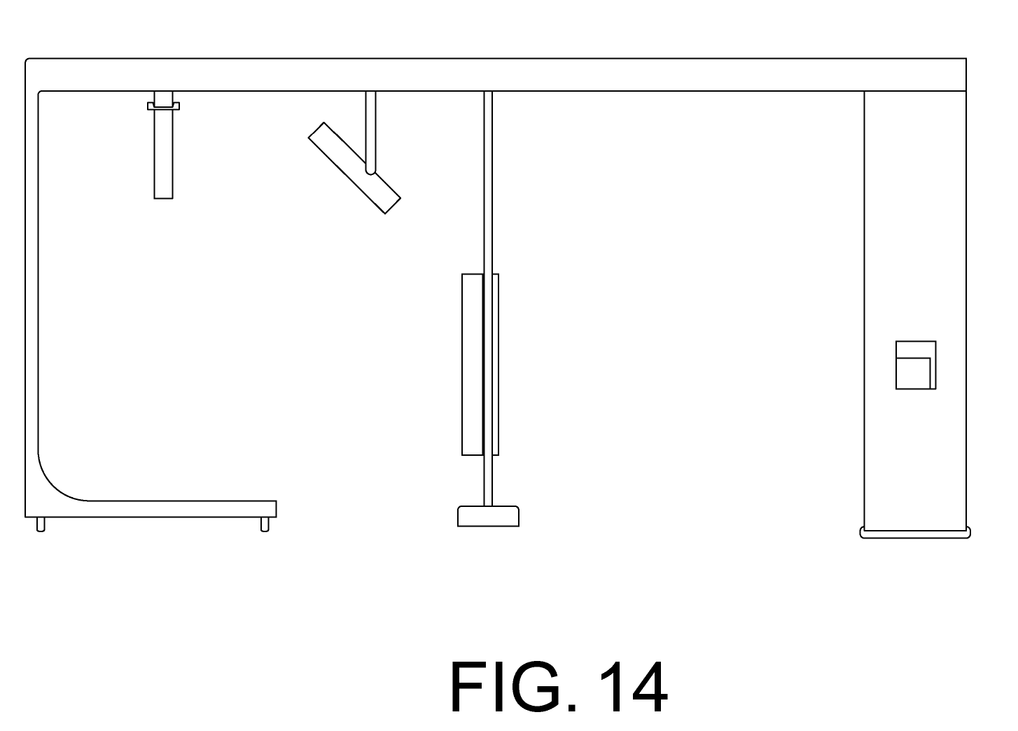

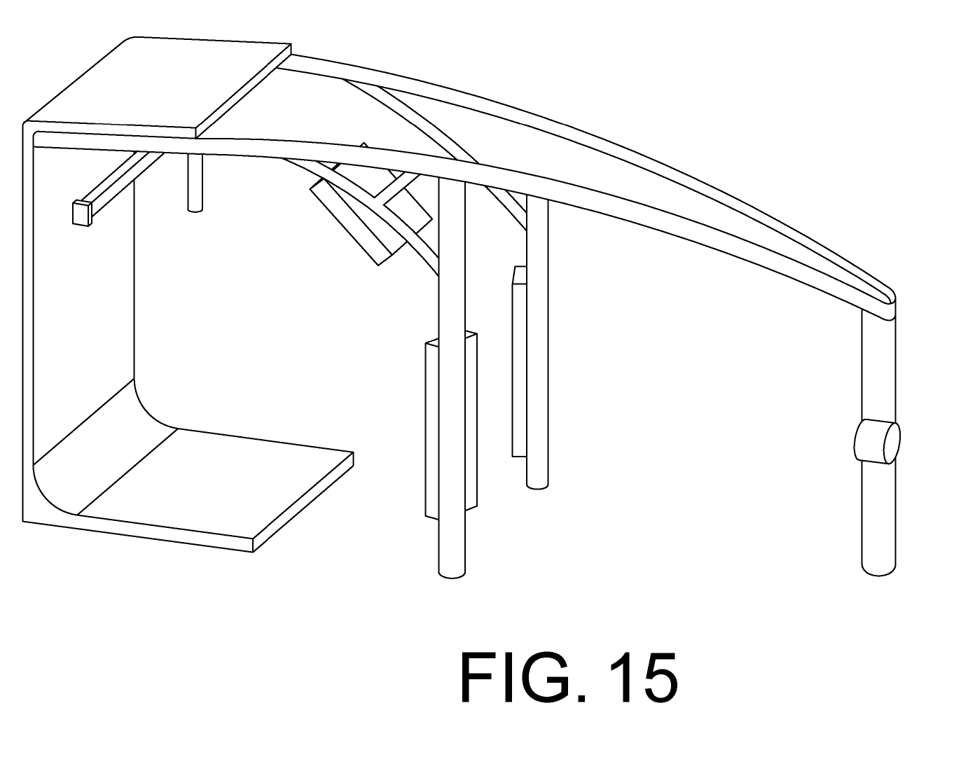

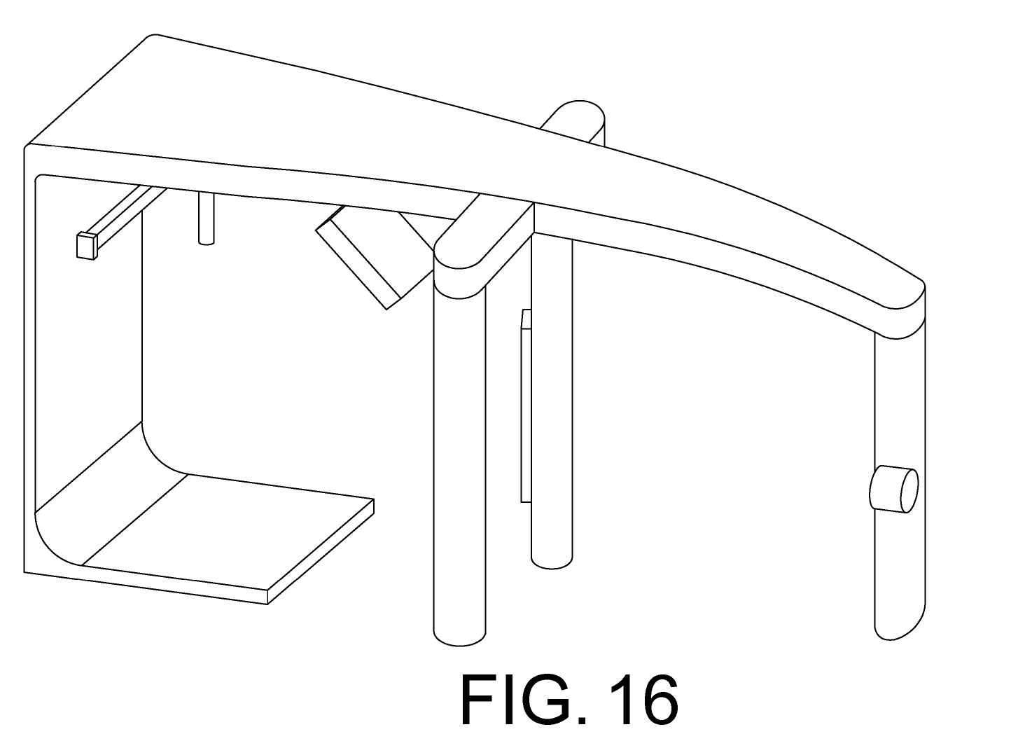

A primary concept option choice was between supporting the mannequin from above and supporting the mannequin from below. Two sketches were made to illustrate examples of these options (see FIGS. 6-7). Supporting descriptions were also recorded. There was also consideration given to marking the camera's field of view with beams that joined the camera housing to the rest of the rig. This was contrasted to a more standard arch-shaped construction. Example constructions are illustrated in FIGS. 8-16.

Example concept options noted for the frame and the structure are given in Table 2.2:

TABLE 2.2
Concept options for the frame and the structure

| Concept | Options | | | | |
|---|---|---|---|---|---|
| Mannequin | Mannequin | Mannequin | | | |
| Support | hangs from | supported from | | | |
| | above | below | | | |
| | (e.g. FIG. | (e.g. FIG. 7) | | | |
| | 6) | | | | |
| Frame | Alloy frame | Composite (e.g. | | | |
| | | Carbon Fibre) | | | |
| Room | Single box | Separate | Fixed length | Wind | Orbital |
| Design | room | mannequin & | by side bars | out rig | room |
| | | camera stand (e.g. | | length | |
| | | lasers) | | | |
| Component | Specific | Variable spaces | Free- | | |
| Layout | spaces for | for each | standing | | |
| | each | component built | components | | |
| | component | in | | | |
| | built in | | | | |
| Mannequin | Active | Passive | | | |
| Stands | mannequin | mannequin | | | |
| | stands | stands | | | |
| Mannequin | Mannequins | Mannequins load | Mannequins | | |
| Loading | load from | from right | load from | | |
| | left | | both sides | | |
| Roof | Roof | Roof structure | | | |
| Structure | structure | covers only the | | | |
| | runs full | mannequin | | | |
| | length of rig | photography | | | |
| | | position | | | |
| Side Lights | Side lights in | Side lights on | Side lights | | |
| | columns | beams | free standing | | |

A most challenging choice was deciding between supporting the mannequin from above or below. The mechanics of installing motion control systems above or below were similar in complexity. A major factor was a desire for a seamless even floor section and the range of garments that could be shot, seeing as the price difference between the two configurations was considered to be negligible.

The decisions made for preferred example designs and their reasons are given in Table 2.3:

TABLE 2.3
Example concept decisions for the frame and the structure.

| Concept | Option chosen | Reason |
|---|---|---|
| Mannequin | Mannequin hangs | Seamless even floor, range of |
| Support | from above | garments that can be shot, “active |
| | (e.g. FIG. 6) | trolley” (e.g. FIG. 7) may be very |
| | | expensive |
| Frame | Alloy frame | A aluminium profile system (e.g. |
| | | Paletti) is much simpler to modify |
| Room | Single box room | Enabled small footprint, best |
| Design | | accessibility and simplest design |
| Component | Specific spaces | Easier assembly and less chance of |
| Layout | for each component | tampering, although modification is |
| | built in | possible (see above) |
| Mannequin | Passive mannequin | Much cheaper & no power issues |
| Stands | stands | |
| Mannequin | Mannequins load | Price difference was negligible, and |
| Loading | both sides | allows for experimentation of ops |
| | | model |
| Roof | Roof structure runs | Aesthetically neater |
| Structure | full length of rig | |
| Side Lights | Side lights in | Better supports roof structure and |
| | columns | aesthetically neater |

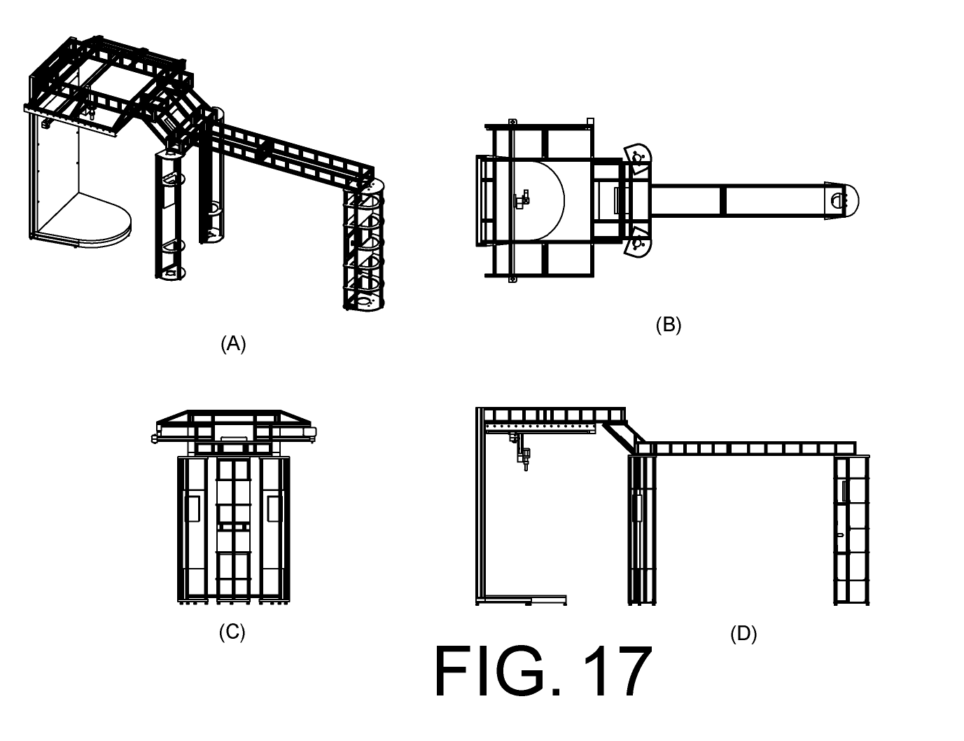

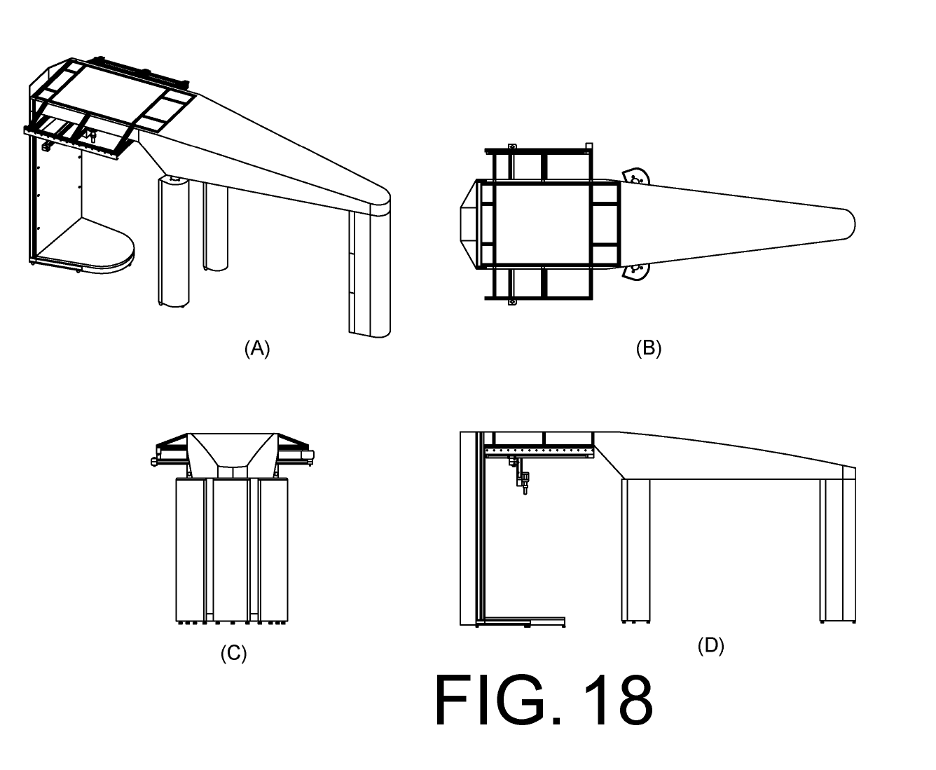

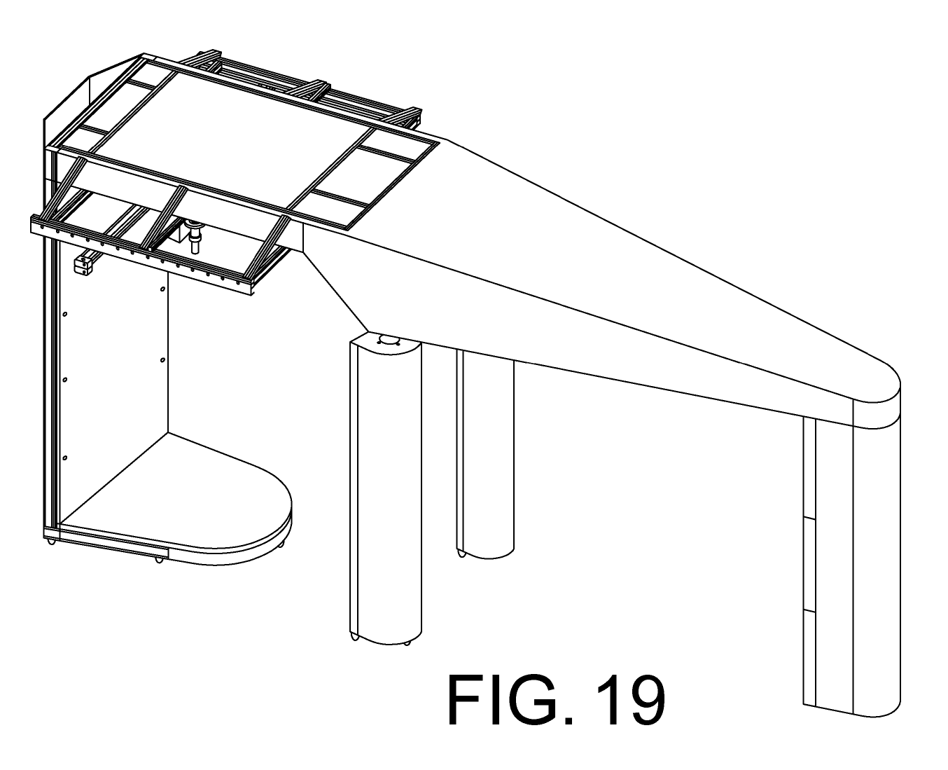

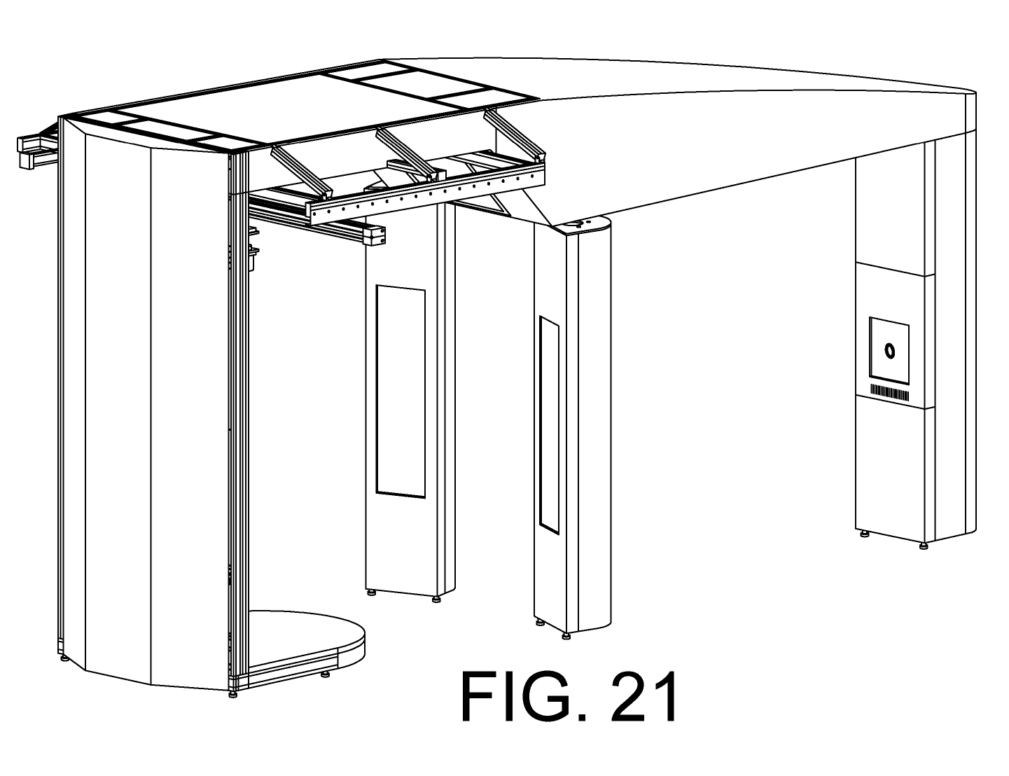

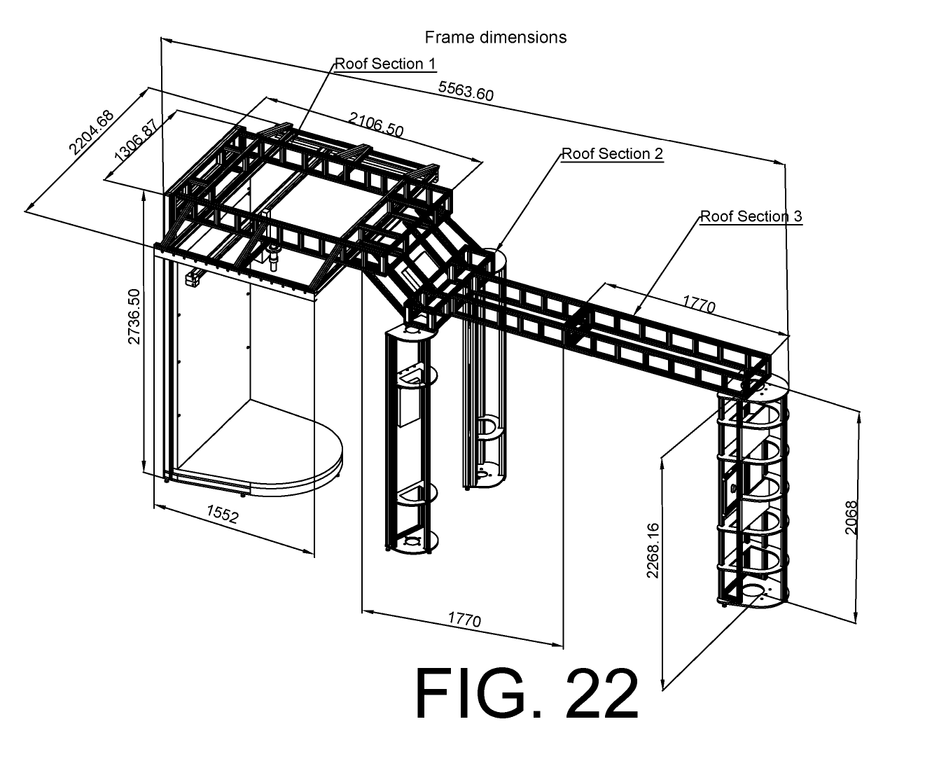

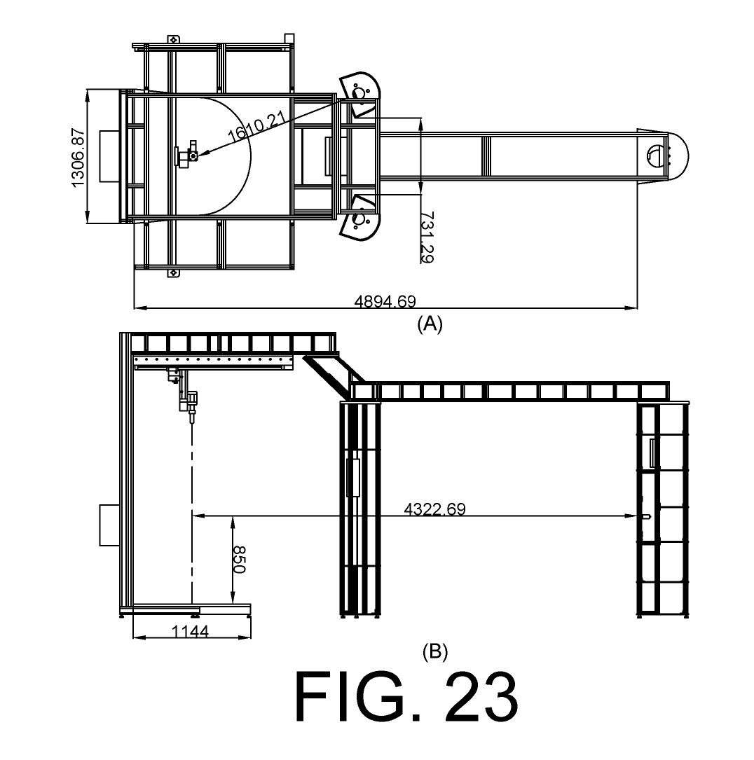

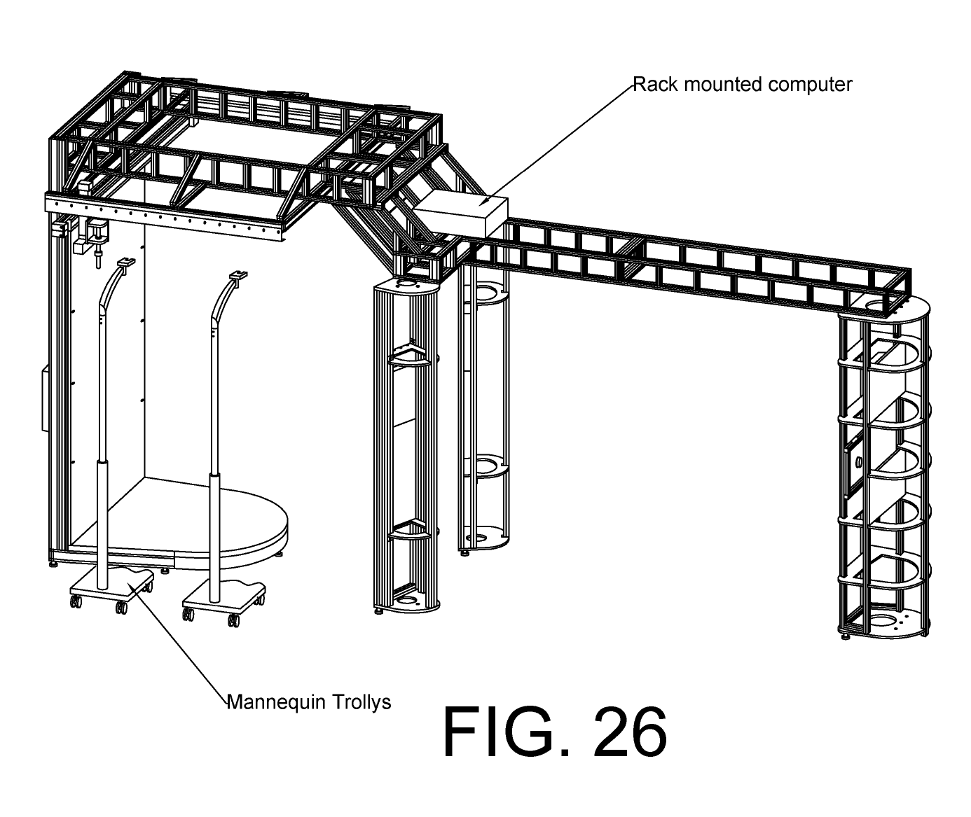

Preferred examples are illustrated in FIGS. 17-25. In an example, a modification has been made to the design to house a larger computer system that may be required, after testing on image processing programs has shown considerable computing power may be necessary. A proposed location for a computer system is illustrated in FIG. 26.

3. Camera Component

The use of an appropriate imaging device on the photo-rig was seen as very important to providing a high-quality and reliable system. The implementation of automatic texture cutout technology (see, e.g. U.S. Pat. No. 8,605,148B2) dictated cycles of up to 16,000 daily shutter actuations. SLRs (Single Lens Reflexes) and other such studio cameras employ mechanical shutters rated with a lifespan of around 150,000 actuations, so with their implied life expectancy of less than two weeks, it was determined that only shutterless cameras would be suitable. Research was undertaken to compare video cameras and industrial cameras, as these are the two most common types of shutterless camera. In principle, either would provide the endurance required, so appraisal was made with regard to cost and ease of integration.

There was a wide range of prices for video cameras, and we focused on the cheapest 4K camera available. This had a sufficient resolution, but the task of extracting lossless image data from the device was deemed to be too challenging. The SDI (Serial Digital Interface) output requires frame grabbing using specialized hardware, and even after this, the output is not comparable to RAW image data. More expensive cameras may have allowed finer control, but the principle of industrial cameras was more appealing.

A camera raw image file contains minimally processed data from the image sensor of e.g. a digital camera, image scanner, or motion picture film scanner. Raw files are so-named because they are not yet processed and therefore are not ready to be printed or edited with a bitmap graphics editor. Normally, the image is processed by a raw converter in a wide-gamut internal colorspace where precise adjustments can be made before conversion to a “positive” file format such as TIFF or JPEG for storage, printing, or further manipulation. This often encodes the image in a device-dependent colorspace.

Cameras of various industrial camera manufacturers were investigated. Our aim was to find the camera with the largest sensor affordable so a 40 mm lens could be used at an acceptable distance from the mannequin. In an implementation, we adopted a GigE Vision camera, which has a 4/3″ (22.7 mm diagonal) sensor, providing a crop factor relative to 35 mm of just 1.9×, allowing a camera-mannequin distance of 3.75 m. The GigE Vision camera is controlled and sends images via Ethernet, allowing very precise control and synchronization, and can output RAW images for a perfectly lossless imaging pipeline.

The GPIO (General Purpose Input/Output) on the camera enables high-speed triggering from the motion controller, eliminating dependency on non-realtime software for synchronization. During mannequin rotation, the images captured are therefore at precisely the same angle as those captured 360° earlier. This alignment between images is essential to achieving accurate automatic texture cutout (see, e.g. U.S. Pat. No. 8,605,148B2) without delaying the photography process.

In an example, the camera may be controlled via a camera control software development kit (SDK) (e.g. GigE Vision compliant SDK in our implementation). This allows fine control of many parameters. The images are passed on to RawTherapee for demosaicing and other RAW-level processing. The images are then passed on to an image processing software (e.g. ImageMagick) for further processing. Using open-source free software enables us to minimize costs and keep as much of the pipeline in a Linux environment as possible.

3.1 Requirement Definition

An example of high-level requirements for the cameras is given in Table 3.1, ranking in preferred example order of importance and ease of implementation:

TABLE 3.1
Example requirement definitions for the cameras

| Requirement | Quantifier/Detail |
|---|---|
| High Quality Optics/Lens | Professional grade (e.g. Canon) |
| Off the shelf model | Majority commercially available kit |
| Reliable/Long Life | Lasts at least 1 year @250 garments/day |
| User Repairable/ | All short lifespan components (<500 hrs) |
| Replaceable | minimal training replaceable |
| Ensure Fast garment | Take 250+ Images Per 8 Hours |
| throughput | |
| Allow Adjustable | Within mannequin height (approx. 5′10″) |
| Camera Height | |

Output quality, speed, and durability were considered most important features of a camera. An undesirable example camera (Canon EOS 6D) had excellent quality (20.2 MP), poor speed (4.5 fps) and unacceptable durability (150,000 shutter actuations). Cost calculations over 3 years were recorded. A 4K video camera (e.g. BlackMagic) seemed to be the most economical choice, with good quality (8.4 MP), excellent speed (30 fps) and excellent durability (electronic shutter).

3.2 Concept Options and Decisions

The primary concept option choice was between digital single-lens reflex cameras (DSLR), video or industrial cameras. Details of each are available from manufacturers' websites.

Example concept options noted for the cameras are given in Table 3.2:

TABLE 3.2
Example concept options for the cameras

| Concept | Options | | |
|---|---|---|---|
| Lens focal | Wider angle lens | 50 mm/40 mm | |
| length | | prime lens | |
| Zooming | Optical zoom | Fixed lens | |
| Interconnect | USB 3.0/Thunderbolt/ | USB 2.0/Slower | |
| type | GigE | interconnects | |
| Calibration | Automatic calibration | Manual user | Manual |
| | | calibration | engineer |
| | | | calibration |
| Camera | Hi res video cam | DSLR | Industrial |
| | | | camera |
| ISO Range | High ISO range (low | Lower ISO range | |
| | noise) | (higher res) | |
| Use of | 3 camera setup | 1 camera setup | |
| Multi-camera | | | |
| System | | | |
| 2D vs. 3D | Active stereo | Standard 2D capture | |
| Photography | | | |
| Camera | Hidden | Open (accessible) | |
| Visibility | (compartmentalized) | | |
| Shutter type | Electronic shutter | Mechanical shutter | |

Most of the concept options noted above are influenced by the choice of camera type. Initial analysis showed product cost was lowest for adopting a video camera (e.g. BlackMagic). However, integration cost and unknowns quickly made video seem to be a risky option. The decisions made and their reasons are given in Table 3.3:

TABLE 3.3
Example concept decisions for cameras

| Concept | Option chosen | Reason |
|---|---|---|
| Lens focal | 50 mm/40 mm prime lens | Least optical distortion and aberration, |
| length | | decent compression distortion @4 m |
| Zooming | Fixed lens | Optical zoom unnecessary from a |
| | | product perspective, less distortion |
| Interconnect | USB 3.0/Thunderbolt/ | Quick feedback on UI desirable, 3x |
| type | GigE | number of images taken for the retro- |
| | | reflective mannequin and automatic- |
| | | cutout solutions need transferring |
| Calibration | Manual user calibration (and | Colour charts need hiding from light |
| | possibly automatic focus | to maintain colour stability, so manual |
| | calibration) | uncovering is necessary |
| Camera | Industrial camera | Good SDK and low integration cost, |
| | | simple triggering and data transfer |
| ISO Range | Lower ISO range (higher res) | High ISO was not useful, as low |
| | | shutter speeds (0.02 s) and wide |
| | | apertures (f/5.6) can be used. Bright |
| | | lighting is much more important |
| Use of | 1 camera setup | Advantages of 3 camera setup are not |
| Multi-camera | | yet clear, much more expensive. |
| System | | Design leaves potential for modularity |
| | | for this. |
| 2D vs. 3D | Standard 2D capture | Active stereo would require |
| Photography | | development work. Implementation of |
| | | stereo not possible for a simple |
| | | example. Modularity possible. |
| Camera | Hidden (compartmentalized) | The camera has no buttons or |
| Visibility | | switches on its body and the |
| | | connectors are very secure. To avoid |
| | | tampering it will remain hidden |
| Shutter type | Electronic shutter | Much longer component lifetime (>5 |
| | | years expected, vs. <2 months for |
| | | Canon 1Ds/x) |

The relevant software component uses an SDK to communicate over ethernet. In an implementation, triggering is done directly from motion controller to camera via Hirose connector. In an example, image processing is done using our own application to convert stream to DNG (Digital Negative), using RawTherapee to convert to TIFF, and using ImageMagick to convert to PNG.

4. Motion Control Component

Three downsides of an earlier photo-rig were noted. Firstly, we relied upon a third-party turntable (e.g. LinearX LT360) for mannequin rotation which overly-constrained our software and hardware choices. Secondly, lifting and moving mannequins manually resulted in dropping and knocking them, thereby reducing their average lifespan to less than a year. Thirdly, lifting mannequins (usually at the waist or the crotch) to load them often disturbed the clothing fabric enough to require redressing in-situ, causing a bottleneck in the system.

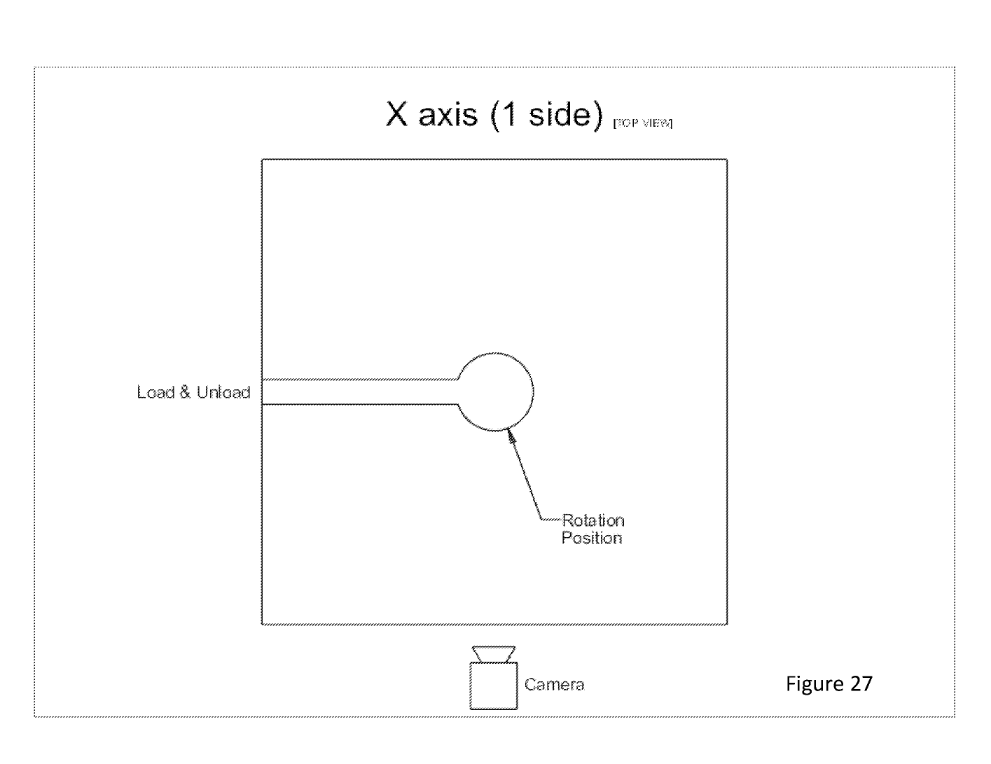

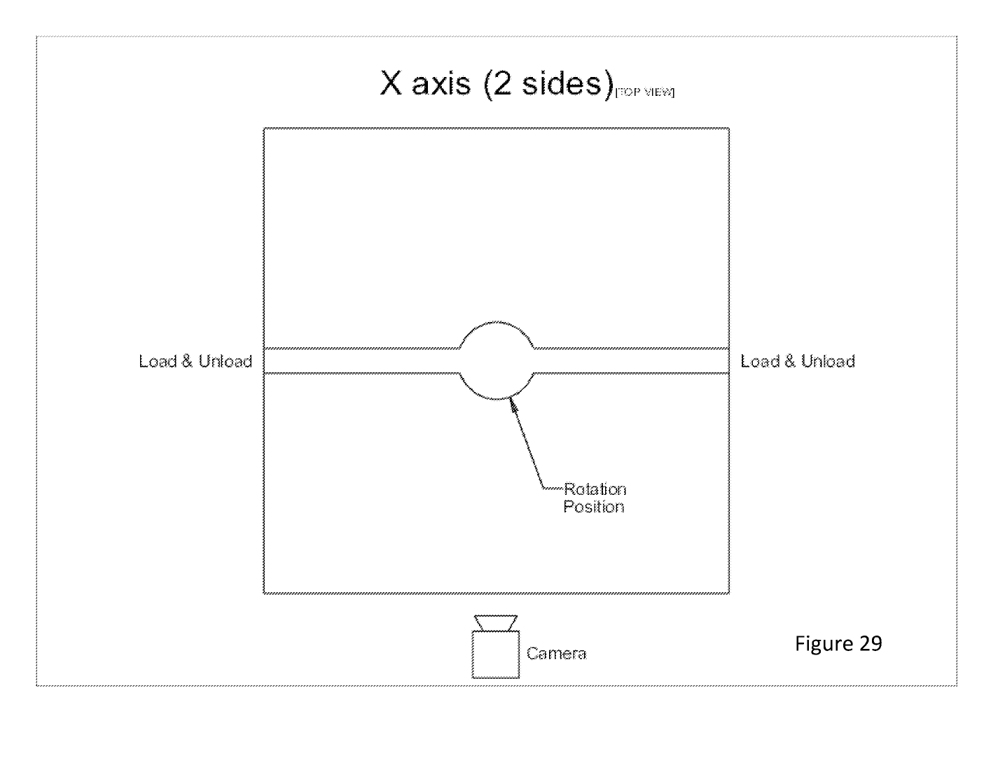

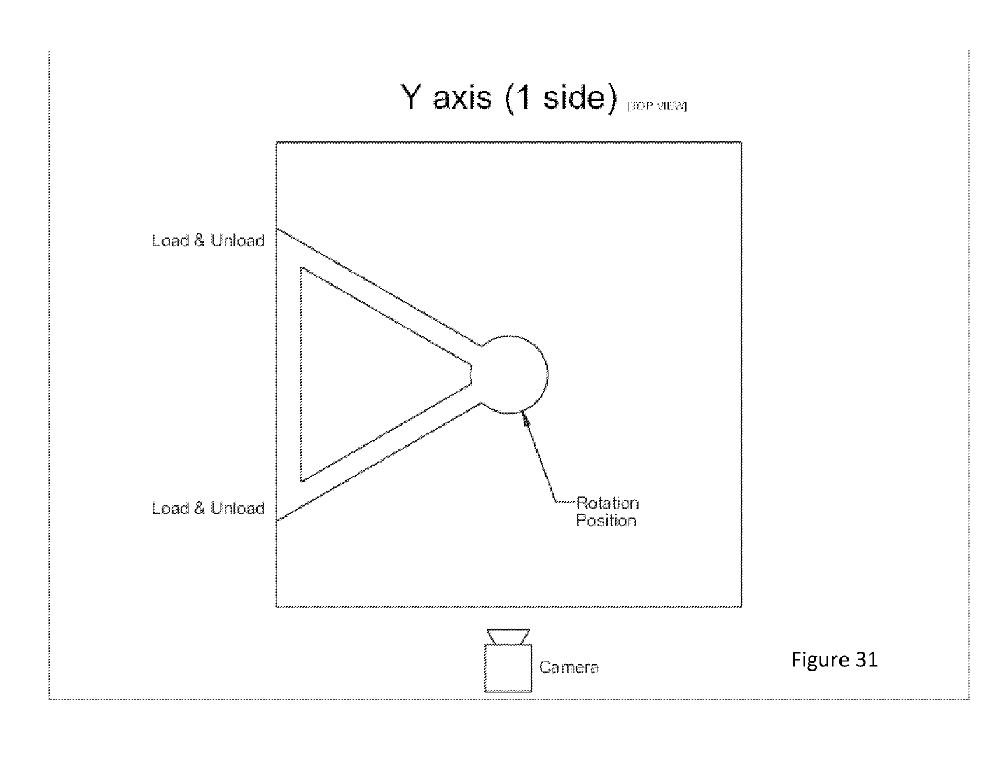

To address the aforementioned problems, we redesigned the motion control module for the rig system. After testing various studio layouts and ways of working, we eventually settled upon a 4-axis system, allowing overhead loading and unloading on both sides of the photo-rig (see FIGS. 27-32, for example). The extra capture time required by the automatic-texture-cutout system (see, e.g. U.S. Pat. No. 8,605,148B2) could be offset by gains in operational efficiencies, provided by a faster loading/unloading mechanism.

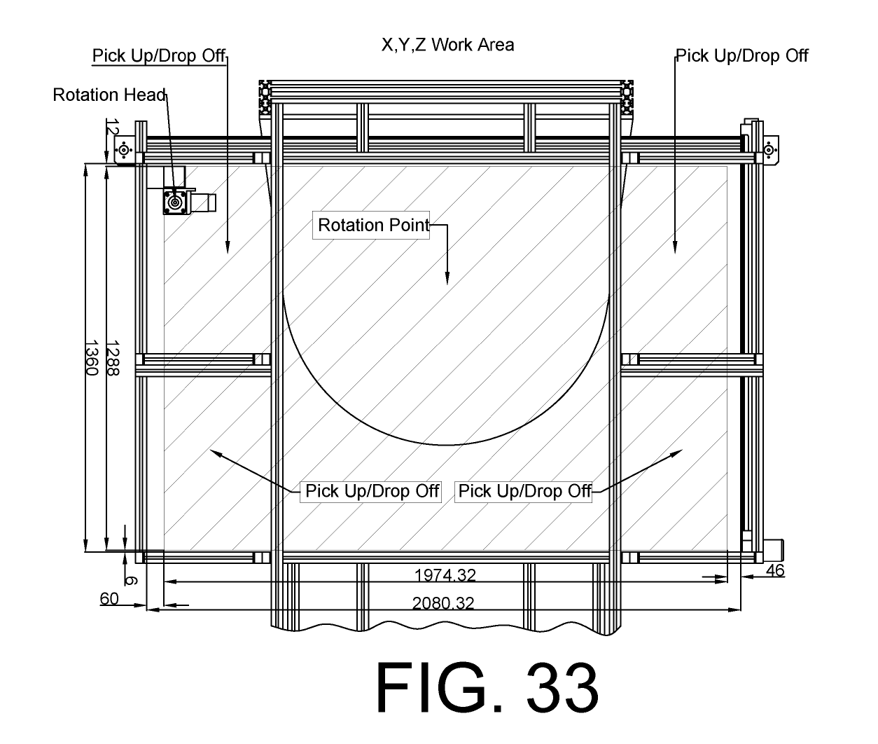

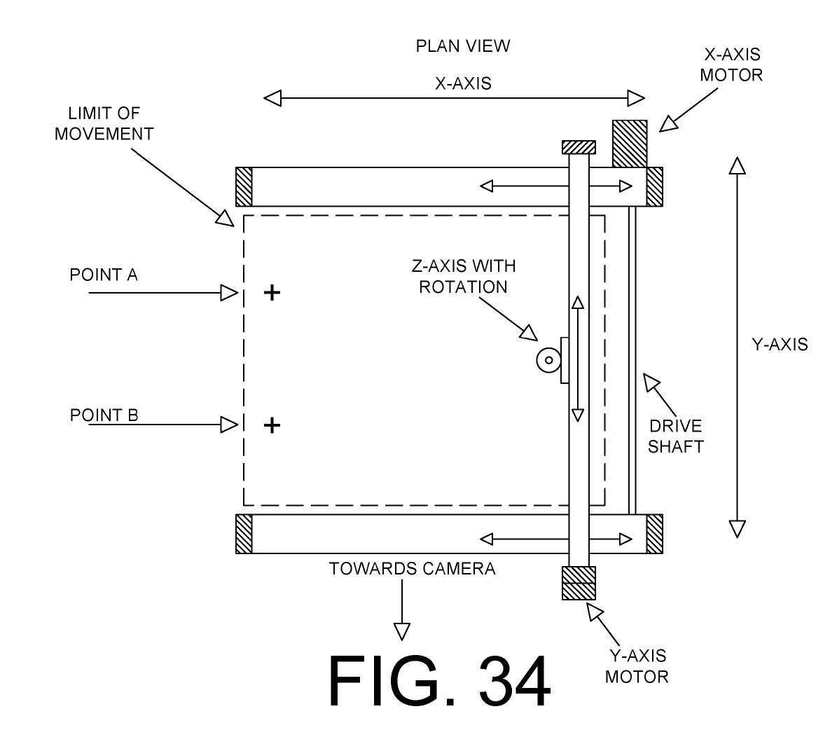

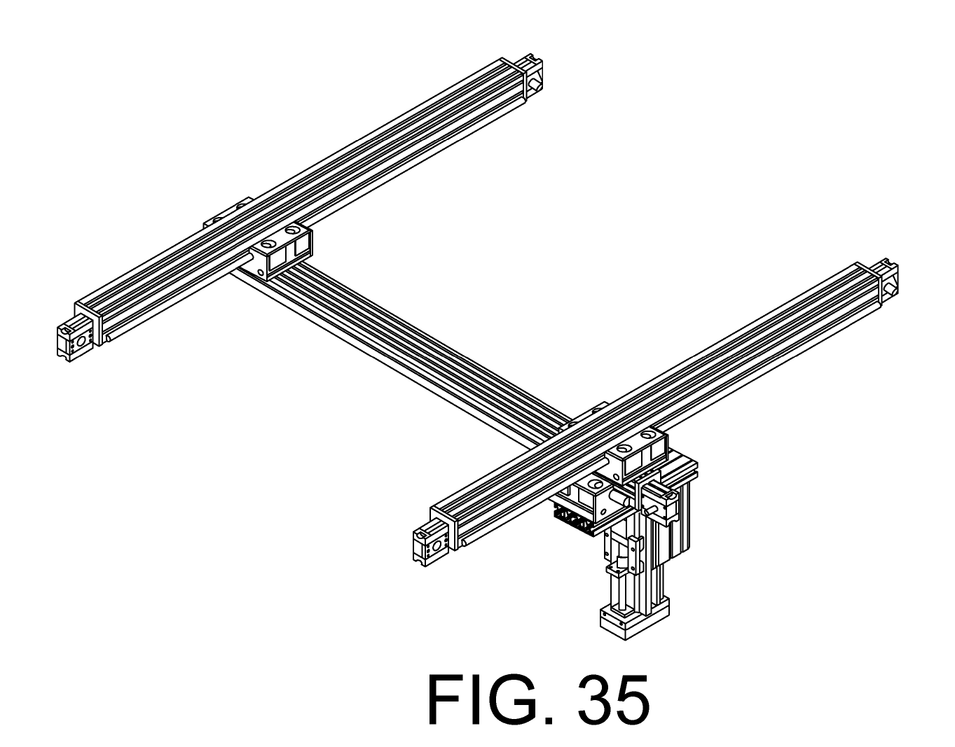

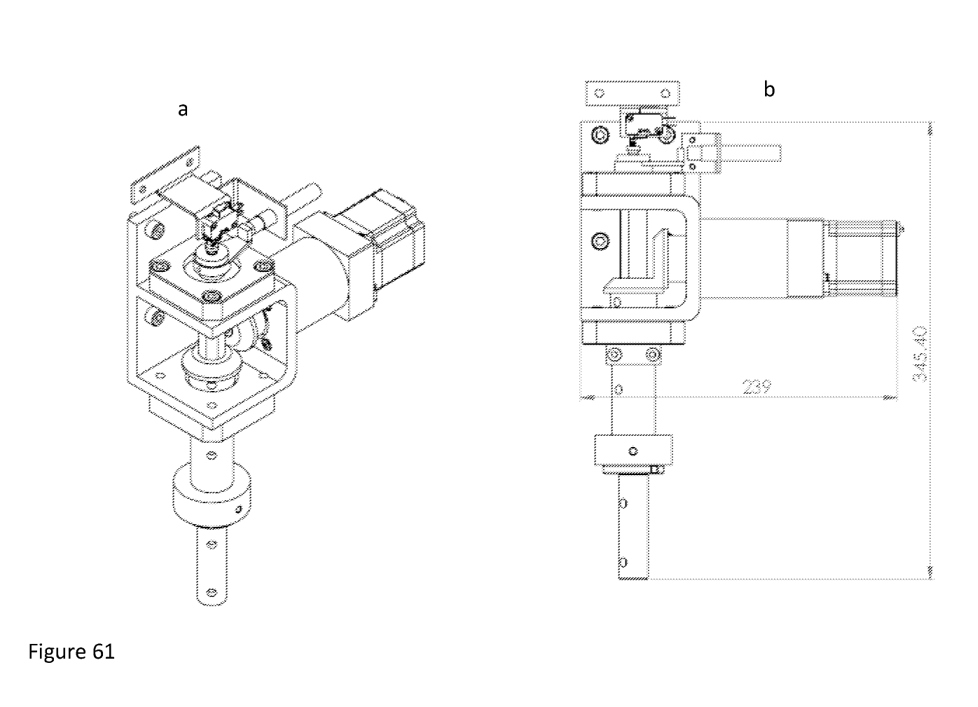

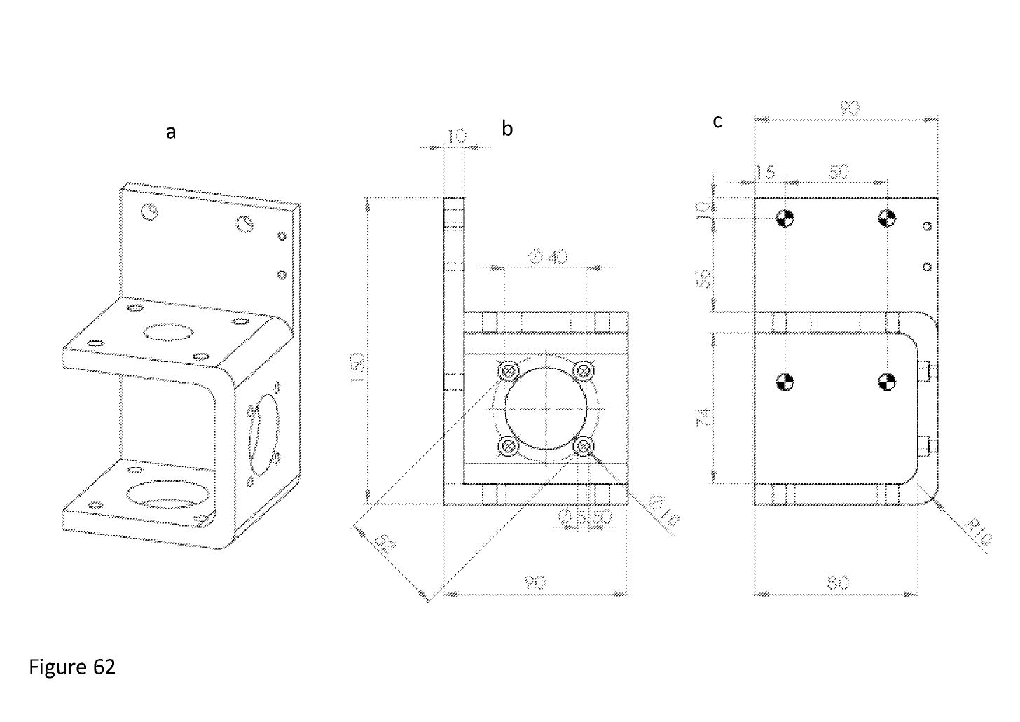

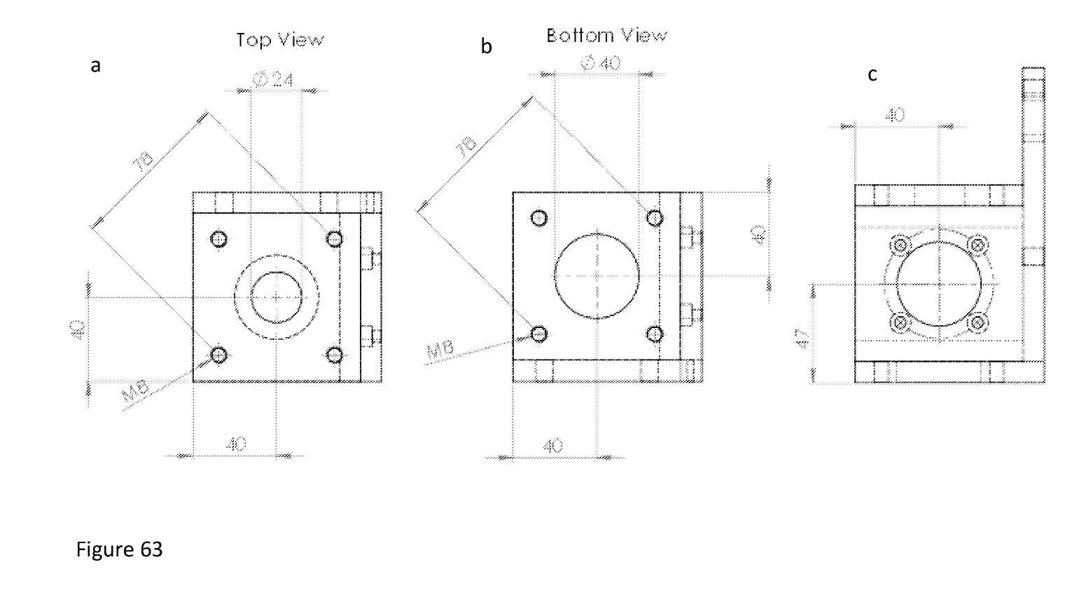

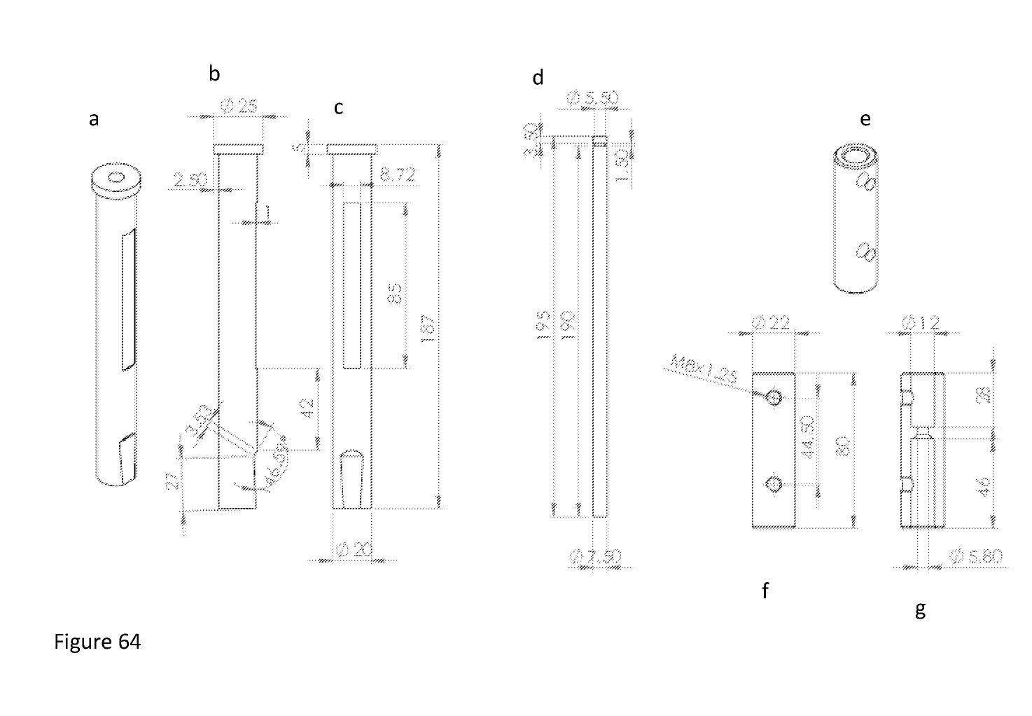

We designed and built a gantry system of 3 linear axes (see FIGS. 34-35 for detailed views of an example design) and 1 rotational axis (see FIGS. 61-64, for example), allowing loading and unloading from any point in a 2 m×2 m overhead grid (see FIG. 33, for example). In an example, these axes are controlled via a motion controller, itself controlled by Modbus protocol over Ethernet from the industrial PC.

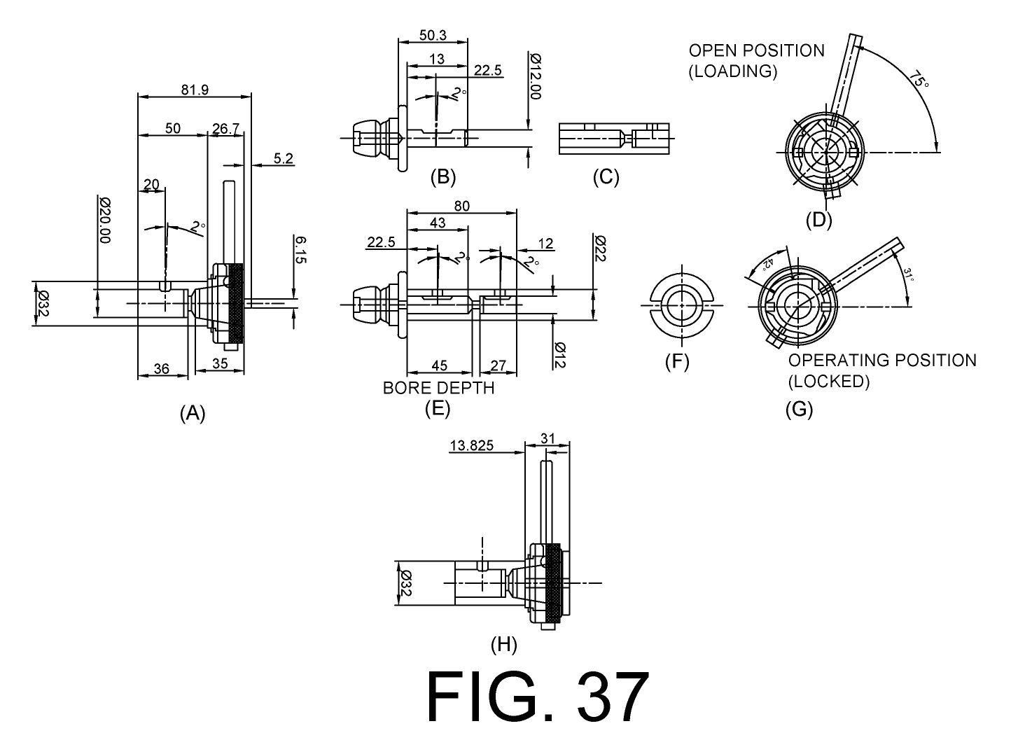

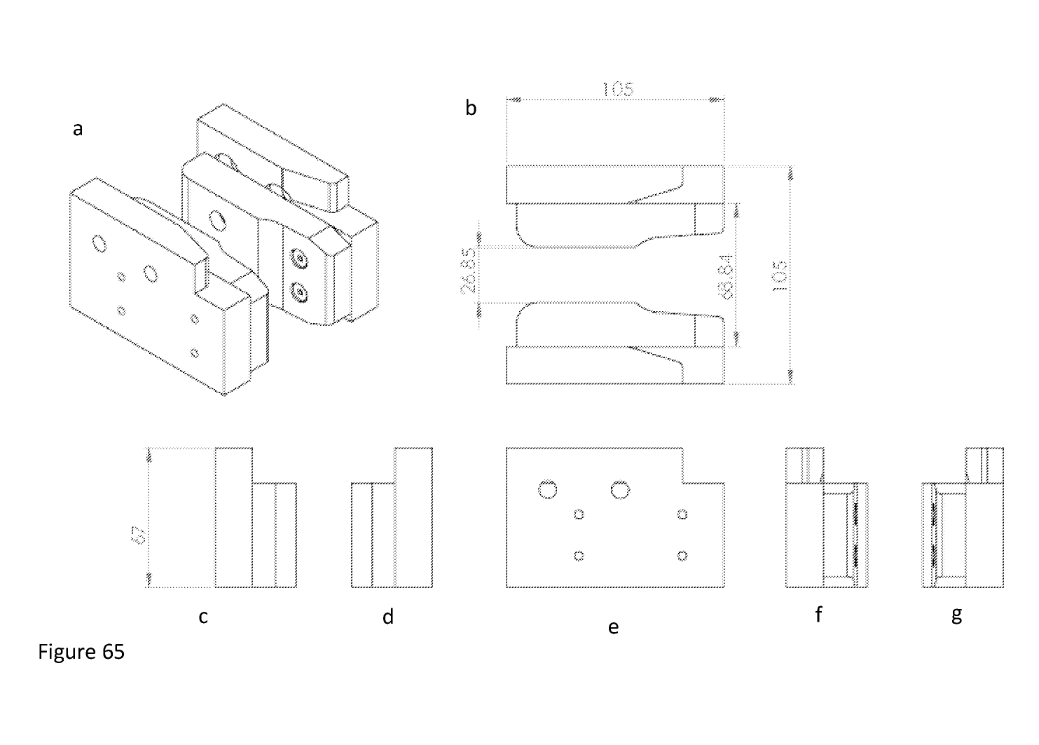

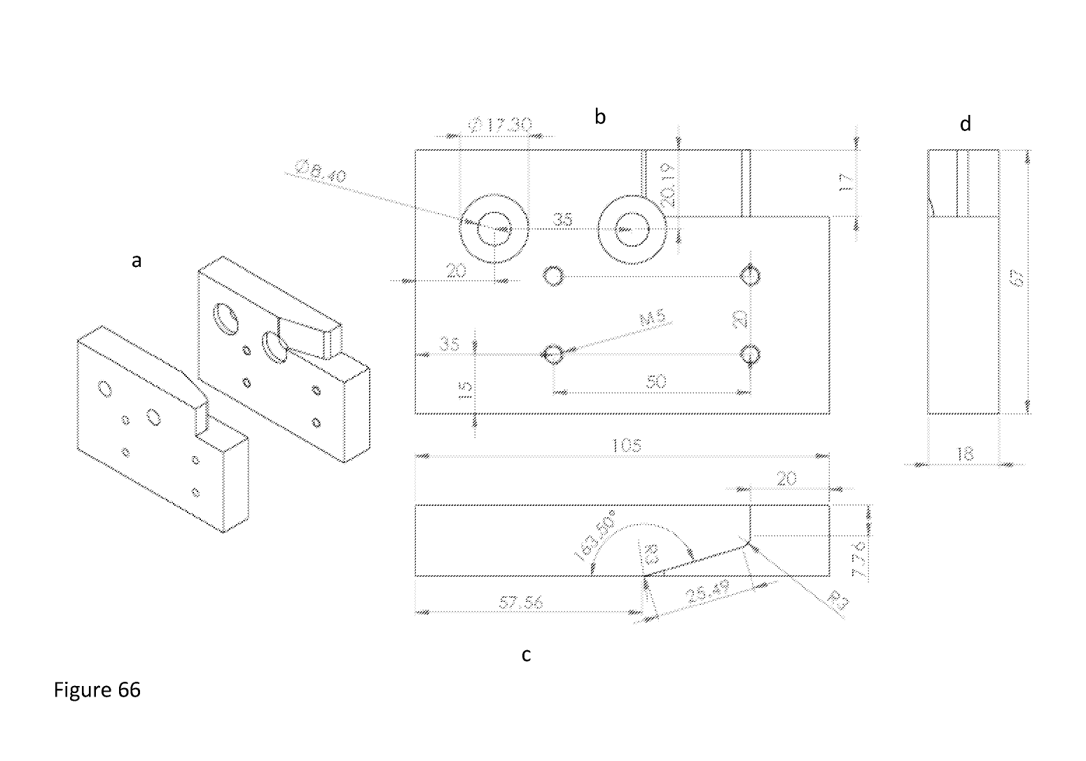

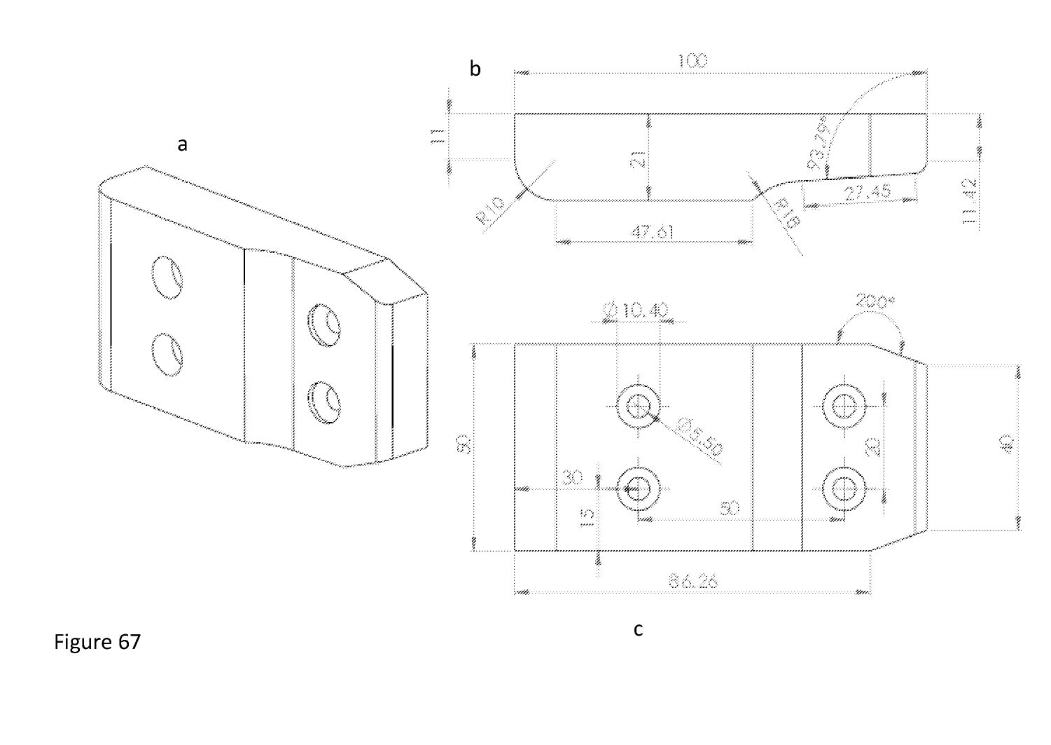

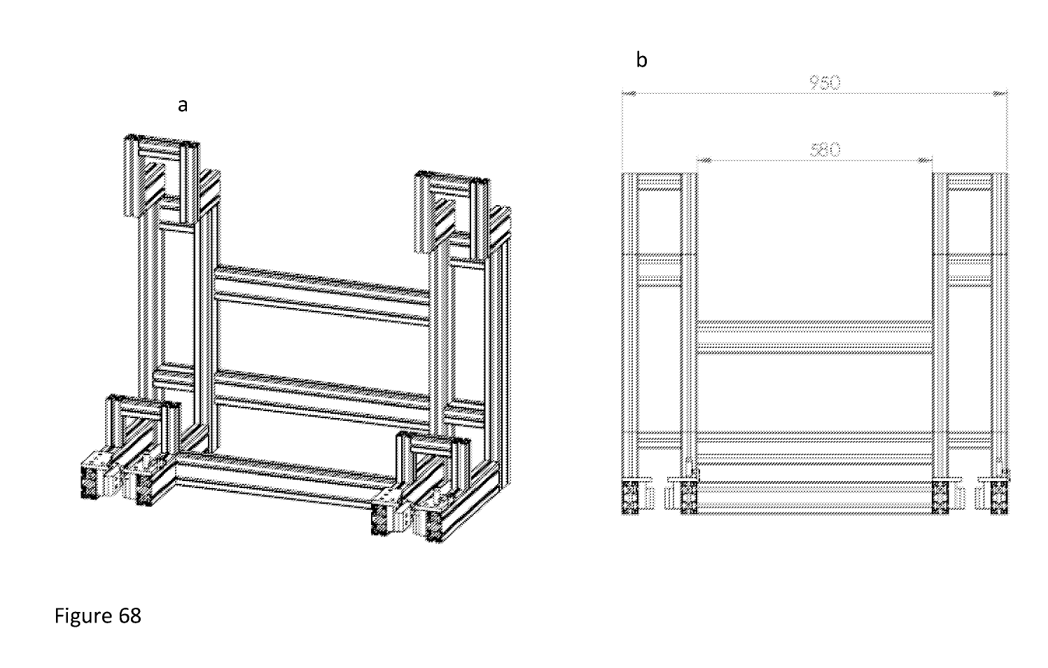

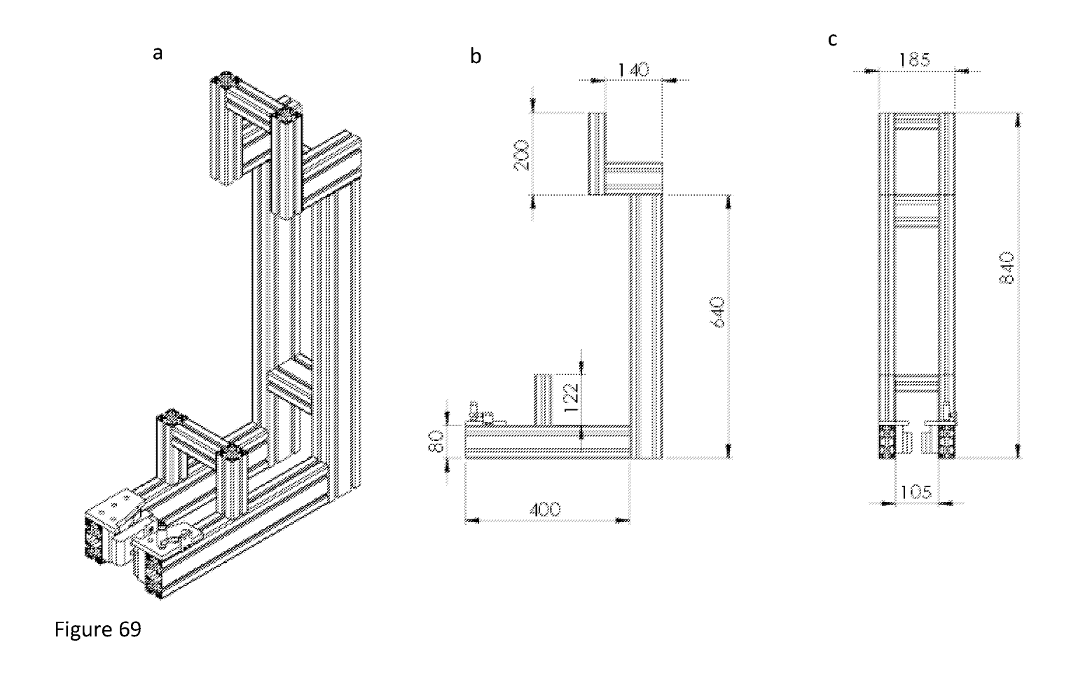

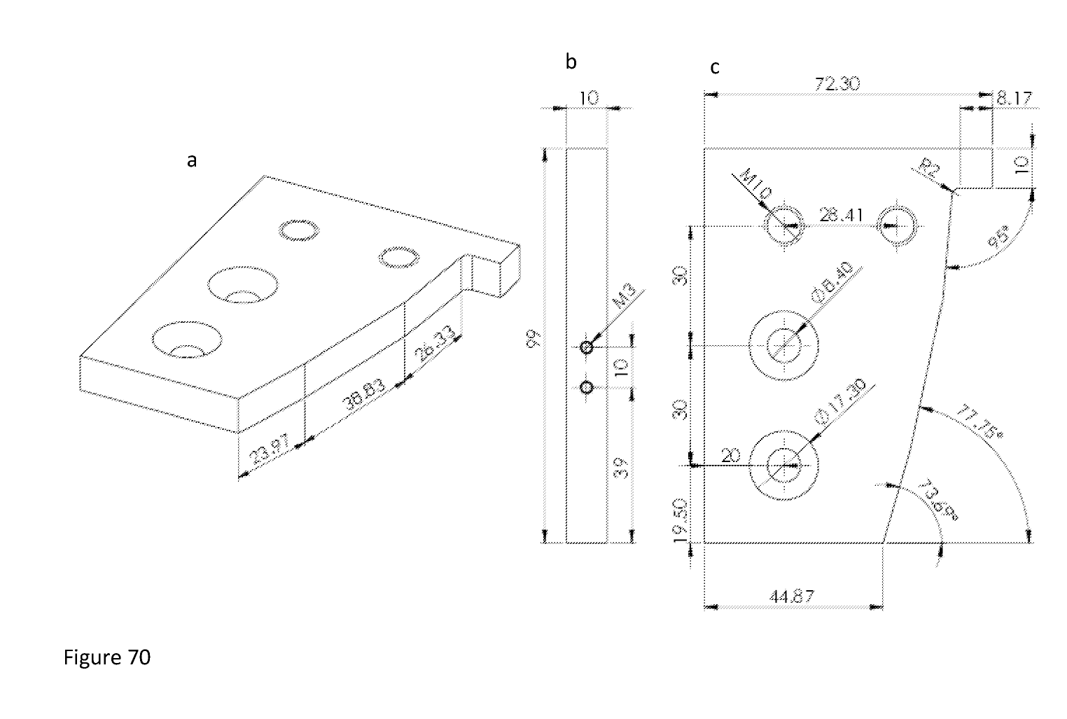

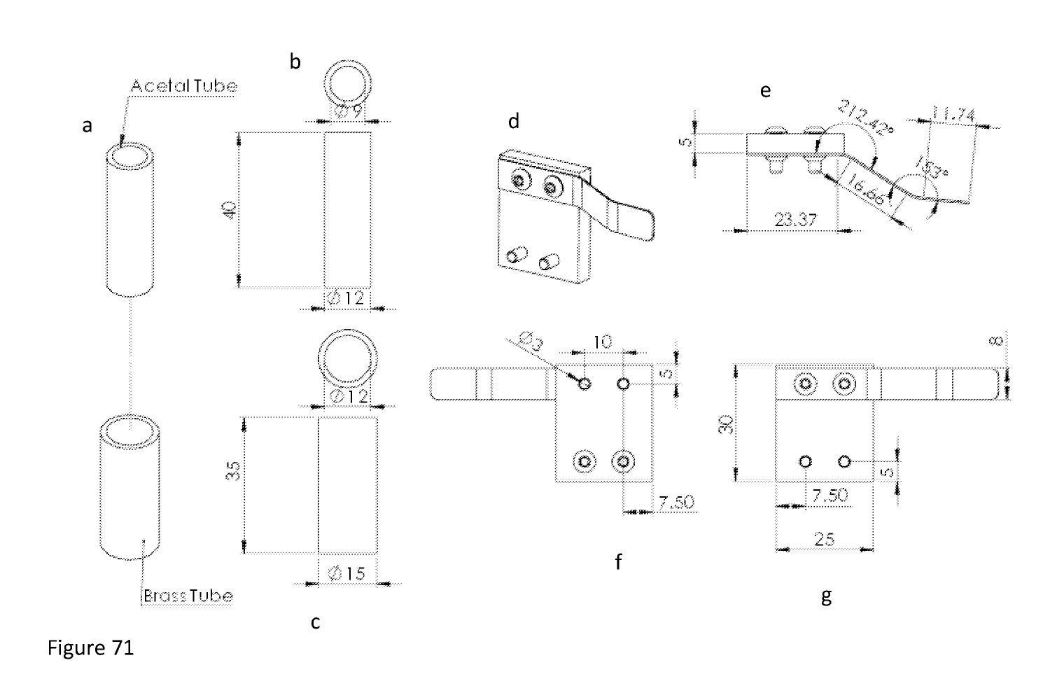

An example mannequin motion control is centred on a tool changing mechanism more normally used in a CNC (Computer Numerical Control) machine. We have developed a special design that, in an example, allows the gantry to safely load a mannequin from the docking station (see FIGS. 65-69, for example) for the digitization, and to unload and release the mannequin back to the docking station after the digitization process finishes. In an example design, a steel rod from the neck of each mannequin is fitted with the corresponding part to allow secure attachment. When the parts connect, in an example, a small trigger locks them together (see FIG. 37, for example). In an example, the tool changer is adapted for opening by use of an added push bar. A button sub assembly may be removed to allow free rotation. Adding an extended arm allows a mechanical method of releasing the taper arrangement (see FIG. 37, for example). In an example, the locked/unlocked status is detected by a release contactor and pin (see FIG. 71, for example). More mechanical and electronic example design details of mannequin loading/unloading are given in Sections 4.4 and 4.5, respectively.

From this point, in an example, the servo motors move the carriages along the actuators to position the mannequin appropriately. In an example, rotation begins when in position, including an acceleration phase, and the motion controller sends input/output (I/O) signals at specified angles. These I/O signals are routed to the camera and lights as appropriate, so the correct shots and lighting are triggered respectively. When a cycle (e.g. 4 rotations) is completed, the mannequin is returned to the loading/unloading bay, where it is released back onto the trolley. The location of each carriage (and therefore the position and orientation of each mannequin) is frequently detected by appropriately placed limit switches.

4.1 Requirement Definition

High-level example requirements for the motion control, are given in Table 4.1, ranking in order of preferred importance and ease of implementation:

TABLE 4.1
Example requirements definition for the motion control.

| Requirement | Quantifier/Detail |
|---|---|
| Reliable/Long Life | Minimum lifespan 5 years |
| Programmable rotational | A motorized device capable of orientating |
| device | the mannequin |
| Mostly “off the shelf” (OTS) | Majority commercially available |
| User Repairable/Replaceable | All short lifespan components (<500 hrs) |
| | minimal staff training replaceable |
| Reduce stress/damage to | Reduce dropping and loading damage |
| mannequins | |
| Allow Auto Cut Outs | Automatic texture cutout requires minimal |
| | post-processing tweaking |
| Ensure Fast garment | Take 250+ garment per day |
| throughput | |
| Positional flexibility of | To accommodate late design changes or |
| mannequin | unique garments/mannequins |

Discussion is focused on constructing a mannequin-specific rotational device rather than a generic turntable. Electronic loading would be a small addition to the cost of motion control, and negligible in comparison to designing and manufacturing a manual solution.

4.2 Concept Options and Decisions

The design of the preferred example of the motion control relied primarily upon the decision regarding the frame and structure (Section 2) between supporting the mannequin (Section 5) from above or below.

The concept options noted for the preferred example motion control design and loading mechanisms are given in Table 4.2:

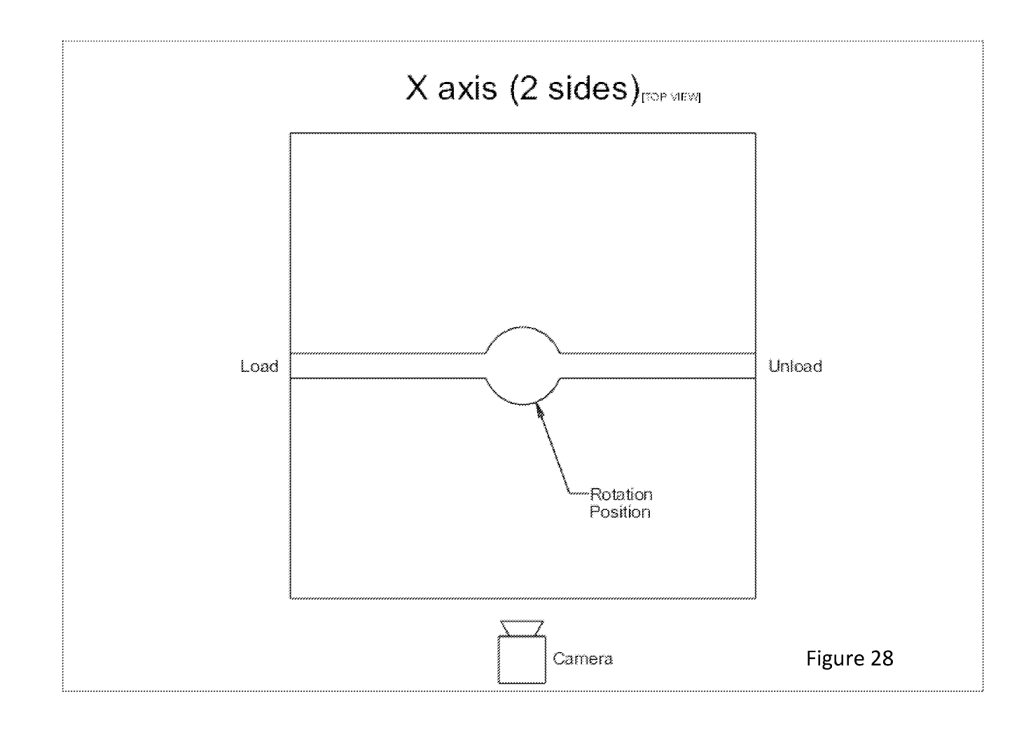

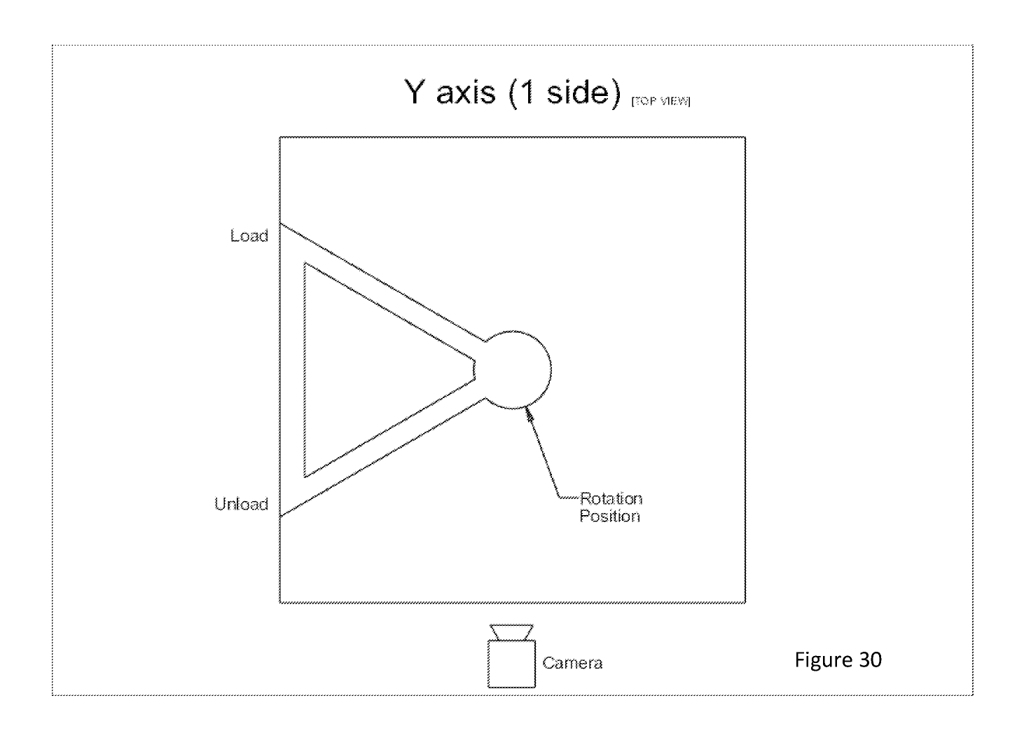

TABLE 4.2
Example concept options for the motion control

| Concept | Options | | | | |
|---|---|---|---|---|---|
| Rotation | Linear X | One motor, many | Orbital | Custom | Off the |
| Mechanism | Turntable | turntables | photography | made | shelf |
| | | | | | (other) |
| Mannequin | Automated | Manual loading | | | |
| Loading | loading | | | | |
| Mechanism | | | | | |
| Rotation | Camera reads | System | | | |
| Angle | turntable | synchronises | | | |
| Measurement | visually | components via | | | |
| | | motion data | | | |
| Fixing | Lock in place | Lock in place with | | | |
| | with | spigot(s) | | | |
| | electromagnets | | | | |
| Axes | 2 axis system | 3 axis system | | | |
| | (e.g. FIGS. | (e.g. FIGS. 30-32) | | | |
| | 27-29) | | | | |
| Multi-sided | 1-sided system | 2-sided system | | | |
| mannequin | (e.g. FIGS. | (e.g. FIGS. 28, | | | |
| loading | 27, 30, and 31) | 29, and 32) | | | |
| Multi-purpose | Single purpose | Dual purpose load | | | |
| loading | load/unload | & unload positions | | | |
| positions | positions | | | | |
| Mannequin | Trolley-based | Track-based | Mannequins | | |
| Moving | system | system | lifted | | |

Examples of 2 vs 3 axis and 1-sided vs 2-sided systems are illustrated in FIGS. 27-32, with single purpose and dual purpose positions labelled. An example working area is illustrated in FIG. 33.

When mannequin support from above was decided, it was seen that off the shelf turntables would not be feasible. This also eliminated “one motor, many turntables” and “manual loading” options. Example decisions made and their reasons are given in Table 4.3:

TABLE 4.3
Example concept decisions for the motion control

| Concept | Option chosen | Reason |
|---|---|---|
| Rotation | Custom made | Off the shelf sub-components reduced |
| Mechanism | | risk and provided a bespoke solution. |
| | | This enabled automated loading. |
| Mannequin | Automated loading | Eliminates redressing from workflow |
| Loading | | and reduced stress/damage to |
| Mechanism | | mannequins |
| Rotation | System synchronises | Visual reading was only suggested as a |
| Angle | components via motion | frame grabbing technique for video |
| Measurement | data | |
| Fixing | Lock in place with | Electromagnets provided no obvious |
| | spigot(s) | benefit and more integration work |
| Axes | 3 axis system (e.g. FIG. | Allows all scenarios to be tested and |
| | 32) | allows more flexible working |
| | | environment |
| Multi-sided | 2-sided system (e.g. FIG. | Allows all scenarios to be tested and |
| mannequin | 32) | allows more flexible working |
| loading | | environment |
| Multi-purpose | Dual purpose load & | Allows all scenarios to be tested and |
| loading | unload positions | allows more flexible working |
| positions | | environment |
| Mannequin | Trolley-based system | Uses trolleys that come with mannequins |
| Moving | (e.g. FIG. 26) | and avoids lifting loading damage. |
| | | Cheaper than track-based system, which |
| | | is ideal in large scale deployments |

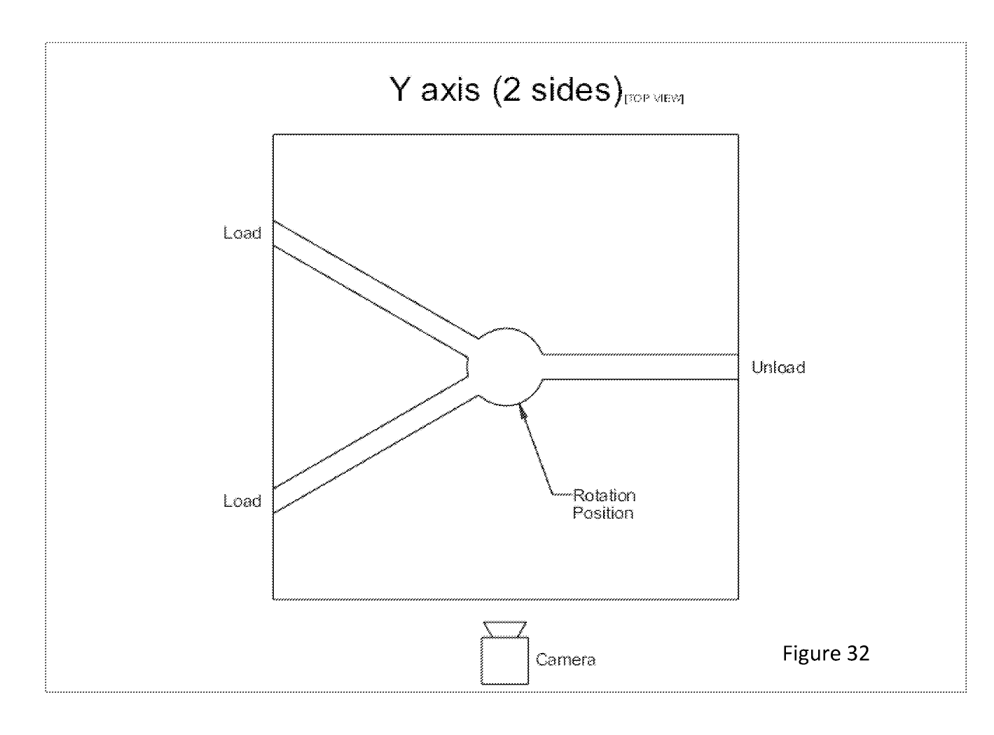

From the proof-of-concept experiment, we find that a 3 axis system (e.g. FIG. 32) allows all formats to be tested with relatively little software work required.

4.4 Detailed Example Designs for Mannequin Loading and Unloading

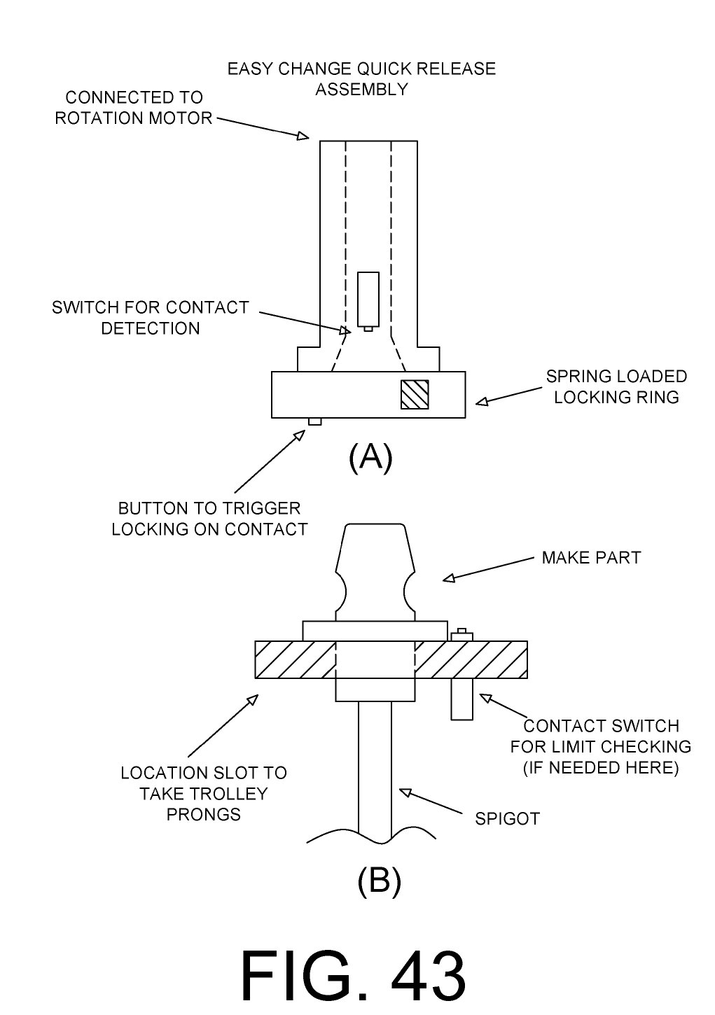

We have provided a special design of the collet fixture (i.e. the tool head, see e.g. FIGS. 43 and 61) that, in an example, allows the gantry to safely load a mannequin from the trolley for the imaging digitization, and unload and release the mannequin back to the trolley after the imaging digitization process finishes. The “Load” and “Unload” gantry operations require accurate positioning at each of the e.g. four possible docking stations. These positions are set during installation of the machine and it is not recommended that these are changed unless absolutely necessary and under extreme caution.

The design of the docking station must be compatible with the gantry to ensure that the positioning sequencing is the same with the same relative distances between the main components of the docking station. Failure to observe this may result in the collision of the gantry with the fixed elements of the docking station and therefore cause damage to the gantry and/or the fixtures. The docking station position may be defined as the X, Y, Z coordinates where the gantry collet fixture fully engages from above with the mannequin connector, causing the collet mechanism to lock in to the engage position, without asserting force to the docking station framework.

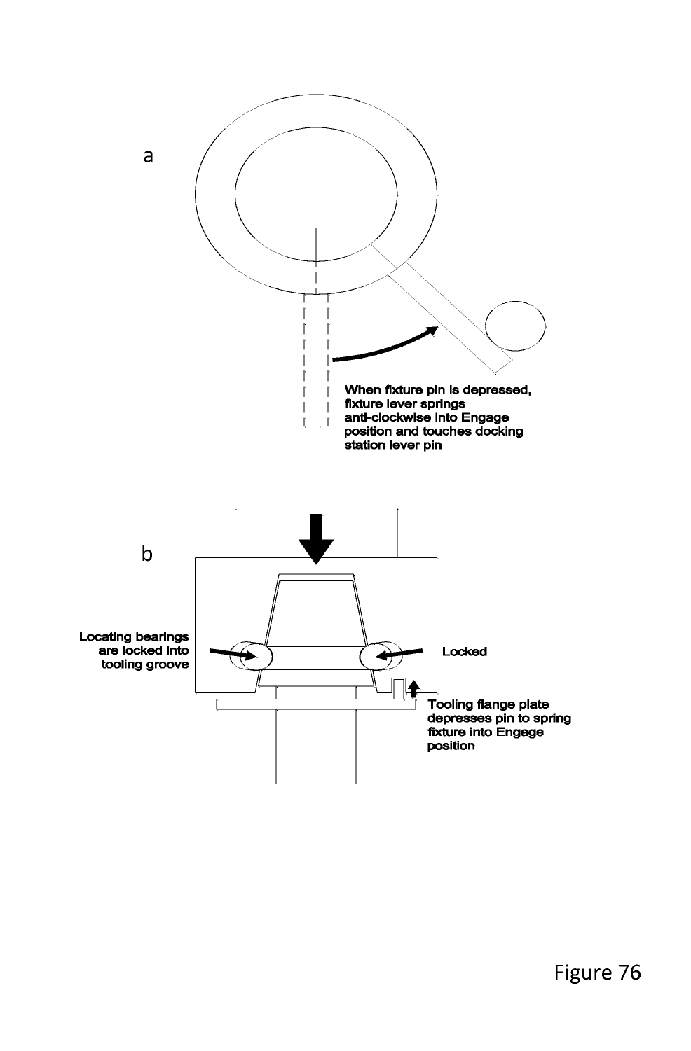

In an example, the collet fixture at the gantry includes a tapered socket. Inside the socket are e.g. three ball bearings that lock into a groove on the tooling fixed to the top of the mannequin. The collet fixture moves downwards to load the mannequin. When the collet fixture is lowered onto the mannequin tooling, a flange on the tooling activates the engage position pin on the collet fixture that triggers the “Engaging” mechanism. The lever on the collet fixture springs e.g. about 40 degrees anticlockwise, and the locating bearings are locked into the groove of the mannequin tooling to engage and secure the mannequin to the collet fixture (this is the collet fixture engaged position), as shown in FIG. 76, for example. When the fixture pin is depressed, the fixture lever springs e.g. anti-clockwise into an engage position and touches the docking station lever pin. (FIG. 76a shows an example from above, in plan view). Locating bearings are locked into a tooling groove. A tooling flange plate depresses a pin to a spring fixture into an engage position. (FIG. 76b shows an example, in a vertical cross section). In this example procedure, the gantry is lowered onto the mannequin tooling from above. The collet fixture is locked in the release position to allow the tooling to fully locate into the fixture. A flange plate on the tooling depresses a pin on the fixture which opens the release latch. The fixture lever is sprung to the engage position and the locating bearings are locked into the tooling groove ring.

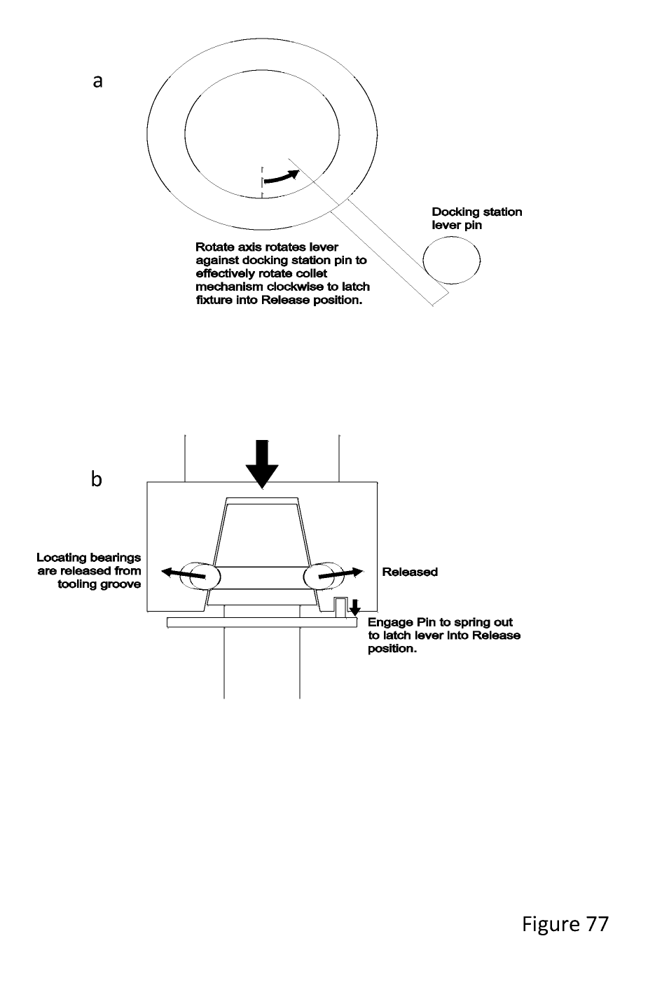

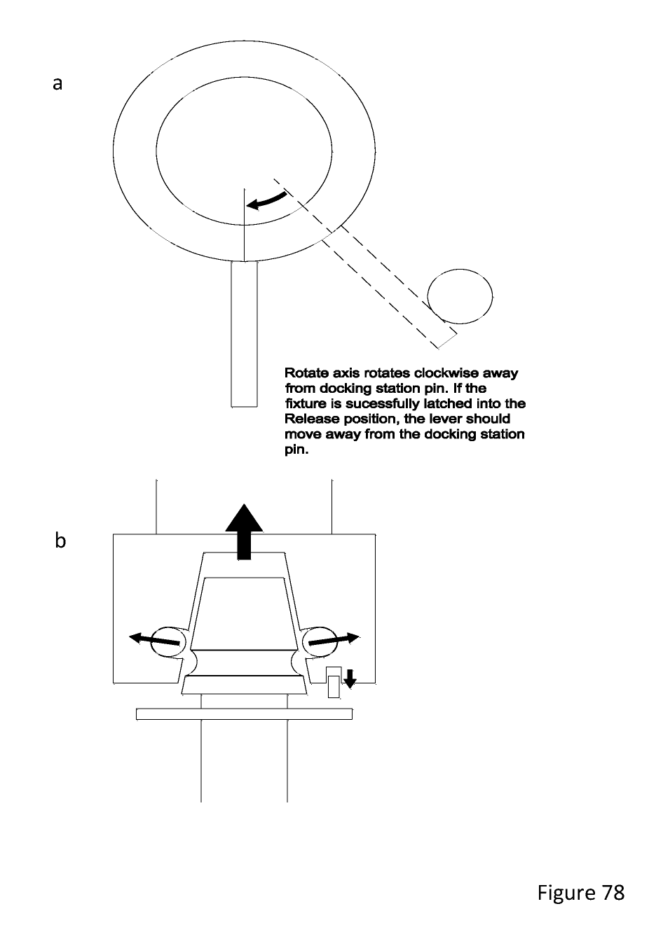

To release the mannequin, in an example, the gantry rotates the collet fixture anti-clockwise, so that the lever is pushed against the lever pin mounted at the docking station. This effectively turns the lever in the clockwise direction. When the lever is effectively pushed to the end of its clockwise travel, the locating bearings are unlocked and therefore released from grooves on the mannequin tooling. The lever should stay in position and therefore allow another part to be engaged into the collet fixture (the collet fixture release position). FIGS. 77 and 78 show, by way of example, how the gantry may unload the mannequin to the docking station, and how the “Release” operation may work, respectively. In this example procedure, the gantry is lowered to unload the mannequin. The rotation axis rotates the lever against the docking station pin to effectively rotate the collet mechanism clockwise to latch the fixture into a release position. (FIG. 77a shows an example from above, in plan view). Locating bearings are released from a tooling groove. An engage pin springs out to latch the lever into a release position. (FIG. 77b shows an example, in a vertical cross section). The gantry with the mannequin is lowered into the docking station from above. In an example, the collet fixture is locked in the engage position. The fixture lever is sprung to the engage position and the rotation axis is driven anti-clockwise until the fixture lever touches the docking station lever pin. The rotation axis rotates a further e.g. 41° (approximately) to latch the fixture into the release position. The locating bearings are released and the mannequin tooling is therefore freed. Then the gantry is moved upwards to release the mannequin, in this example. The rotation axis rotates clockwise away from the docking station pin. If the fixture is successfully latched into the release position, the lever should move away from the docking station pin. (FIG. 78a shows an example from above, in plan view). Once the mannequin tooling is released, the gantry may be raised. The rotation axis may turn clockwise away from the docking station lever pin. If released properly, the lever may move away from the pin immediately. (FIG. 78b shows an example, in a vertical cross section).

4.5 Electronic Designs for Mannequin Loading and Unloading

In a prototyping phase, we realised that there was an issue with the collet fixture in which it would sometime not lock-open ready to engage with the next mannequin. We tracked the three main causes of this to be the following:
The collet fixture had not been rotated far enough for the head to latch open. (Note: over rotation would damage equipment and the head has e.g. 0.5 degree of tolerance to over rotation.).
The head was not lifted far enough off of the mannequin for the latch to catch.
Stuck bearings, sometimes in the collet fixture would stick and then release later allowing the latch to spring shut.

The system needed to detect when the latch had failed so that an exception could be raised. Unfortunately, the collet fixture blocks the pickup of the tool chuck when the latch is closed, resulting in an artificial increase in length of the assembly with the knock-on effect of the collet fixture attempting to push the dock and the mannequin down by that distance resulting in slippage in the axis, and strain on the frame.

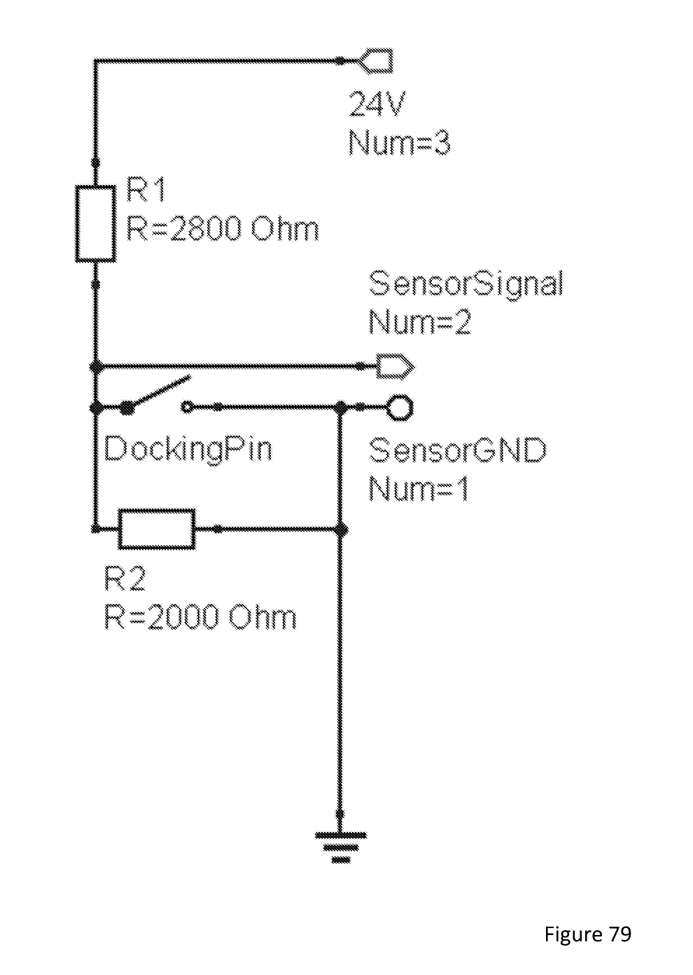

The solution was to detect the position of the release pin with regards to the docking station pin, and to check the positions of pre-mannequin loading and post-mannequin unloading. To achieve this a simple continuity circuit may be used where when docking station pin and input sensor are held at +10V, using a voltage divider from a 24V supply, and the sensor is grounded through the rig when the release pin makes contact with the dock pin (see FIG. 79 for an example electronic circuit design).

To detect if the head is in the correct locked-open position, the loading/unloading operation may be arranged to perform the following tasks:
Loading: Lower head to within range of the docking pin. Rotate 35 degrees towards the pin, if contact is made the head is not locked open, then move head back to safe location and generate exception.
Unloading: Perform the “Unloading” procedure by lowering the head with mannequin into the dock, rotate the head e.g. 40 degrees to release the mannequin. Raise the head e.g. 20 mm, then rotate the head e.g. 5 degrees away from the pin. If contact is lost, continue rotating to zero degrees and carry on to the next task. If contact is not lost, continue rotating to zero degrees and move the head to safe location generating the appropriate exception.
Further amendments: To aid the system, the solid plastic pin insert was replaced with a rubber insert allowing for an additional 2 degrees of over-rotation tolerance.

5. Lighting Components

An example photo-rig was inadequate in terms of lighting, as it relied upon xenon flash-strobes with similarly low endurance for retro-reflective-mannequin-based photography (see, e.g. U.S. Pat. No. 8,605,148B2) as for the SLR camera, described above. As the mechanical shutter was replaced with a shutterless sensor, the strobes were replaced with LED panels, in an example. We firstly considered fluorescent tubes, as they boast an excellent always-on lifetime and strong spectral fidelity CRI (Colour Rendering Index). However, fluorescent tubes do stress their filaments on starting-up, so we are concerned that repeatedly switching for the retro-reflective-mannequin-based system would yield a poor overall lifetime. We adopted LED panels in our design example (see e.g. FIGS. 20, 24 and 25). Although most LED panels exhibit a poor spectral fidelity, we found specifically high-CRI LEDs which satisfied our requirements of quality and endurance.

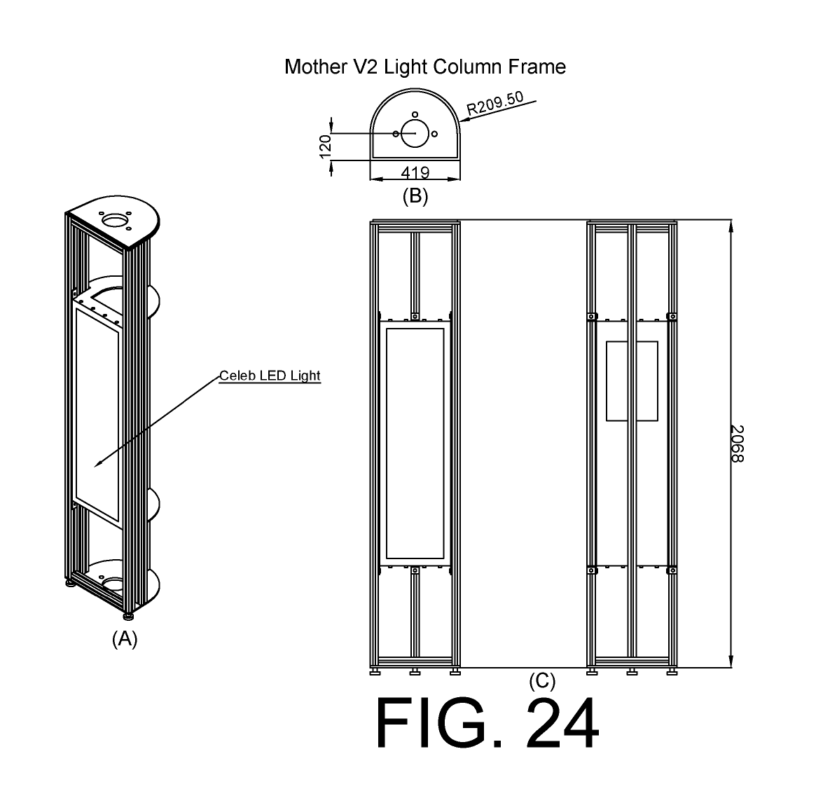

In an example design, the lighting components of an example system includes 6 LED-panels: one for the ringlight to activate the retro-reflectivity, three for normal texture lightings (2 side panels and 1 overhead lighting), and two for the backlight (see FIGS. 1-5 for examples of the layout and dimensions in different perspectives). For the ringlight (e.g. FIG. 24) and the backlights, the photography system based on the retro-reflective-mannequin only requires monochrome retro-reflective return, so CRI was not important. In an example, more economical panels were chosen for these components. The ring light is controlled via an M12 5-pin connector and the back-panels can be switched simply too. The main LED panels are controlled via DMX (Digital MultipleX), so a simple splitter was implemented to enable control from the motion controller.

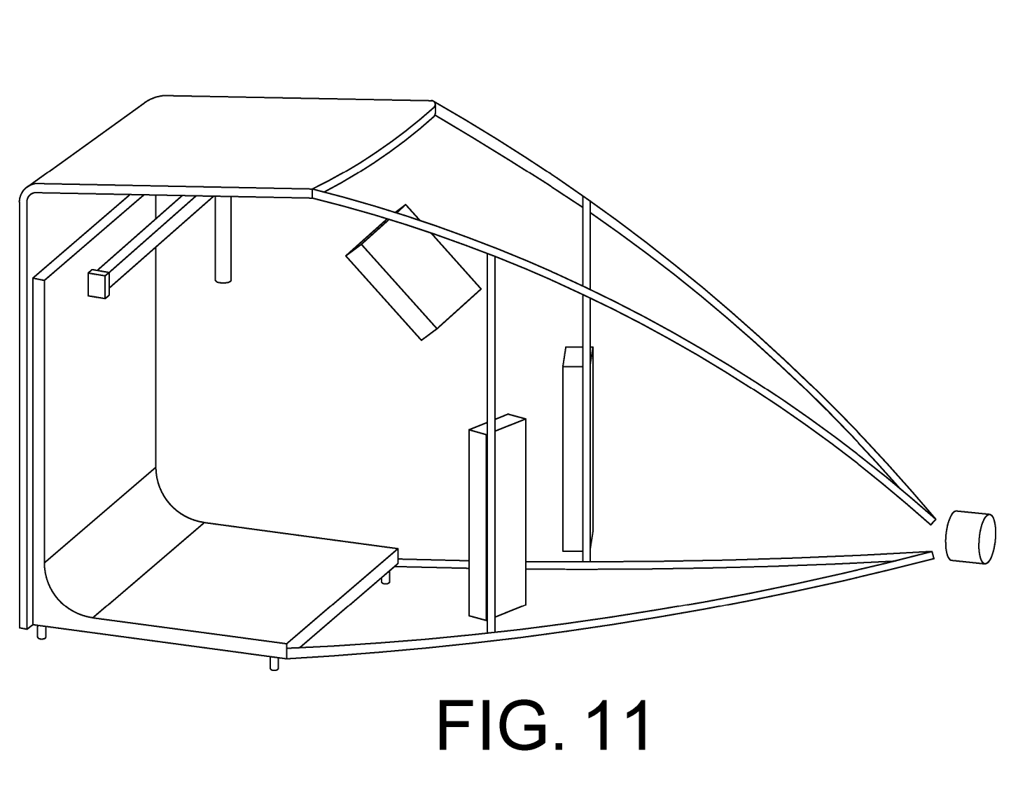

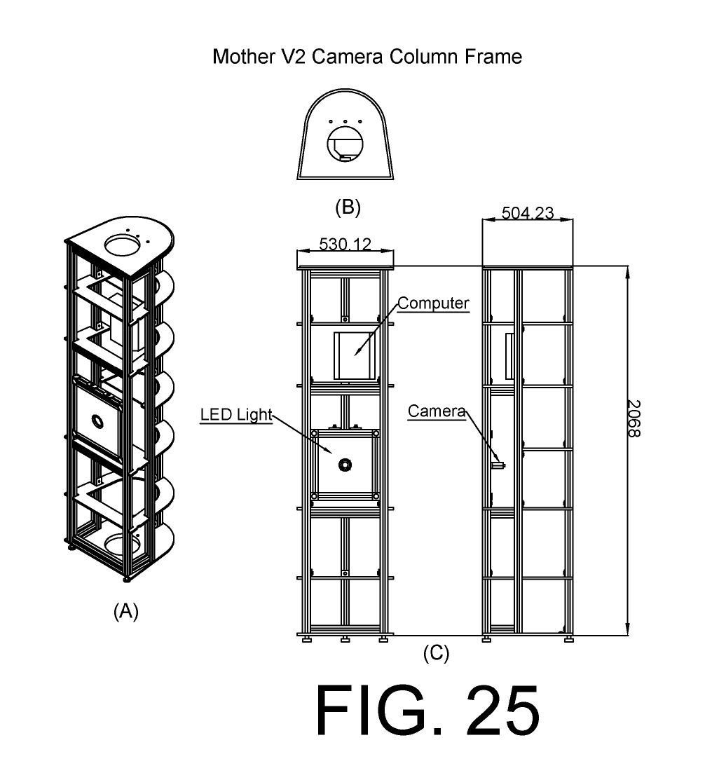

To obtain the automatic texture cutout results, the mannequin may be rotated 3 times under 3 different lighting conditions: texture lighting, alpha lighting, and albedo lighting. Firstly, in an example, under normal texture lighting where the two side panels and the single overhead light illuminate the detail of the garment (see e.g. FIGS. 11-16 for three versions of example designs). Secondly, in an example, under alpha lighting where the ringlight and the back-panels put the garment in silhouette: black if opaque, white if transparent and a level of grey if somewhat translucent. Thirdly, in an example, under albedo lighting where the side panels (e.g. FIG. 25) illuminate the garment in a less shadowy way to provide a reference against which the alpha lighting may be compared to calculate translucency.

5.1 Requirement Definition

The initial high-level requirements for example lighting components, are given in Table 5.1, ranking in preferred order of importance and ease of implementation:

TABLE 5.1
Example requirement definitions for example lighting components

| Requirement | Quantifier/Detail |
|---|---|
| Daylight Equivalent Lighting | D65/D50 |
| Even Background & | All clipped within 50 pixels of mannequin |
| Floor Lighting | |
| Reliable/Long Life | Minimum lifespan 5 years |
| User Repairable/Replaceable | All short lifespan components (<500 hrs) |
| | minimal staff training replaceable |

The most important requirement is that of reliability. Tripling shots per garment and increasing daily throughput could demand >16,000 images per day. With strobes, this would quickly result in blown bulbs. Furthermore, the frequency of flashes would be too fast for recharging, and the room would be subject to constant flashing, which is undesirable for staff.

5.2 Concept Options and Decisions

Fluorescent tubes were seen as possibly ideal, as they are cheap and have a very good light spectrum. LEDs can also have a very high CRI but are these are much more expensive per lumen. The concept options noted for the example lighting specifications and designs are given in Table 5.2:

TABLE 5.2
Example concept options for the lighting

| Concept | Options | | |
|---|---|---|---|
| Lighting type | Flash | Constant | |
| Lamp | Fluorescent | LED | Tungsten |
| technology | | | |
| Background | 90° background | Cyclorama (cove) | |
| Panels | panels | | |
| Floor | White floor | Translucent floor | |
| lighting | (reflective) | (light-through) | |
| Frontal Light | Ring flash/light | Panel with hole | |
| Source | | | |
| Diffusion | Plastic diffusion | Material diffusion | Paper diffusion |
| Type | | | |
| Lighting | Strip bank & fill | Double key & | Side lights + top |
| Arrangement | | kicker | |

The most important option is lighting type, which imaging quality and durability are dependent on. Our desire to repeatedly turn lights on and off made this option of using fluorescent lighting less appealing. Even with a programmed start (preheating filaments) the lamp life for fluorescent tubes is approximately 100,000 on/off cycles, which is too short for our goal of using components with 5-year lifespans. The warm up must be <0.75 s for a 10 rpm mannequin rotation rate, further casting doubt on the suitability of fluorescents.

The preferred decisions made and their reasons are given in Table 5.3:

TABLE 5.3
Preferred concept decisions for the lighting

| Concept | Option chosen | Reason |
|---|---|---|
| Lighting type | Constant | Better for previewing garment |
| | | images, less distracting |
| | | environment |
| Lamp | LED (e.g. FIG. 20) | Excellent CRI (95+) possible, very |
| technology | | long (50,000 hrs + lifetime), no |
| | | switching problems |
| Background | 90° background panels (e.g. | Curved cyclorama is unnecessary |
| Panels | FIG. 20) | and makes rig longer |
| Floor lighting | Translucent floor (light- | Neater design and more even result |
| | through) | |
| Frontal Light | Panel with hole (e.g. FIG. 24) | Industrial ring-light is square with |
| Source | | circular aperture, so meets this |
| | | requirement |
| Diffusion | Plastic diffusion (or none) | Hard wearing and sufficient for |
| Type | | diffusion, but many small LED |
| | | implies no real need |
| Lighting | Side lights & top (e.g. FIG. 11-16) | If well balanced, a kicker light is |
| Arrangement | | unnecessary |

Example light locations are illustrated in FIGS. 1-5. Example 90° panels are illustrated in FIGS. 17-25. The specification of the lights used is available from the manufacturer's website.

6. Mannequin Related Designs

The mannequin was in an example supported using two steel spigots onto which each of the legs were slotted. In the design of an example system, we supported two brands of mannequin using interchangeable spigots depending on brand used. This allowed for quick swapping of mannequins after some practice, but was more challenging for shorter users or those with less upper-body strength. Consequently, the mannequins were often dropped or knocked against other items in the studio, reducing their average lifetime to approximately one year. Furthermore, lifting the mannequins (usually at the waist or crotch) disturbed the dressed garment and required redressing once in-situ. The above drawbacks led us to develop a system which relied less upon user strength and coordination. Aspects of a relevant solution are detailed in Section 4.

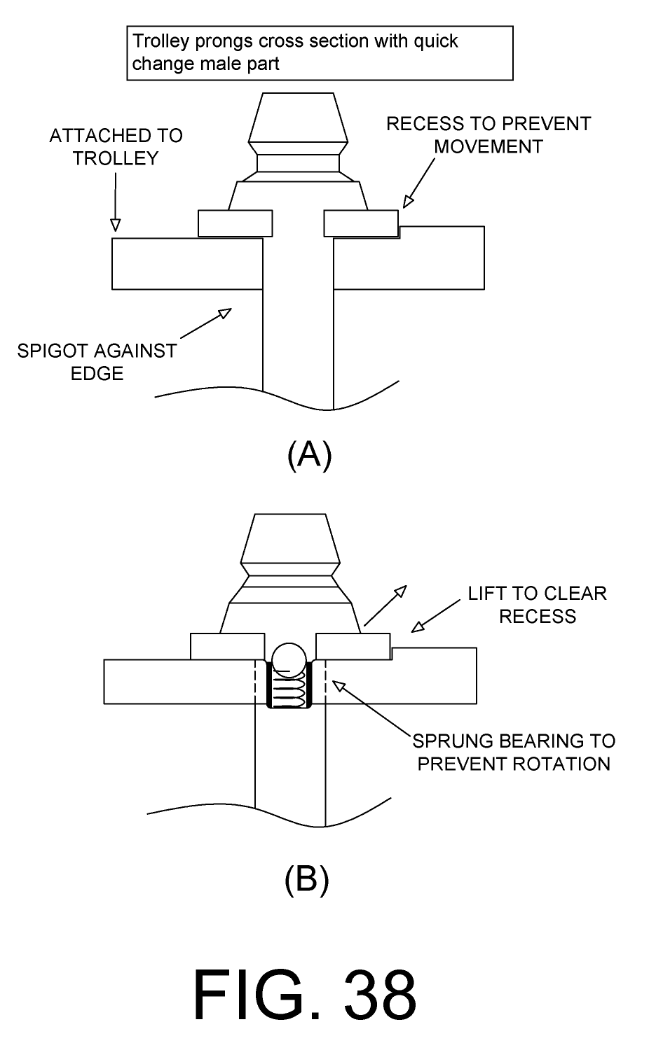

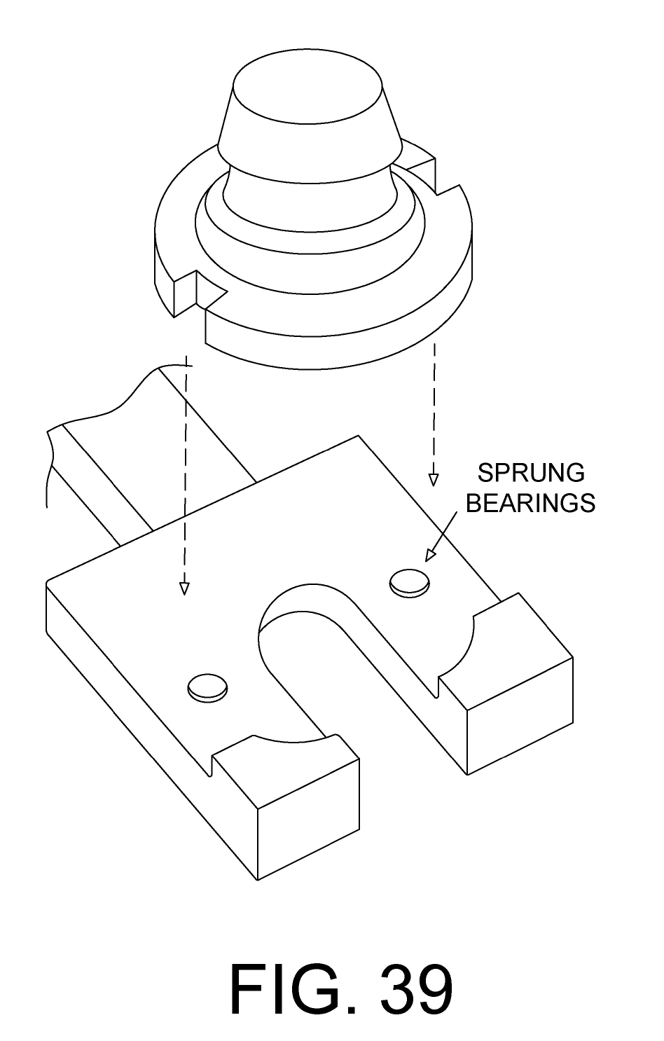

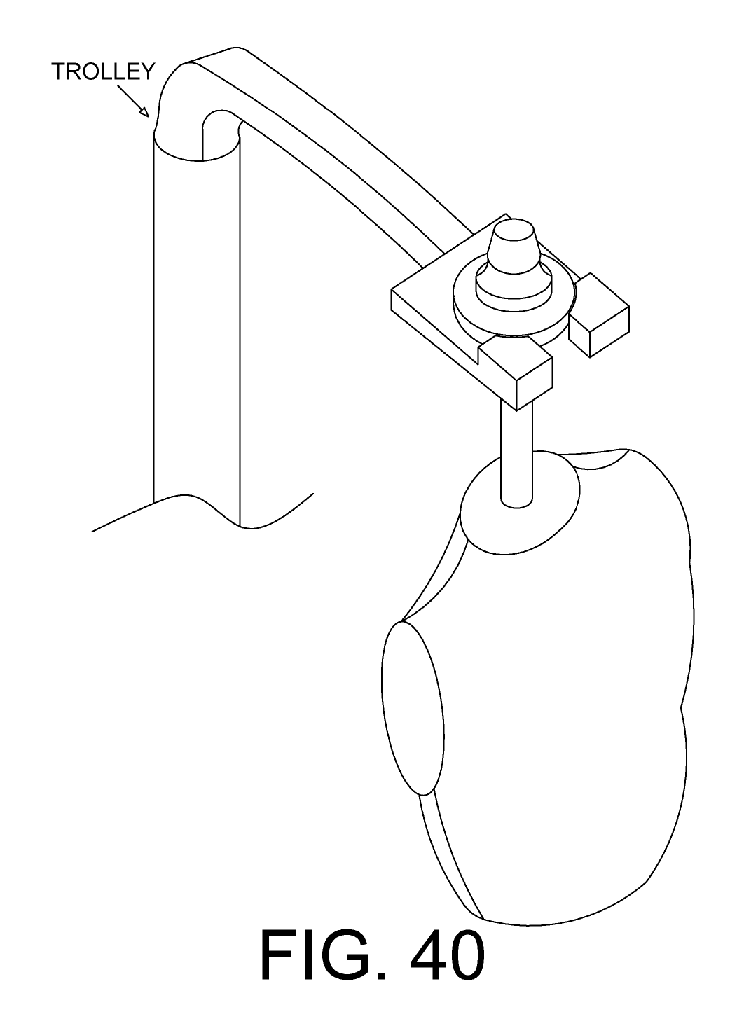

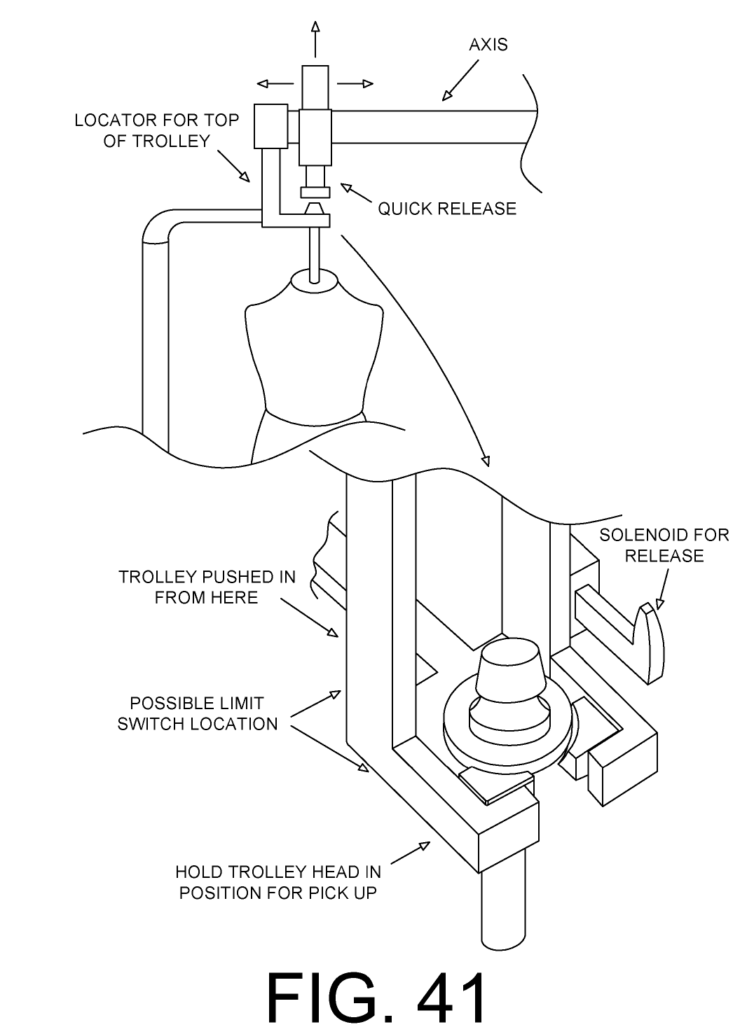

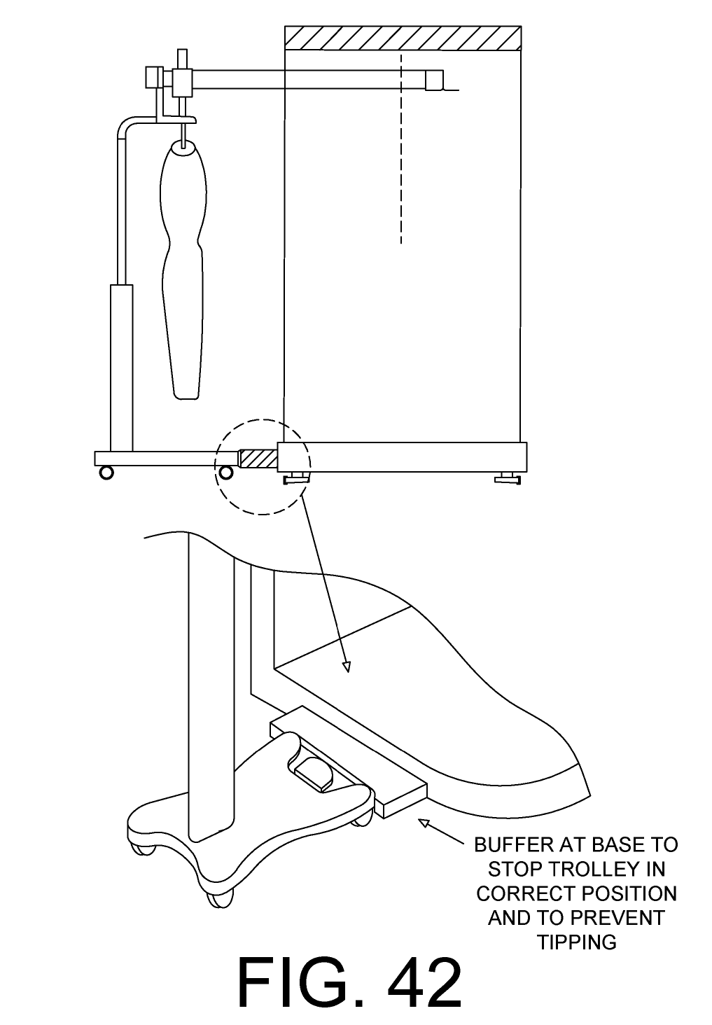

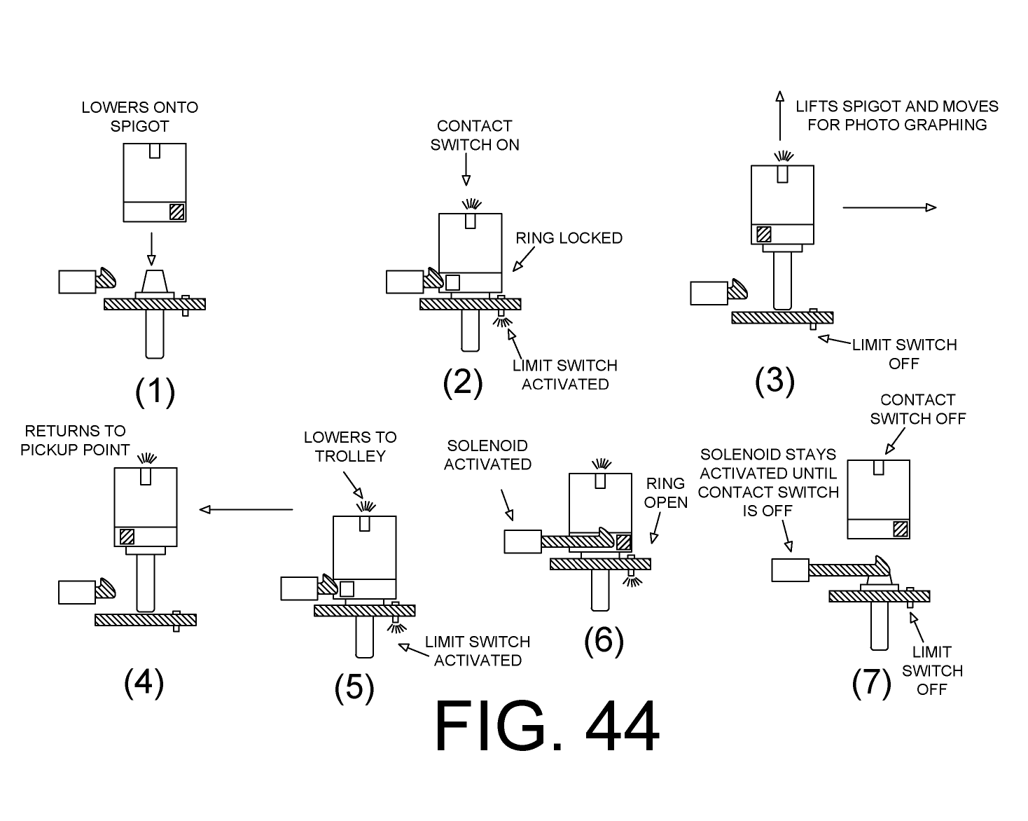

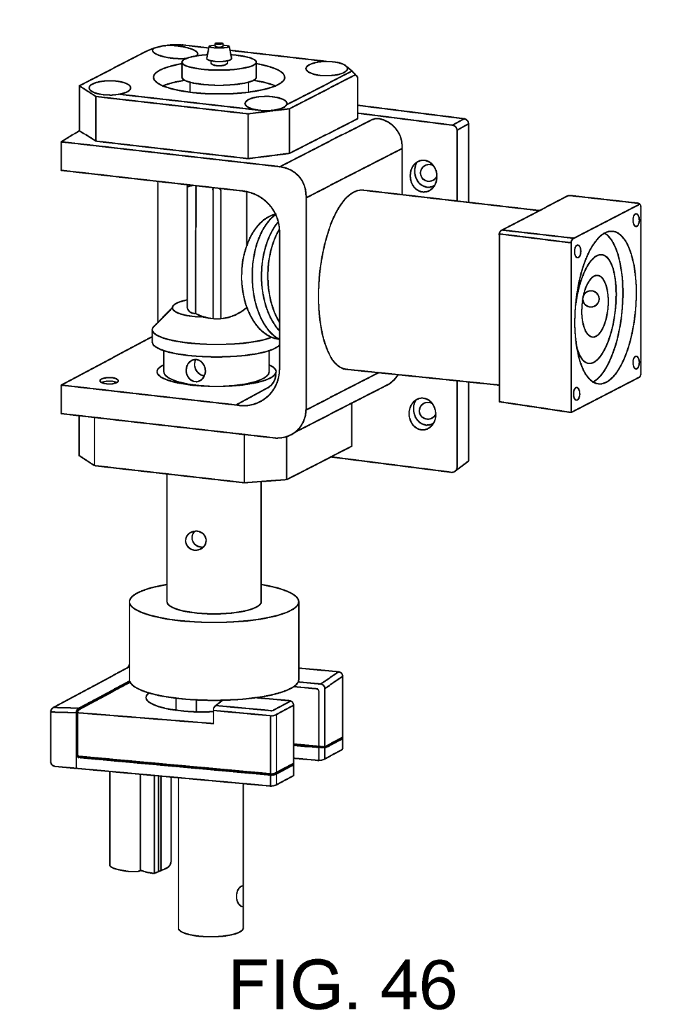

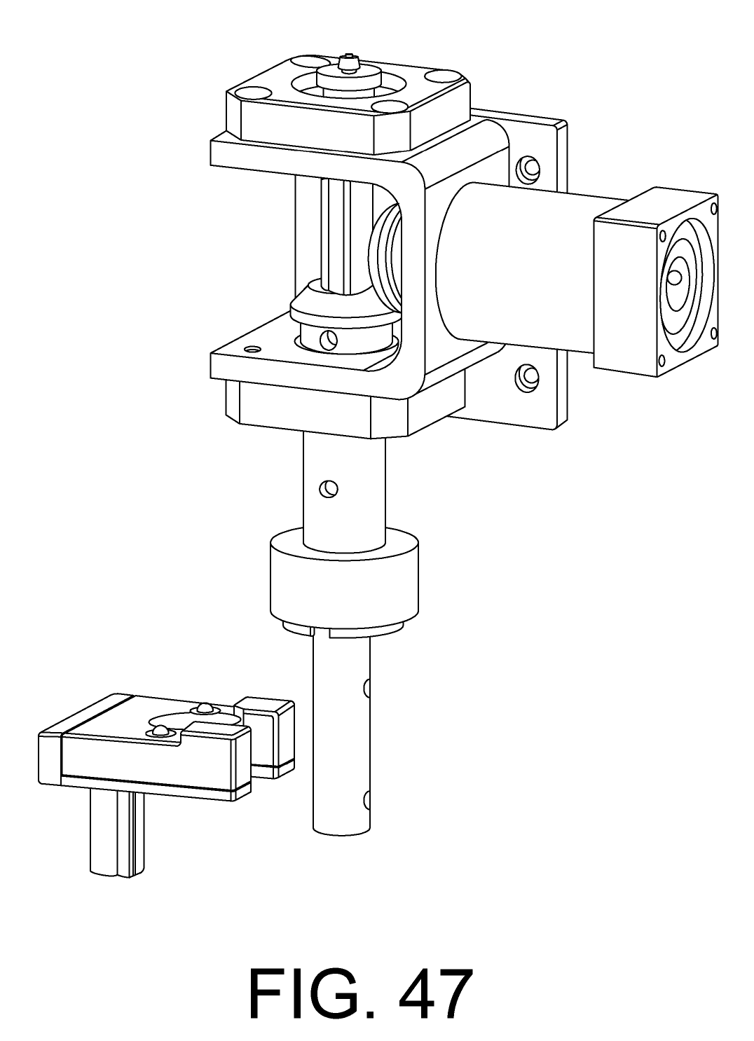

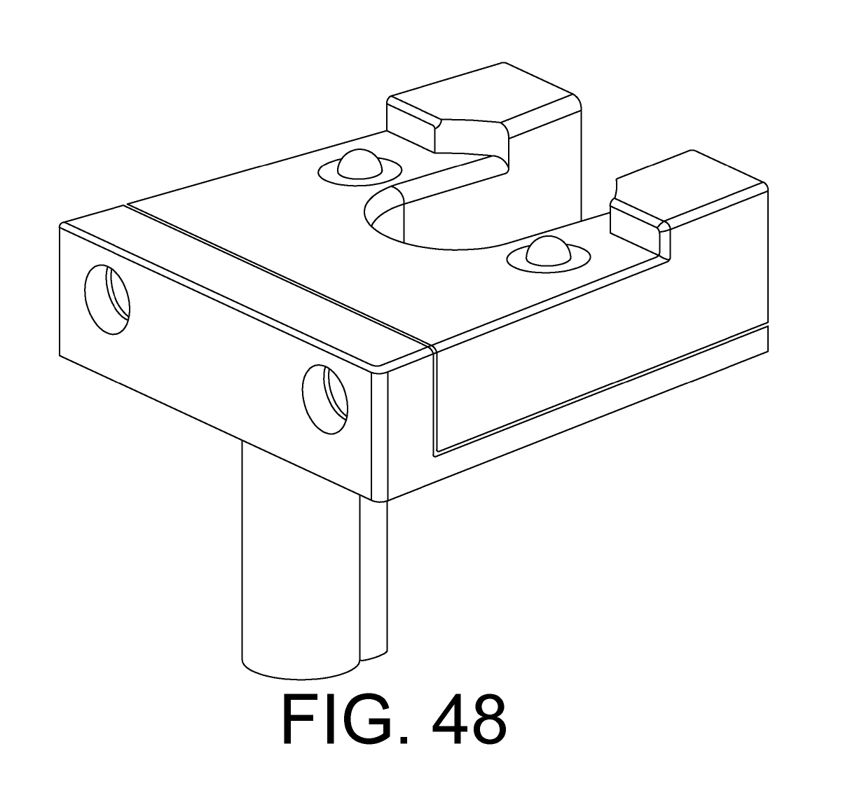

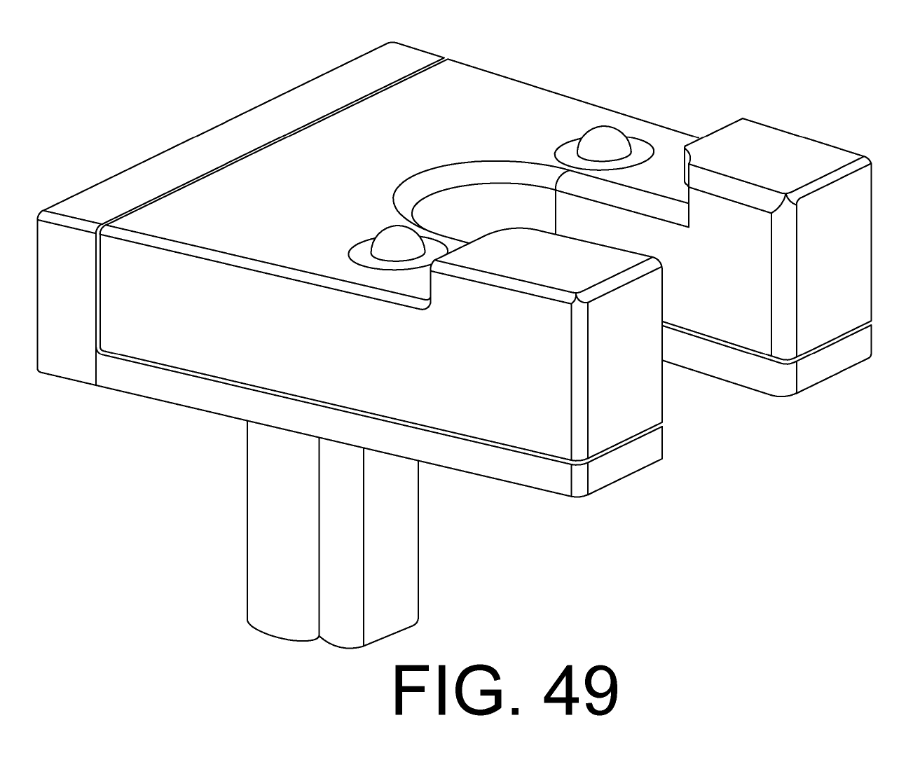

The neck spigots of some mannequins (e.g. Alvanon Alvaform), and of available sturdy stands, led us to develop a system to take advantage of these features (see e.g. FIGS. 37-49). Supporting the mannequin from the neck spigot rather than the legs allows for a cleaner texture cutout for sections of a garment around the ankles, such as maxi-dresses and trousers. Dispensing with the need for any mechanism below the mannequin avoids the problem of shadows around this base region.

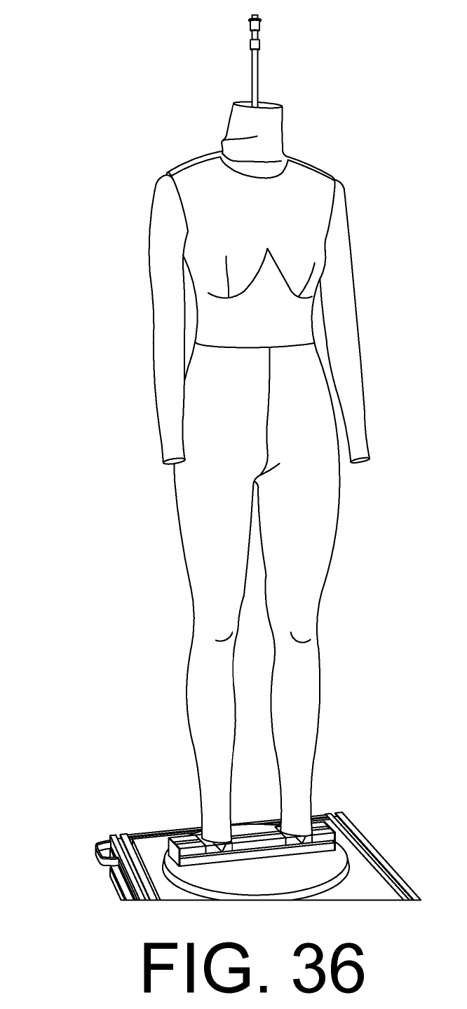

To implement automatic texture cutout technology to the highest possible standard required a rethink about how to develop a retro-reflective mannequin (see, e.g. U.S. Pat. No. 8,605,148B2). We constructed a covering for the mannequin using a stretchy retro-reflective material with the fewest seams possible. We took a mannequin apart, removed the top layer and replaced it with the retro-reflective material. Clamping the material under metal sections at the neck, shoulders and ankles allowed for a smooth and even covering (see e.g. FIG. 36).

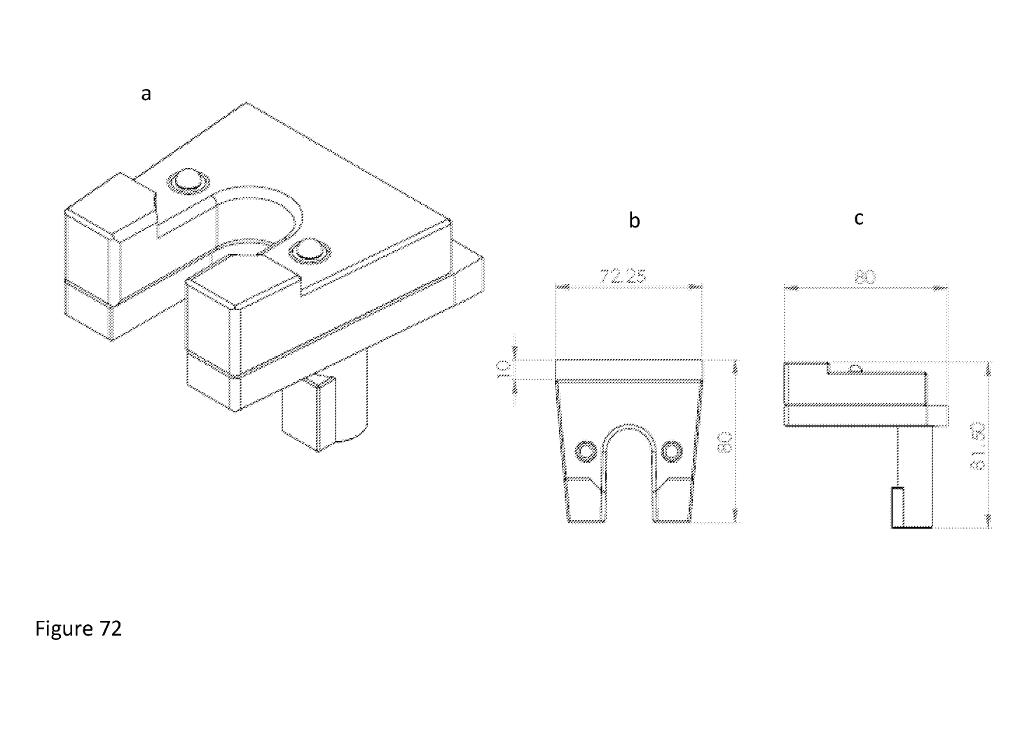

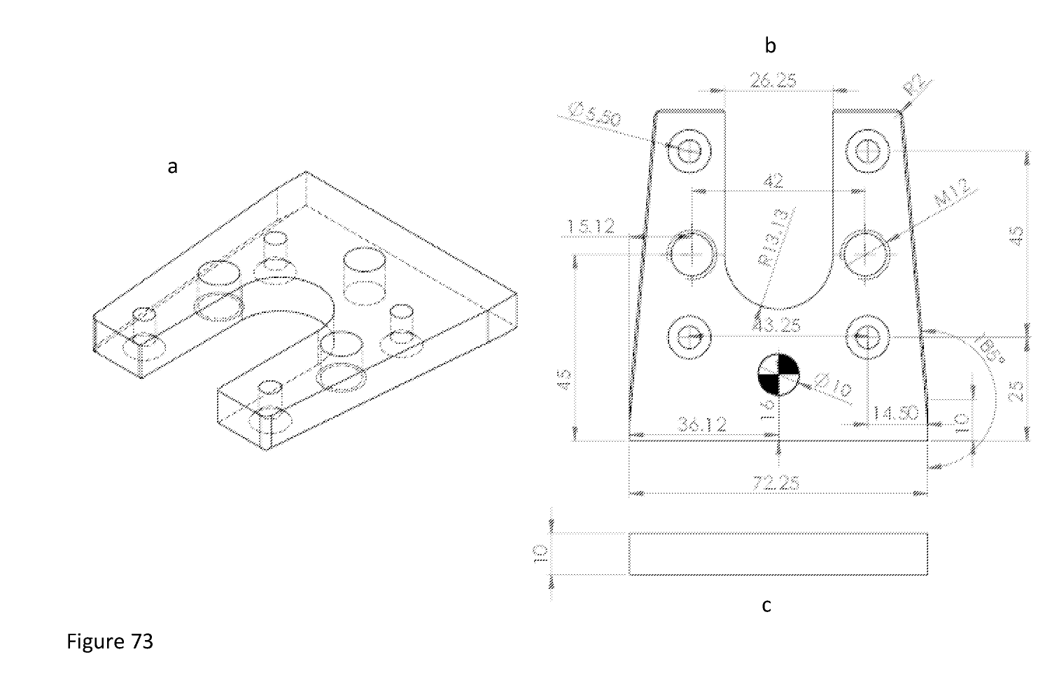

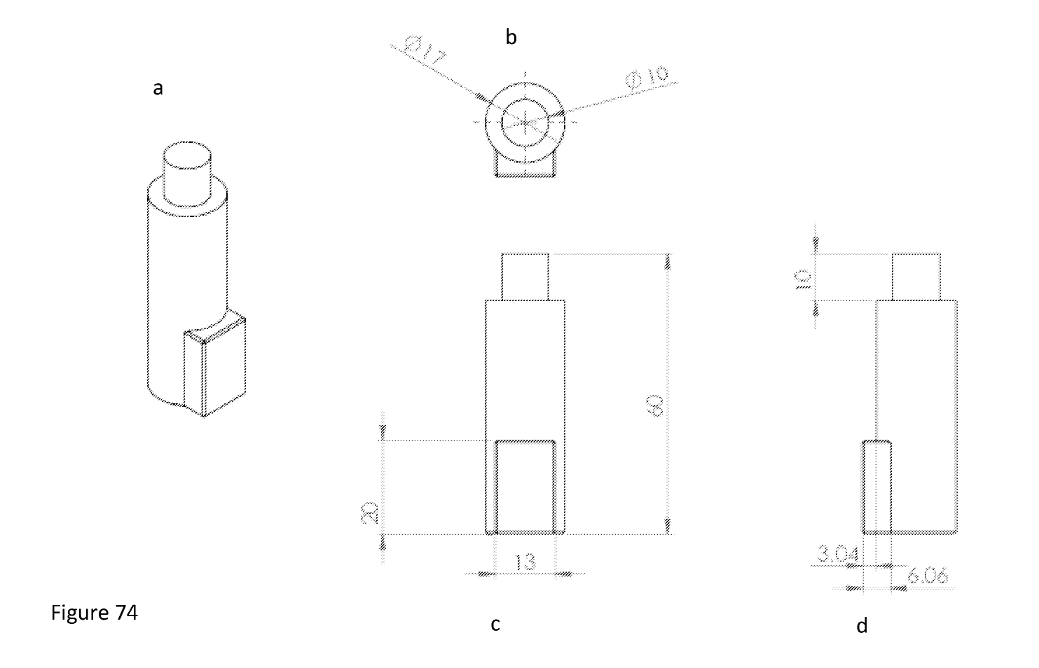

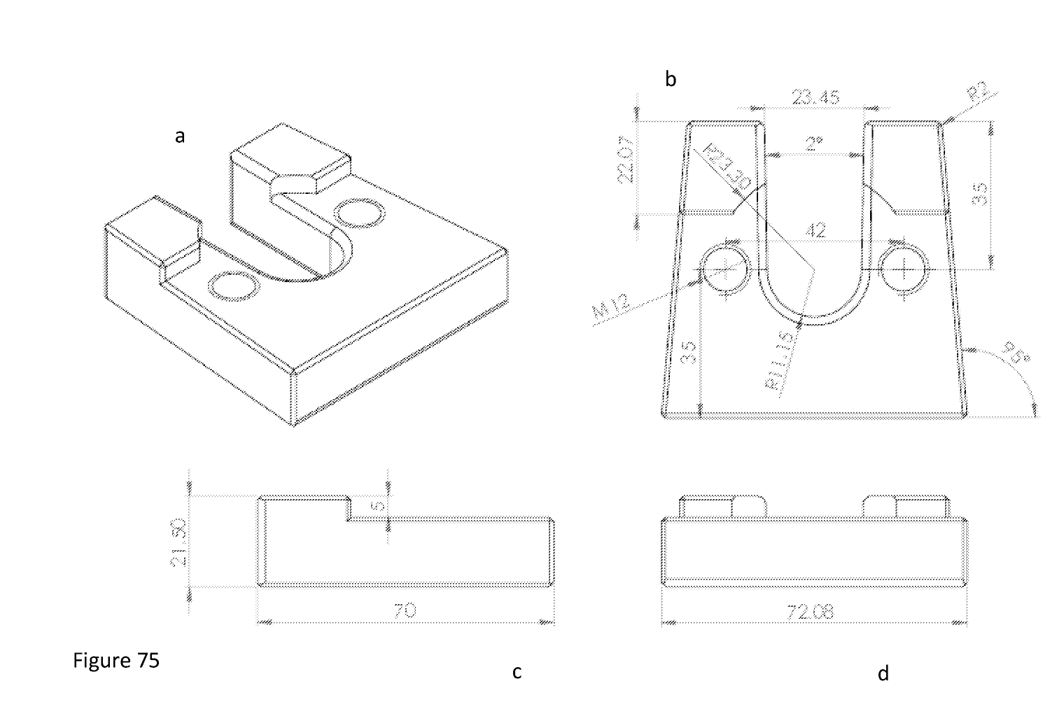

The stand needed little adaptation to make it appropriate for use in the new photo-rig. We designed and constructed an adaptor for the spigot holder to allow support of the male tool changer component (see e.g. FIGS. 72-75) and removed a protrusion from the side of the arm to allow insertion of the stand into the loading bay of the rig. An example of a mechanism for supporting the adaptor when docked is illustrated in FIGS. 65-67.

6.1 Requirement Definition

An initial high-level example of requirements for mannequins is given in Table 6.1, ranking in order of importance and ease of implementation:

TABLE 6.1
Example Requirements Definition for Mannequins

| Requirement | Quantifier/Detail |
|---|---|
| Stand to support mannequin | Holding the mannequin by legs for |
| during and after dressing | overhead dressing and by neck for |
| | legwear dressing |
| Easy movement & transportation | — |
| Promote long life span of | Mannequins are expensive. Lifespan |
| mannequin | of >2 years is essential |
| Provide optimum automatic | Reduce cutout time of the operation |
| texture cutout | team from 30% of work time to <10% |
| Simple & cost effective | Must survive 40,000+ loads/unloads |
| interfaces | |
| Various mannequins supported | Plus size, male, half-mannequins |
| Mannequin/stylist automatically | RFID tag/colour coding |
| ID'd | |

These design requirements can be split into two primary streams: 1) retro-reflective suit construction and 2) mannequin stand/spigot modification. An example of a retro-reflective suit design is given in FIG. 36.

6.2 Concept Options and Decisions

Example concept options noted for the mannequin and related designs are given in the Table 6.2:

TABLE 6.2
Example concept options for the mannequin

| Concept | Options | | | |
|---|---|---|---|---|
| Mannequin | Spigots | Electromagnetic | Caddy | Support |
| support | | plates | (spigots for | from above |
| technology | | | trousers) | |
| Trolley | Front loading | Side loading | “Monorail” | Track |
| loading | caddy/trolley | caddy/trolley | top loading | loading for |
| system | | (e.g. FIG. 7) | (e.g. FIG. 6) | caddy |
| Mannequin | Circular rotating | Oscillating auto- | Standard | |
| movement | loading | loader | loading | |
| type | mechanism | | | |
| Mannequin | Custom | OTS Mannequin | | |
| customisation | mannequin | | | |
| Mannequin | Hollow | Solid mannequin | | |
| solidity | mannequin | (pin arms) | | |
| | (stuff arms | | | |
| | inside) | | | |
| Ghost | Removable | Standard neck | | |
| mannequin | (neck) sections | | | |
| facility | | | | |
| Arms options | Abductable | Standard arms | | |
| | arms | | | |
| Retro- | Retro-reflective | Retro-reflective | | |
| reflective | suit in one piece | paint | | |
| technology | | | | |
| Wrists/ankles | Wrists & ankles | No wrists & ankles | | |
| technology | (to stop arm & | | | |
| | leg sleeves) | | | |

The preferred decisions made and their reasons are given in Table 6.3. Preliminary investigations showed that retro-reflective paint was not a good option, so we focused on implementing a retro-reflective suit as neatly as possible. To cover the retro-reflective suit over the mannequin, welding, sewing and gluing were used, in an example.

TABLE 6.3
Example concept decisions for the mannequin

| Concept | Option chosen | Reason |
|---|---|---|
| Mannequin | Support from above (see | Allows for more even floor lighting and |
| support | e.g. FIG. 26) | removal of legs for translucent skirt |
| technology | | sections |
| Trolley | Side loading trolley (see e.g. | Cheapest option with flexible workflow |
| loading | FIG. 26) | |
| system | | |
| Mannequin | Varying or standard loading | Circular rotating loading requires |
| movement | (see e.g. FIGS. 27-32) | monorail or track to work efficiently, |
| type | | and is a possible option. |
| Mannequin | OTS mannequin | Less development overhead, |
| customisation | | |
| Mannequin | Solid mannequin (pin arms) | The mannequins adopted are solid. See |
| solidity | | above |
| Ghost | Standard neck | The mannequins adopted have standard |
| mannequin | | necks. See above |
| facility | | |
| Arms options | Standard arms | The mannequins adopted have standard |
| | | arms. See above |
| Retro- | Retro-reflective suit in one | Tests confirmed paint is much less |
| reflective | piece (see e.g. FIG. 36) | retro-reflective, requires a hard surface |
| technology | | and is more liable to chip |
| Wrists/ankles | No wrists & ankles | The mannequins adopted do not have |
| technology | | wrists or ankles. See above |

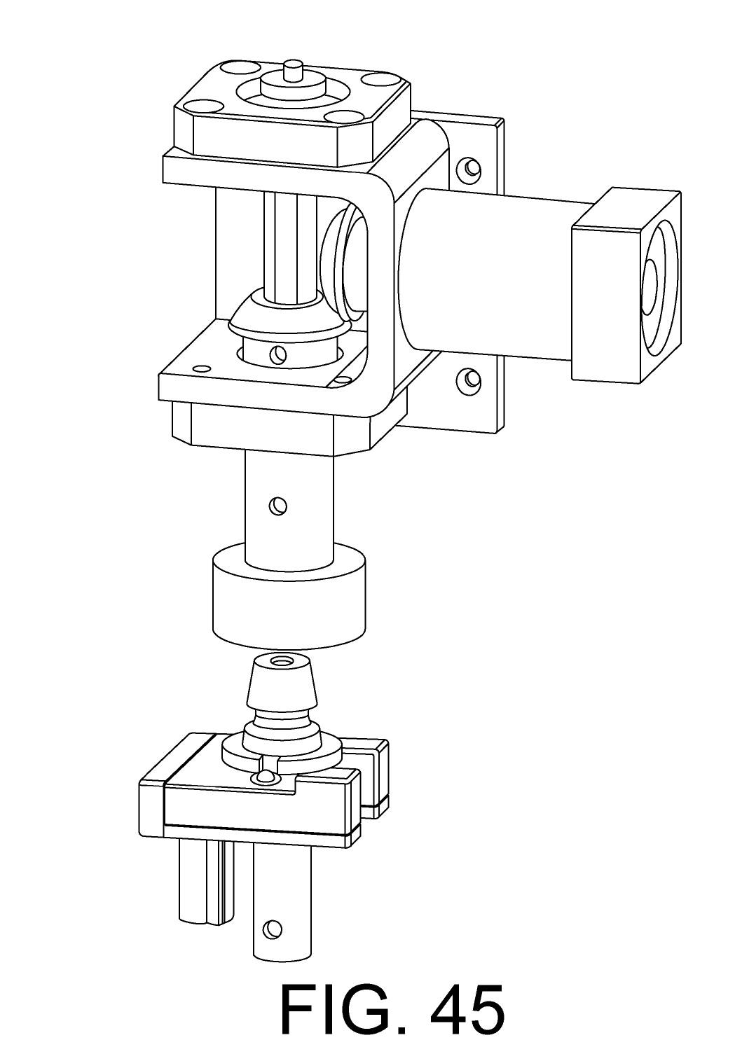

Further detailed options were considered for the attachment mechanism, e.g. the stand of the mannequin (see Table 6.4). This first involved an adaptation of a tool changer mechanism; an example is illustrated in FIGS. 37-44. A corresponding example CAD design is illustrated in FIGS. 45-49.

TABLE 6.4
Example concept options for the attachments

| Concept | Options | | |
|---|---|---|---|
| Stand | Fabricate new stand | Use existing stand | |
| manufacture | | | |
| Mannequin | Use existing | Design new mannequin | |
| to stand | mannequin | to stand interface | |
| interface | to stand interface | | |
| Interface | Electrical interface | Mechanical interface | Pneumatic |
| | | | interface |
| Automated/ | Automated interface | Manual interface | |
| manual | | | |
| interface | | | |

Example decisions made on the attachments and their reasons are given in Table 6.5. Using the existing stand of the mannequin makes sense, as they are well made and need little modification. The mannequin to stand interface could be mostly kept, also with little modification. An electrical interface made sense, as this would require only an extension of the motion control system. An automated interface is also desirable for this reason. A specific mechanism for the interface may still incorporate the mechanism illustrated in FIGS. 37-44.

TABLE 6.5
Example Concept Decisions for the attachments

| Concept | Option chosen | Reason |
|---|---|---|
| Stand | Use existing stand | Cheaper and well made |
| manufacture | | |
| Mannequin to | Use existing | Only a little modification is required |
| stand interface | mannequin to | |
| | stand interface | |
| Interface | Electrical | Integrates well with rest of motion |
| | interface | control |
| Automated/ | Automated | Eliminates need for user to lift the |
| manual | interface | mannequin and position it accurately |
| interface | | |

7. Back-End Software and Computer Hardware Components

The photo-rig of an example system used our custom software written in the .NET framework, running on Windows on an Intel NUC PC. The only connected components were the SLR camera via USB and the turntable via serial RS-232. The camera would automatically trigger the flashes. This system required a mouse, keyboard and barcode scanner for input, so a desk and chair were supplied to studios. This setup constrained one user to the PC and other users to their assigned mannequin. After much operational analysis, we decided to pursue a system allowing more operational fluidity, exploiting the benefits of a tablet for each user and easier sharing of roles to overcome occasional holdups.

The components in the new example system are all connected to an industrial PC, which acts as a server to the tablets, so multiple users can interact with the system simultaneously. The camera is connected to the PC via Ethernet and sends images and receives settings this way. The motion controller is also connected to the PC via Ethernet and communicates via Modbus over TCP/IP protocol. The lights and camera are switched/triggered by the motion controller via a 24V control signal from the bi-directional I/O ports.

In our designed example, the mannequin motion control system is controlled by the Trio motion controller. The controller has 5 stepper outputs/encoder inputs so can control either stepper motors or servo motors. The controller has enough memory to store simple programs written in a Basic programming language (e.g. TrioBASIC). This allowed our developers to write code for the industrial PC to call the motion control code, thereby controlling the mannequin movement indirectly. The controller is programmed to respond appropriately to limit switches to ensure the system works as expected.

Example back-end software also includes programs to 1) process images, 2) upload images, 3) store images, and 4) serve the UI to the tablets. The image processing is done using RawTherapee and ImageMagick—both open source free software. The tablet UI is hosted on the industrial PC and accessed on the tablets using a browser for device compatibility.

7.1 Requirement Definition

An initial high-level requirements example for the back-end software, is given in Table 7.1, ranking in order of preferred importance and ease of implementation:

TABLE 7.1
Example requirements definition for the back-end software

| Requirement | Quantifier/Detail |
|---|---|
| Capable of Off-Line Use | Up to 5 days shooting |
| Wi-Fi Capable | 802.11b/g/n (2.4 GHz) and 802.11n/ac (5 GHz) |
| Process Raw | Alongside JPEG |
| Input/Output | |
| Colour Calibration | Xrite or iT8 profile shot & loaded monthly |
| Automatic Software | Every LoB release downloaded within 1 day |
| Updates | |
| Generate & Send | Automatic timestamps, counts, garment types |
| Statistics Report | |
| Remote Assist | Preferably with Intel AMT |
| Built in Test | Lighting, camera, focus, orientation, turntable |

The computer hardware should meet general requirements such as durability. All components should be server-quality and all interconnects ethernet or other non-consumer level. Early on it was decided that running on Linux would be preferred, so, for example, writing .NET code that runs in mono would allow this and Windows compatibility. The software development structure is to develop each software component as a separate deliverable module. This may include an orchestrator, a web server and any other back-end modules necessary.

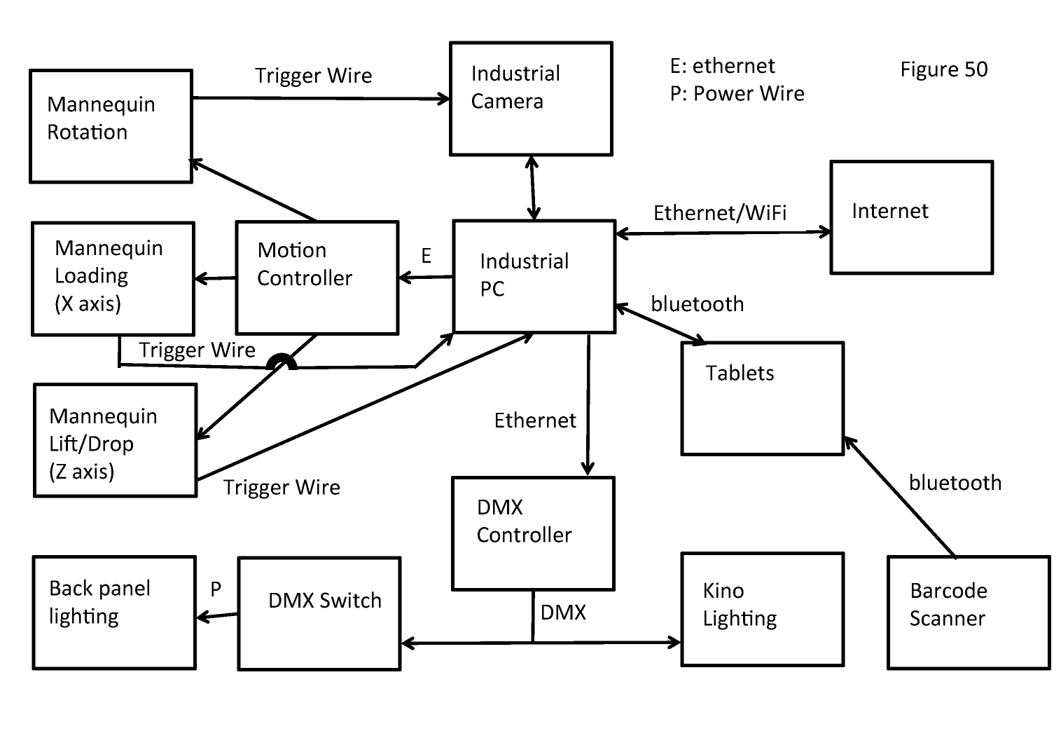

Nonetheless, an example component communication wireframe was drawn up to illustrate the sequence of events in a possible deployment. This is shown simply in FIG. 50.

7.2 Concept Options and Decisions

Most concept options were influenced by general system design. The back-end is supportive of many concept decisions made in other work packages. In an example, it was decided to run some of the back-end on a server unit so access to the components could be regulated. It soon became apparent that the processing power of a large unit and the mains power used supported moving all but the UI to the server, in a preferred example.

Example high-level concept options noted for the back-end software are given in Table 7.2:

TABLE 7.2
Example concept options for the back-end software

| Concept | Options | | | |
|---|---|---|---|---|
| Type of PC | Intel NUC | Industrial PC | Server | Other PC |
| Parallelisation | Serial input | Multiple | | |
| | process | simultaneous input | | |
| | | process | | |
| Back-end | Back-end runs | Back-end runs on | | |
| | on input | server | | |
| | device(s) | | | |
| Operation | Run only | Run only on | Run on both Linux | |
| System | Linux OS | Windows | & Windows | |
| Support | | | | |
| Image | Run image | Run image | | |
| Processing | processing in | processing on | | |
| | parallel on | GPU | | |
| | CPU | | | |
| Input Device | Single large | Multiple PCs as | Multiple tablets as | |
| | input device | input devices | input devices | |

Example preferred decisions made and their reasons are given in Table 7.3:

TABLE 7.3
Example concept decisions for the back-end software.

| Concept | Option chosen | Reason |
|---|---|---|
| Type of PC | Industrial PC (later, server) | Long lifetime and expandability. |
| | | Moving to a server (e.g. Dell) |
| | | improves ease of maintenance |
| Parallelisation | Multiple simultaneous input | Although more complex, this is |
| | process | essential for a fast and simple |
| | | studio UX |
| Back-end | Back-end runs on server | More processing power on server, |
| | | more storage and not limited by |
| | | battery life |
| Operation | Run on both Linux & Windows | Cross-platform support is |
| System | | preferable. |
| Support | | |
| Image | Run image processing in parallel | ImageMagick already parallelizes |
| Processing | on central processing unit | using OpenMP. Move to graphics |
| | (CPU) | processing unit (GPU) is possible. |
| Input Device | Multiple tablets as input devices | Intuitive UI, more portable around |
| | | studio |

8. Front-End Software Components

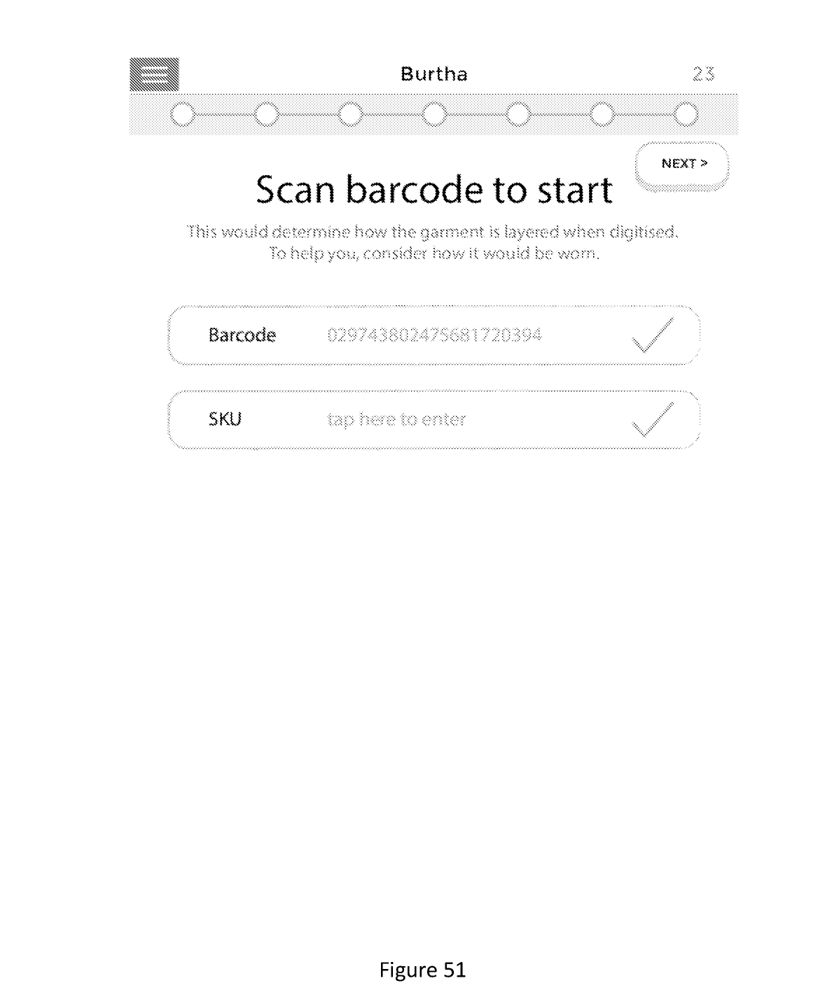

In a preferred garment imaging system example, the front-end software implements a touch-based interface to allow simpler and faster data input and image review. Data input may be completed primarily with a barcode scanner but an on-screen keyboard may also be available (see e.g. FIG. 51).

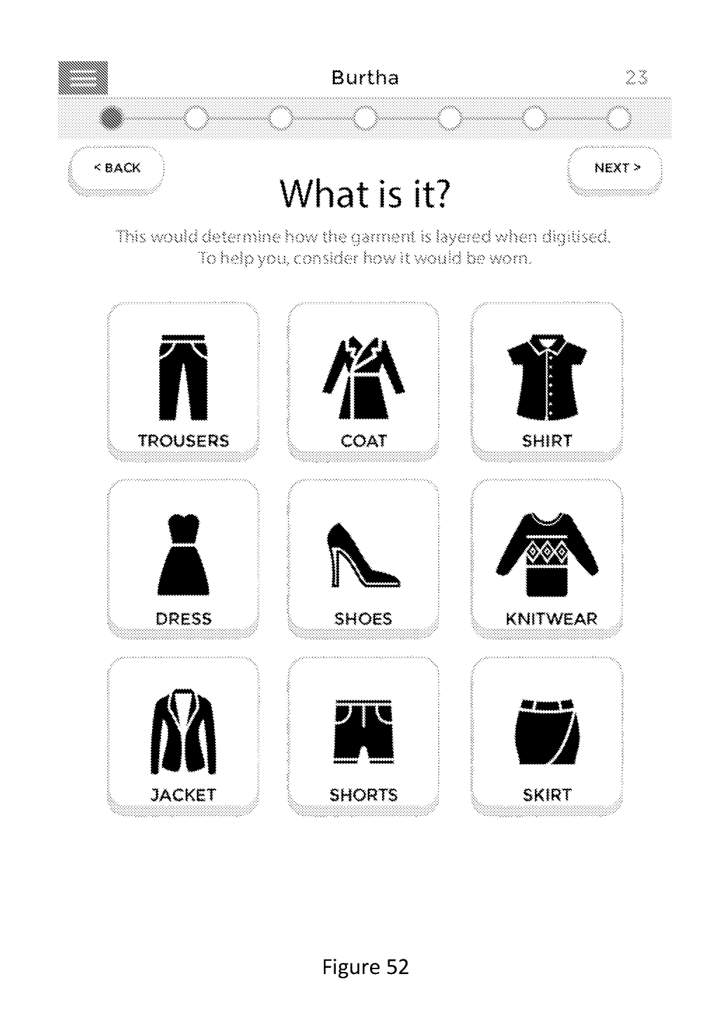

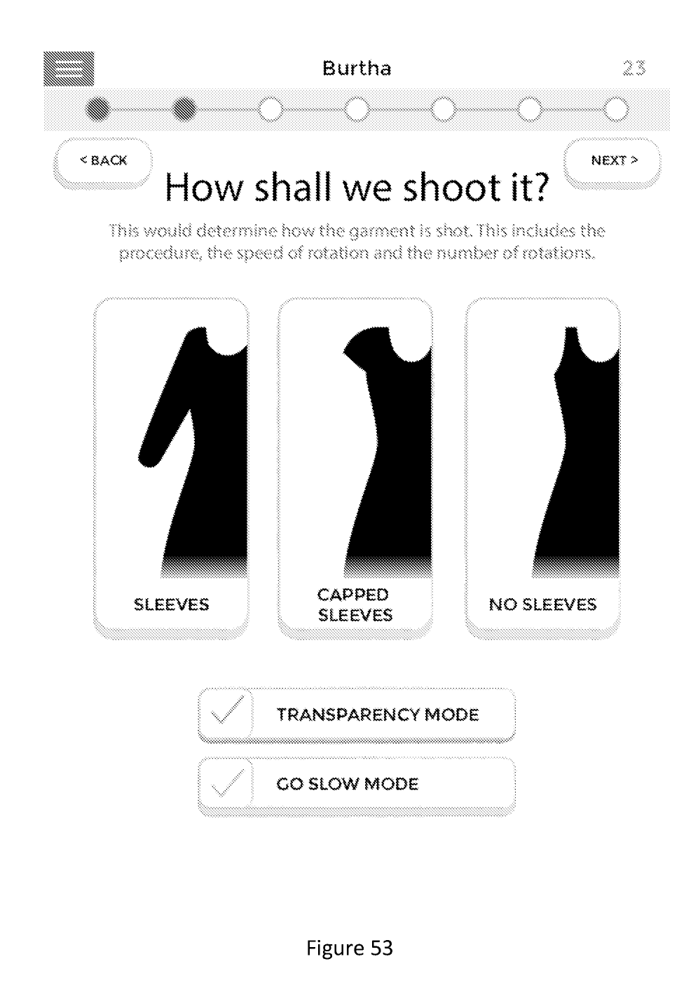

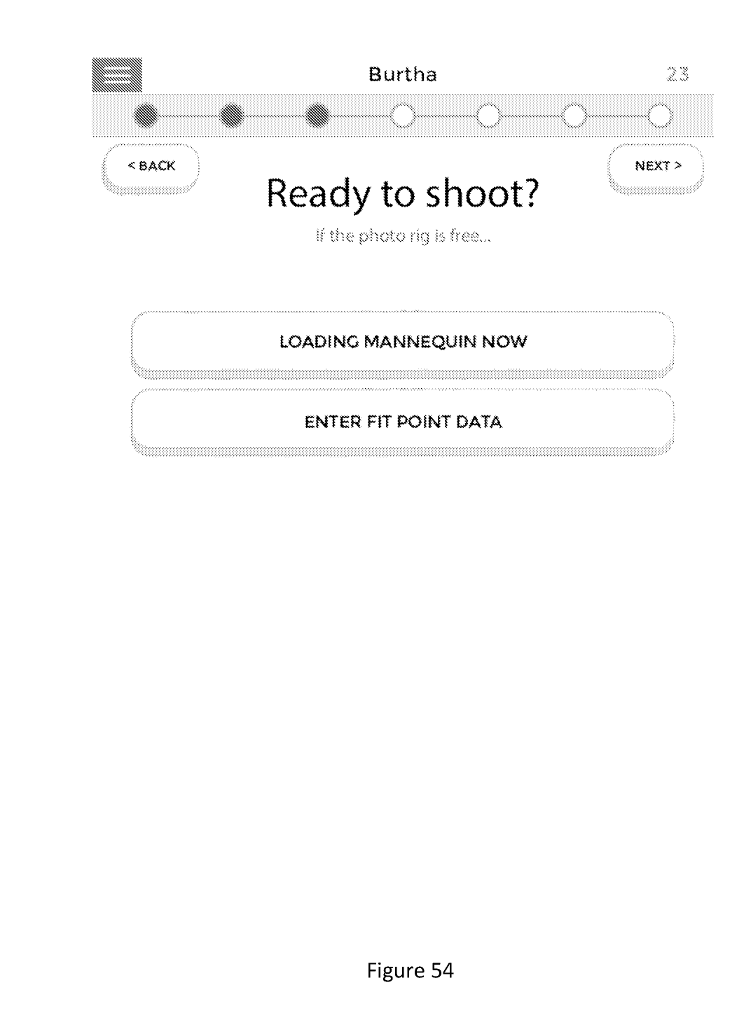

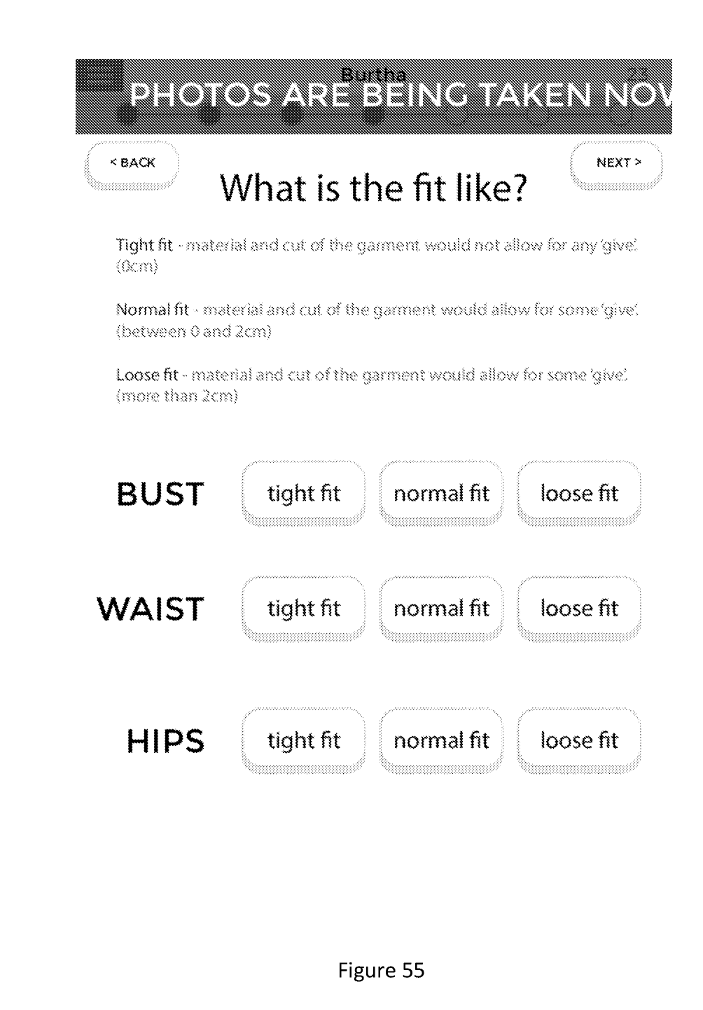

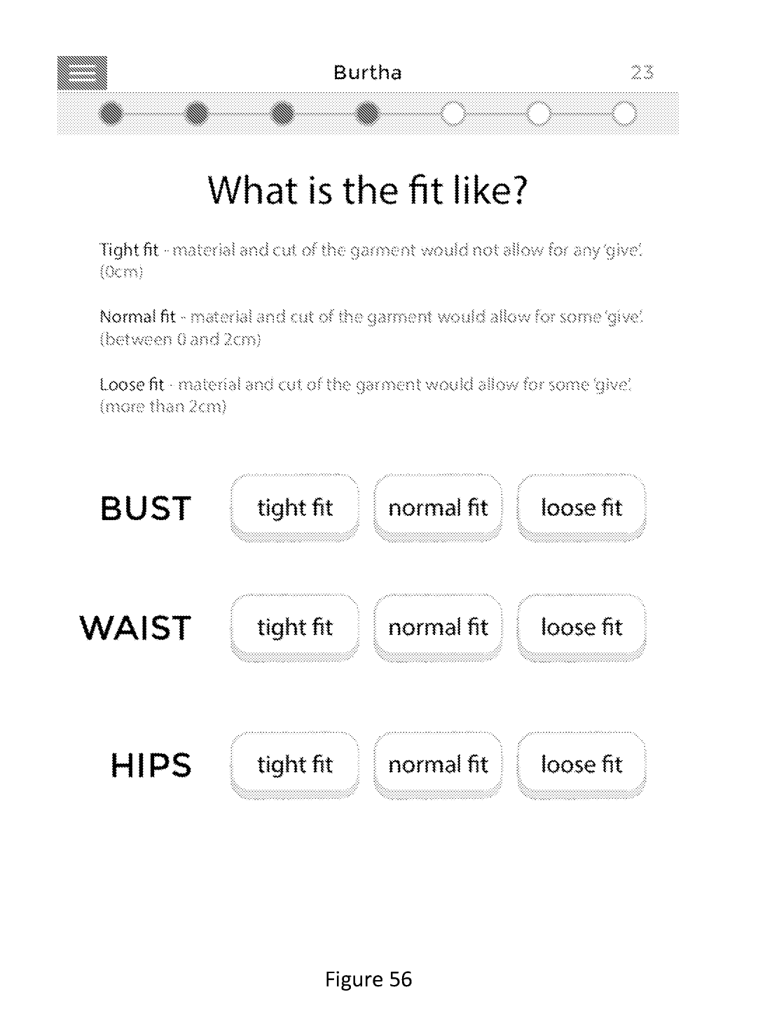

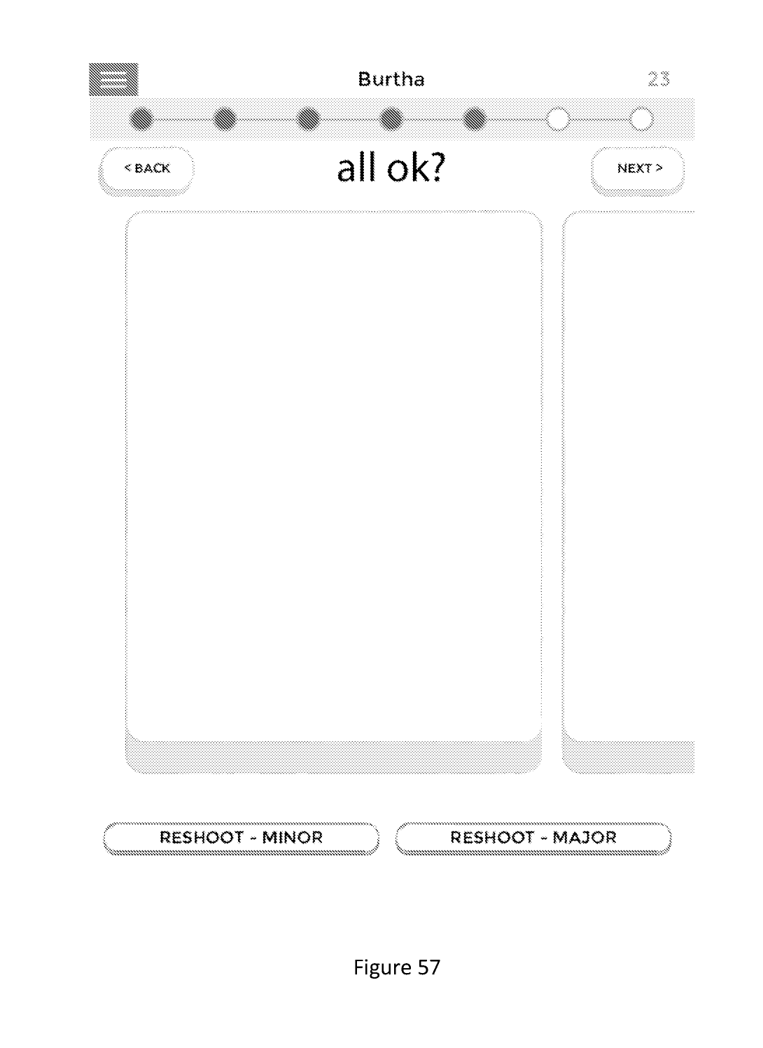

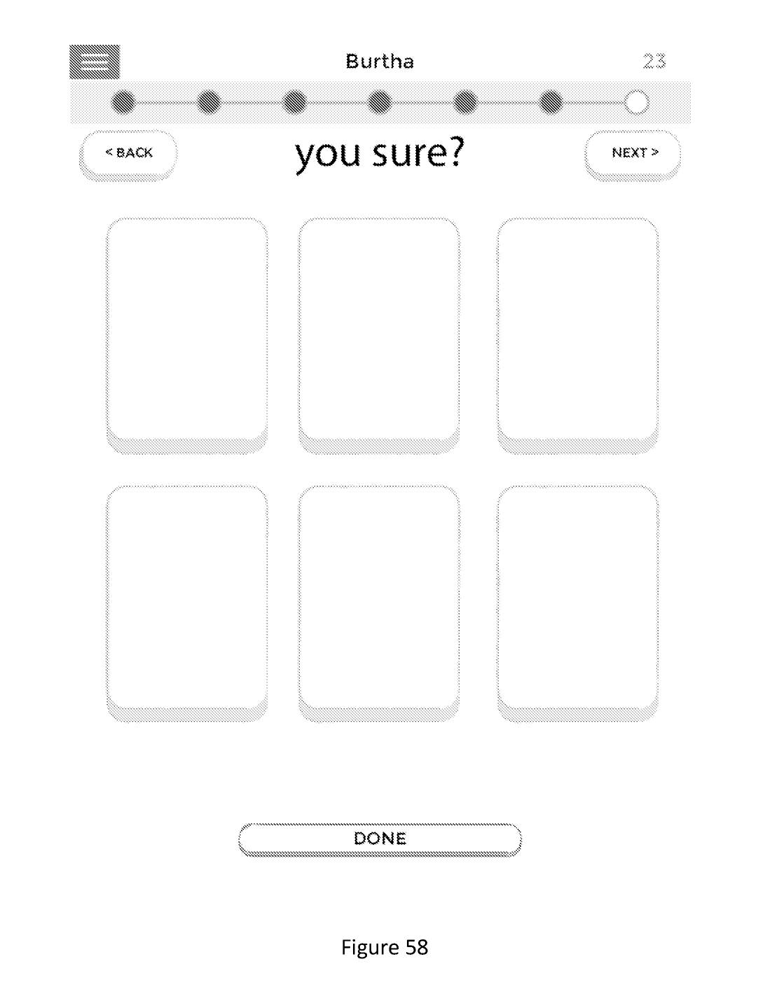

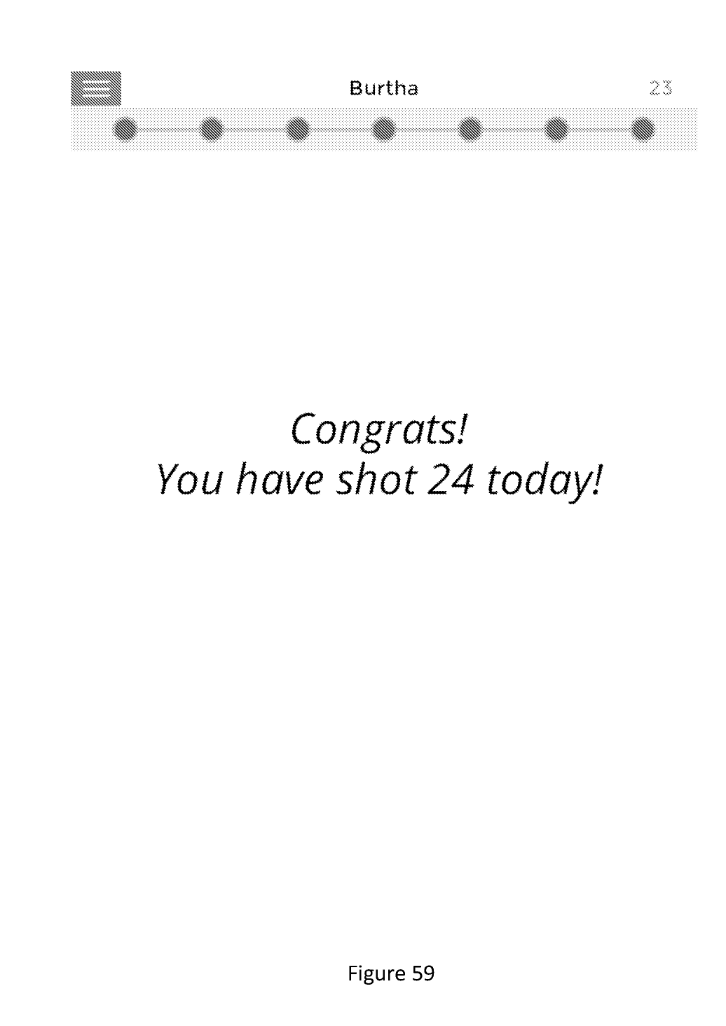

In an example, four possible user flows were identified. Depending on the number of layers, waiting time and reshooting may be necessary, hence the interface routes the user appropriately to optimize the workflow (see e.g. FIGS. 51-59).

RFID (Radio Frequency IDentification) tags on the mannequins or stands may allow the system to identify which mannequin corresponds to which tablet, and therefore which data. The tablets may be docked on the mannequin stands during operation and may be charged on the rig when not in use.

8.1 Requirement Definition

An initial high-level example requirements for the front-end software, is given in Table 8.1, ranking in preferred order of importance and ease of implementation:

TABLE 8.1
Example Requirements Definition for the front-end software

| Requirement | Quantifier/Detail |
|---|---|
| Able to Collect All Photos In | 8 or 19 depending on layers |
| One Click/Touch per layer | |
| Gives Instant Photo Feedback/ | Zoom/hi res previews |
| QC | |
| Auto Duplicate Checking | — |
| Wireless Barcode Entry | Bluetooth barcode scanner/tablet camera |
| | photo |
| Instantly Usable Each Day | “Boot and ready to shoot” in 30 s |
| Tablet Based Entry | — |
| Minimal - No Data Entry | No keyboard necessary |
| Intuitive UI | From start to shoot/learning time (TBA) |

In terms of functionality, the front-end software may be implemented as a web app with touch functionality. Certain features of the back end such as multiple simultaneous input process (i.e. multitasking) may, however, be necessary to effect this. The above requirements have been designed conceptually, as illustrated in FIGS. 51-59.

8.2 Concept Options and Decisions

The example concept optiocept options for the front-end software noted are given in Table 8.2

TABLE 8.2
Example Concept Options for Front-end Software

| Concept | Options | | |
|---|---|---|---|
| Operation | Simple | Complex linear operation | Cluster (autonomous) |
| Mode | linear | | operation |
| | operation | | |

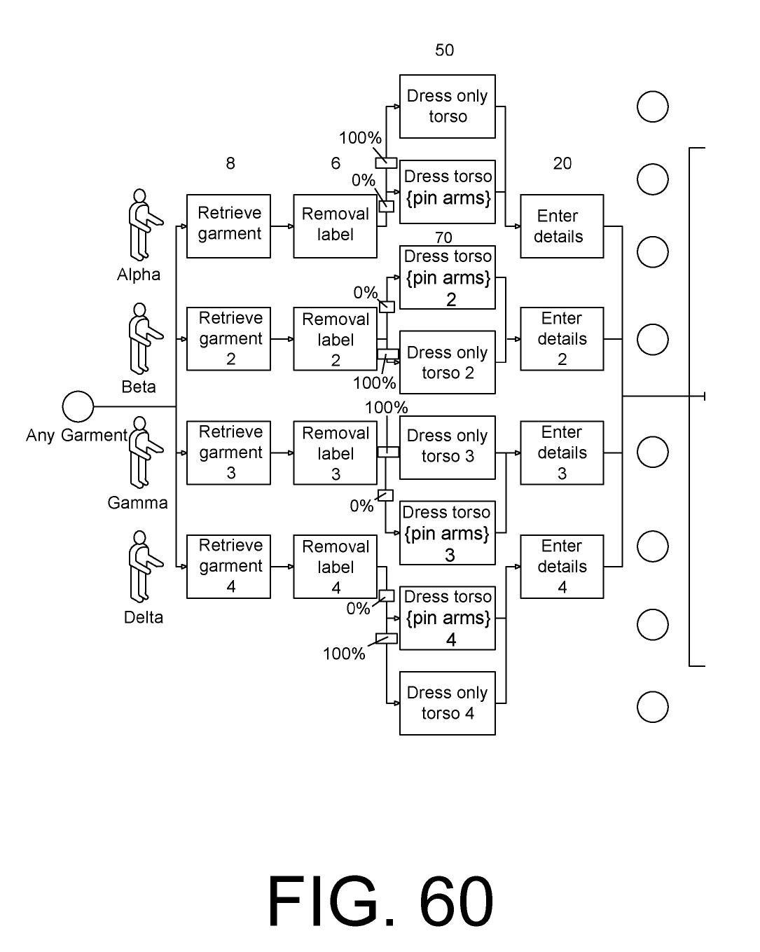

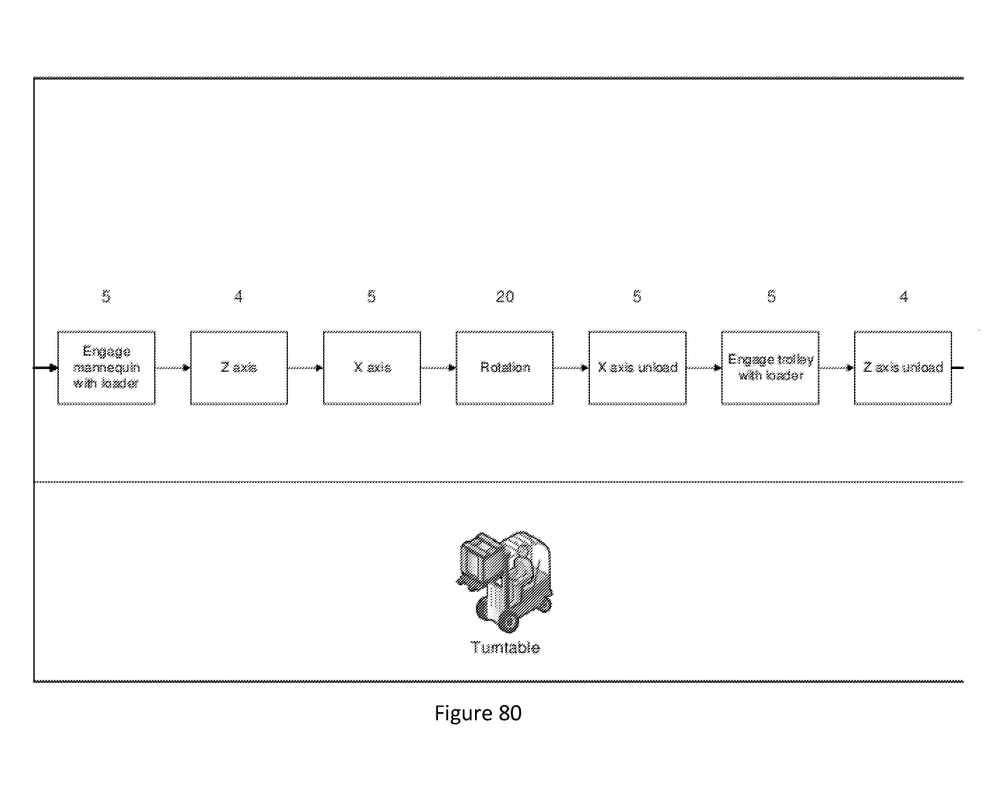

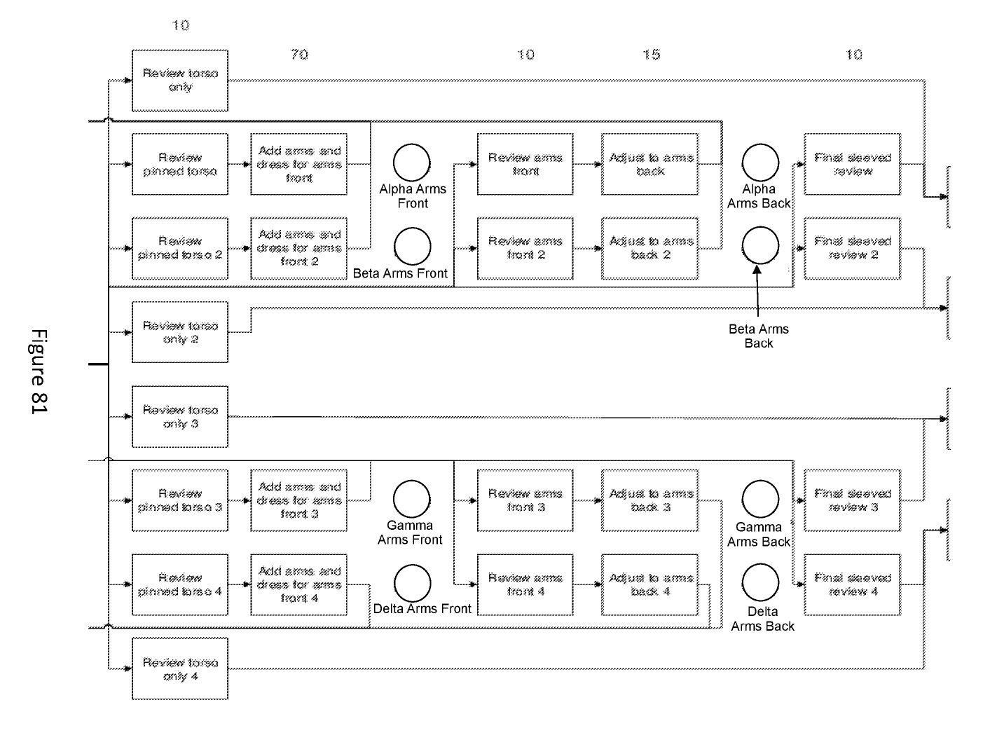

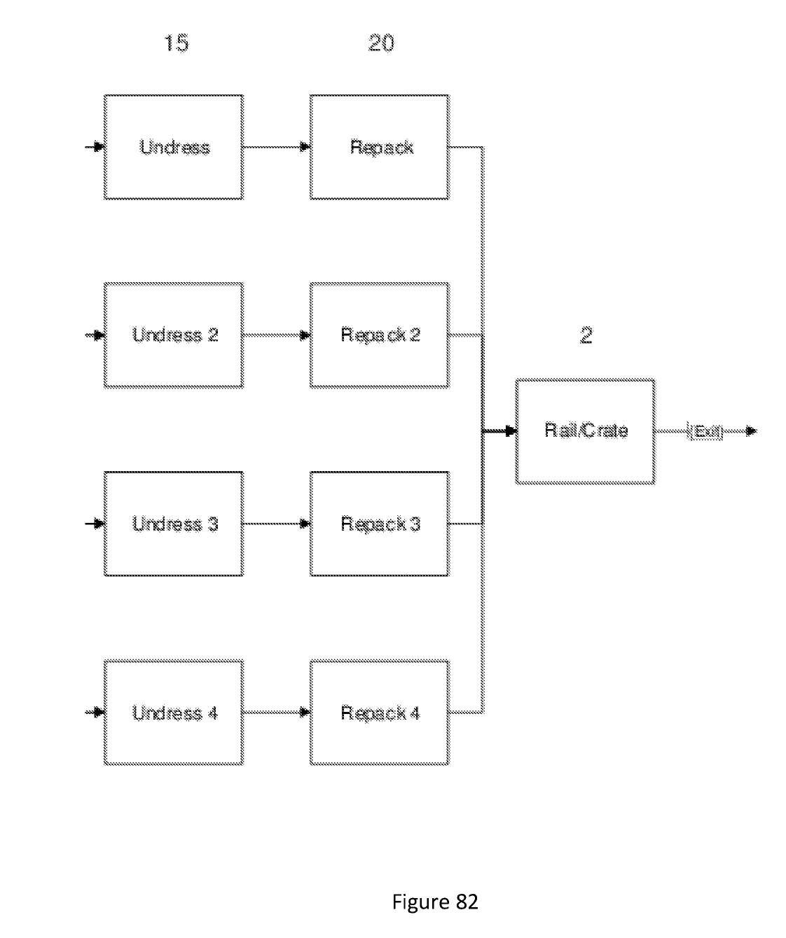

A cluster process may be provided; an example is mapped out in FIGS. 60, 80-82. A complex linear model may work best. This would be similar to a simple linear operation (where workers have separate, small tasks) but would involve workers helping i.e. assisting others e.g. if bottlenecks occur. In this example, this means each tablet would be linked permanently to one trolley and to one mannequin (as in the cluster model), but workers would interact only with the part of the UI relevant to their task. For monitoring purposes, NFC (Near Field Communication) wristbands (for example) could be used to quickly ID each worker when they interact with a tablet.

Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. A garment digitization apparatus, including a mannequin loading system, a mannequin rotation system, a computer system and a camera system, wherein the apparatus is configured to load a mannequin wearing a garment using the mannequin loading system, to rotate the mannequin wearing the garment through at least 360° using the mannequin rotation system, and to capture images of the garment using the camera system during the mannequin rotation, wherein the mannequin loading, the mannequin rotation and the image capturing occur under control of the computer system.

2. The garment digitization apparatus of claim 1, wherein the captured images of the garment are stored on the computer system.

3. The garment digitization apparatus of claim 1, wherein the captured images are suitable for 3D garment digitization of the garment.

4. The garment digitization apparatus of claim 1, wherein the apparatus is arranged to support a loaded mannequin from above.

5. The garment digitization apparatus of claim 4, wherein the loaded mannequin includes a neck spigot, and is supported from the neck spigot by the apparatus.

6. The garment digitization apparatus of claim 1, wherein the apparatus includes a motion controller which controls rotation of the mannequin, wherein a signal from the motion controller is used to synchronise mannequin rotation and image capture.

7. The garment digitization apparatus of claim 1, wherein the loading system includes a gantry system to engage and to load the mannequin.

8. The garment digitization apparatus of claim 7, wherein the gantry system includes 3 linear axes and 1 rotational axis.

9. The garment digitization apparatus of claim 6, wherein the loading system includes a gantry system to engage and to load the mannequin, and wherein the gantry system includes 3 linear axes and 1 rotational axis and wherein the 3 linear axes and 1 rotational axis are controlled by the motion controller.

10. The garment digitization apparatus of claim 7 any of claims 7 to 9, wherein the gantry system includes a collet fixture which is movable downwards to receive, to engage and to secure mannequin tooling on an upper part of the mannequin to the collet fixture.

11-12. (canceled)

13. The garment digitization apparatus of claim 1, wherein the apparatus is arranged to support a loaded mannequin from below.

14. The garment digitization apparatus of claim 13, wherein the loaded mannequin is supported using two spigots of the loading system onto which each of the legs is slotted.

15-19. (canceled)

20. The garment digitization apparatus of claim 1, wherein the camera system includes a stereo camera.

21. The garment digitization apparatus of claim 1, wherein the apparatus includes a lighting system.

22. The garment digitization apparatus of claim 21, (i) wherein the lighting system is under control of the computer system, or (ii) wherein the lighting system comprises high-color rendering index (CRI) lighting, or (iii) wherein the lighting system includes a backpanel and a ringlight, or (iv) wherein the lighting system includes light emitting diode (LED) panels, or (v) wherein the lighting system includes texture lighting, alpha lighting and albedo lighting.

23-26. (canceled)

27. The garment digitization apparatus of claim 1, wherein the apparatus includes a rig, wherein the rig supports or includes the camera system, the mannequin loading system, the mannequin rotation system, and a lighting system.

28. The garment digitization apparatus of claim 27, (i) wherein the rig includes columns and a roof, wherein the columns support the roof, or (ii) wherein the rig includes a back-panel, a lighting column, and a camera column which provide stability while housing their respective components, or (iii) wherein the rig includes a frame which includes an extruded aluminium profile system, or (iv) wherein the rig is readily movable within a room without disassembly of the rig, or (v) wherein the rig ensures that the location and orientation of all apparatus components is constrained so that consistency between garment images is maintained.

29-35. (canceled)

36. The garment digitization apparatus of claim 1, wherein the apparatus is configured to receive a trolley and to receive the mannequin from the trolley.

37-39. (canceled)

40. The garment digitization apparatus of claim 1, wherein the computer system includes a server.

41-48. (canceled)

49. The garment digitization apparatus of claim 1, wherein the apparatus includes Radio-frequency identification (RFID) tracking for mannequin RFID tracking.

50. The garment digitization apparatus of claim 1, wherein the apparatus includes the mannequin.

51. The garment digitization apparatus of claim 50, wherein the mannequin includes a retroreflective surface.

52-54. (canceled)

55. The garment digitization apparatus of claim 1, wherein the apparatus includes a portable device which is connectable to the computer system, in which the portable device is programmed to receive user input to control mannequin loading and/or garment image capture.

56-65. (canceled)

66. The garment digitization apparatus of claim 1, wherein the mannequin loading system is operable to unload and to release the mannequin.

67. The garment digitization apparatus of claim 1, wherein the apparatus supports digitisation of high-translucency garments, complex netting garments, and dipped hem garments.

68-70. (canceled)

71. A computer-implemented method of digitising a garment, using a garment digitization apparatus, the apparatus including a mannequin loading system, a mannequin rotation system, a computer system and a camera system, the method including the steps of:
(i) loading a mannequin wearing a garment using the mannequin loading system;
(ii) rotating the mannequin wearing the garment through at least 360° using the mannequin rotation system, and
(iii) capturing at least three images of the garment using the camera system during the mannequin rotation.

72-78. (canceled)

79. The computer program product executable on a computer system to digitise a garment, the computer system controlling a garment digitization apparatus, the apparatus including a mannequin loading system, a mannequin rotation system, the computer system and a camera system, the computer program product executable to:
(i) load a mannequin wearing a garment using the mannequin loading system;
(ii) rotate the mannequin wearing the garment through at least 360° using the mannequin rotation system, and
(iii) capture at least three images of the garment using the camera system during the mannequin rotation.

80-100. (canceled)
